(19) United States
(12) Patent Application Publication
(10) Pub. No.: US 2007/0168046 A1
(43) Pub. Date: Jul. 19, 2007

(54) Image information apparatus and module unit

(75) Inventors: Tenryu Misawa, Tokyo (JP); Kyosuke Yoshimoto, Tokyo (JP); Tokumichi Murakami, Tokyo (JP); Yoshiki Mizutani, Tokyo (JP); Kazuo Hirasawa, Tokyo (JP); Chihiro Morita, Tokyo (JP); Kosuke Yagi, Tokyo (JP)

Correspondence Address: BIRCH STEWART KOLASCH & BIRCH, PO BOX 747, FALLS CHURCH, VA, 22040-0747, US

(73) Assignee: Mitsubishi Denki Kabushiki Kaisha, Tokyo (JP)

(21) Appl. No.: 10/566,731

(22) PCT Filed: Jul. 27, 2004
(86) PCT No.: PCT/JP04/10656

§ 371 Date: Sep. 19, 2006

(30) Foreign Application Priority Data
Aug. 4, 2003 (JP) 2003-285690

(51) Int. Cl. G05B 15/00; G06F 9/44; G06F 9/46

(52) U.S. Cl. 700/1; 719/319; 719/313; 717/171

(57) ABSTRACT

An apparatus has not been configured without accompanying entirely changing and revising the system LSI when the specification of the apparatus or the system LSI configuring the apparatus is changed, and also, development cost has not been able to be reduced and development period has not been able to be shortened. An image information apparatus is realized in which new functions are easy to be added into the image information apparatus without need for development of a new system LSI for each model, by installing into the image information apparatus a ubiquitous image module having configurational elements such as a hardware engine, CPU, and general-purpose bus for realizing functions that have not been provided on the image information apparatus itself, and also including an OS for operating the configurational elements.

### BACKGROUND OF THE INVENTION

1. Field of the Invention

The present invention relates to image information apparatuses, and particularly relates to an image information apparatus and a module unit used in the apparatus, which can ubiquitously connect to network environments, by providing the apparatus with a ubiquitous image module or a ubiquitous-image-module unit configured including the ubiquitous image module.

2. Description of the Related Art

A conventional AV (audio visual) digital network apparatus includes in its interior an interface for connecting to a network and a function for connecting to the network (for example, refer to Patent Document 1).

Moreover, a function relating to a network is also realized using a system LSI (large scale integration) (for example, refer to Patent Document 2).

[Patent document 1] Japanese Laid-Open Patent Publication 016,619/2002 (on pages 5-6, in FIG. 1)

[Patent document 2] Japanese Laid-Open Patent Publication 230,429/2002 (on pages 10-13, in FIG. 2)

Due to lowering price and sophisticating functions of a personal computer, increasing in Internet content, and diversifying of network connection apparatuses such as a cellular phone or PDA (personal digital assistant), opportunities of using a LAN (local area network) and the Internet have been increased even in general households.

Moreover, also from the viewpoint of standards such as HAVi (home audio/video interoperability) and ECHONET (energy conservation and home-care network), preparation for connecting home-use electrical appliances to a network has been progressing.

In an image information apparatus, such as a television and VTR (video tape recorder) as a digital network apparatus, disclosed in Japanese Laid-Open Patent Publication 016,619/2002 (above Patent Document 1), a system LSI exclusive to the apparatus has been generally developed. Such system LSI is fundamentally composed of a logical part including a CPU (central processing unit) for controlling a system and a VSP (video signal processor) for processing image signals, and a memory part including ROMs (read only memory) and RAMs (random access memory).

Here, the logical part is designed so as to have needed functions based on the specifications of the image information apparatus to be used. Moreover, a front end processor for performing front processing and a back end processor for performing back processing of signal processing in the system LSI are provided at the front end and at the back end of the system LSI, respectively. Then, an image in the image information apparatus is outputted from a video interface being connected to the back end processor and interfacing the image information apparatus with external apparatus.

On the other hand, a network-connection-type semiconductor charge collector disclosed in Japanese Laid-Open Patent Publication 230,429/2002 (above Patent Document 2), is equipped therein with a network-apparatus controller, so that a configuration enabling network connection has been realized.

### DISCLOSURE OF THE INVENTION

In the conventional apparatus described above, when expanding the function or changing the specification of this apparatus, in order to further add to the system LSI an additional function, this system LSI is requested to be entirely designed and developed anew. Therefore, software installed in this system LSI must be entirely changed and revised; consequently, a problem has been that development cost and development period increase.

In an apparatus in which a system LSI whose function has already been obsolete is installed, a problem has also been that new functions cannot be realized without revising and updating the system LSI itself.

Moreover, because in most cases, the exclusive function of the system LSI differs model by model of the apparatus provided with the system LSI, in order to realize such exclusive function, a system LSI exclusive to the apparatus must be developed; consequently, another problem has also been that cost reduction is difficult.

Furthermore, because the product specification is changed every time the system LSI is changed, reliability test and EMI test must be newly conducted every time it is changed; consequently, a problem has been that time and cost for the tests increase.

An objective of the present invention, which is made to solve problems as described above, is to configure an apparatus without accompanying entirely changing and revising the system LSI even if the specification of the apparatus or the system LSI configuring the apparatus is changed, and also to obtain an apparatus in which development cost can be reduced and development period can be shortened.

An image information apparatus according to the present invention comprises: an image-information-apparatus main unit including a first central processing unit, and a connection interface for connecting with a module unit that has a second central processing unit for controlling the first central processing unit; wherein: the first central processing unit and the second central processing unit each have a plurality of hierarchical control strata, and the second central processing unit included in the module unit is configured to transmit, between each of the hierarchical control strata of the first central processing unit and respectively corresponding hierarchical control strata of the second central processing unit, control information related to each of respectively corresponding hierarchical control strata, so as to control the image-information-apparatus main unit.

Moreover, a module unit according to the present invention comprises: a connecting portion connected to a connection interface of an image-information-apparatus main unit that includes a first central processing unit having a plurality of hierarchical control strata, and the connection interface; and a second central processing unit having hierarchical control strata corresponding to the hierarchical control strata of the first central processing unit, and for transmitting, from the hierarchical control strata of the second central processing unit through the connecting portion, control information for controlling the hierarchical control strata of the first central processing unit, so as to control the first central processing unit; wherein by controlling the first central processing unit, processed information including image information is outputted from the image-information-apparatus main unit.

Because the present invention is configured as described above, it is effective that, even if the specification of an apparatus or a system LSI configuring the apparatus is changed, not only the apparatus can be configured without entirely changing and revising the system LSI, but also development cost can be reduced and the development period can be shortened.

### BRIEF DESCRIPTION OF DRAWINGS

FIG. 1 is a view illustrating a network system including an image information apparatus according to Embodiment 1;

FIG. 2 is a view illustrating a schematic configuration of a ubiquitous image module according to Embodiment 1;

FIG. 3 is a schematic view illustrating functional blocks of the ubiquitous image module according to Embodiment 1;

FIG. 4 is an explanatory view illustrating a topological example (bus type) for connecting the ubiquitous image module to the image information apparatus according to Embodiment 1;

FIG. 5 is an explanation view illustrating a topological example (star type) for connecting the ubiquitous image module to the image information apparatus according to Embodiment 1;

FIG. 6 is a block configuration view when other external apparatuses are connected to image information apparatus according to Embodiment 1;

FIG. 7 is a block configuration view when the external apparatuses are removed from the image information apparatus according to Embodiment 1, but instead the ubiquitous image module is connected to the image information apparatus;

FIG. 8 is an explanation view illustrating an example of a configuration of a communication engine according to Embodiment 1;

FIG. 9 is an explanation view illustrating an example of a software block configuration of middleware in accordance with an Internet communication protocol according to Embodiment 1;

FIG. 10 is an explanation view illustrating an example of a software block configuration when another communication interface is added to middleware in accordance with the Internet communication protocol according to Embodiment 1;

FIG. 11 is a view illustrating a software block configuration of the ubiquitous image module according to Embodiment 1;

FIG. 12 is a view illustrating software blocks when the ubiquitous image modules are applied to each apparatus according to Embodiment 1;

FIG. 13 is a configurational view representing a relationship between software of the image information apparatus and that of the ubiquitous image module according to Embodiment 1;

FIG. 14 is a configurational view representing a relationship between software of the image information apparatus and that of the ubiquitous image module according to Embodiment 1;

FIG. 15 is a configurational view representing a relationship between software of the image information apparatus and that of the ubiquitous image module according to Embodiment 1;

FIG. 16 is an explanation view illustrating an example of a system configuration when the ubiquitous image module is connected to a storage I/F of the image information apparatus according to Embodiment 1;

FIG. 17 is a software-block-configuration view when the ubiquitous image module is connected to an ATA storage I/F according to Embodiment 1;

FIG. 18 is an explanation view illustrating an example of a system configuration when the ubiquitous image module is connected to an ATA storage I/F of the image information apparatus according to Embodiment 1;

FIG. 19 is a software-block-configuration view when the ubiquitous image module is connected to the image information apparatus according to Embodiment 1;

FIG. 20 is a hardware-configuration view illustrating a conventional hard disk using an ATA interface;

FIG. 21 is an explanation view illustrating a sequence when data is written from an ATA host into the hard disk;

FIG. 22 is an explanation view illustrating a sequence when the ATA host reads out data from the hard disk;

FIG. 23 is a software-block-configuration view of the ubiquitous image module according to Embodiment 1;

FIG. 24 is a hardware-block-configuration view of the ubiquitous image module according to Embodiment 1;

FIG. 25 is an explanatory view illustrating a sequence when data is written into a NAS from the image information apparatus according to Embodiment 1;

FIG. 26 is an explanatory view illustrating file names that are created anew by the ubiquitous image module according to Embodiment 1;

FIG. 27 is an explanatory view illustrating a sequence when the image information apparatus reads out data from the NAS according to Embodiment 1;

FIG. 28 is an explanatory view illustrating an example of a system configuration when a ubiquitous image module is connected to an Ethernet interface according to Embodiment 2;

FIG. 29 is a software-block-configuration view when the ubiquitous image module is connected to an image information apparatus according to Embodiment 2;

FIG. 30 is a software-block-configuration view illustrating a conventional NAS;

FIG. 31 is a software-block-configuration view illustrating the ubiquitous image module according to Embodiment 2;

FIG. 32 is a directory-configuration view illustrating a virtual file system according to Embodiment 2;

FIG. 33 is an explanatory view illustrating a sequence when the image information apparatus is associated with a camera according to Embodiment 2;

FIG. 34 is an explanatory view illustrating a sequence when the image information apparatus obtains picture data of the camera;

FIG. 35 is a directory-configuration view representing a virtual file system according to Embodiment 2;

FIG. 36 is a directory-configuration view representing a virtual file system according to Embodiment 2;

FIG. 37 is a directory-configuration view representing a virtual file system according to Embodiment 2;

FIG. 38 is an explanatory view illustrating an example of a system configuration when the ubiquitous image module is connected to an Ethernet interface according to Embodiment 3;

FIG. 39 is an explanatory view illustrating an example of a configuration when a function for displaying images on a display unit is provided in the ubiquitous image module unit according to Embodiment 3;

FIG. 40 is a hardware-configuration view illustrating a conventional image information apparatus;

FIG. 41 is a hardware-configuration view illustrating a ubiquitous image module according to Embodiment 4;

FIG. 42 is a software-configuration view illustrating the ubiquitous image module according to Embodiment 4;

FIG. 43 is an explanatory view illustrating a sequence when picture data displayed on an image information apparatus is gotten from a Web browser according to Embodiment 4;

FIG. 44 is a hardware-configuration view illustrating the ubiquitous image module according to Embodiment 4;

FIG. 45 is an explanatory view illustrating a sequence when picture data displayed on the image information apparatus is gotten from the Web browser according to Embodiment 4;

FIG. 46 is an explanation view schematically representing an example of a system configuration of an image information apparatus to which a ubiquitous image module is applied, according to Embodiment 5;

FIG. 47 is an explanatory view schematically representing another example of the system configuration of the image information apparatus to which the ubiquitous image module is applied, according to Embodiment 5;

FIG. 48 is a schematic view representing an example of setting information stored in setting memories according to Embodiment 5;

FIG. 49 is an explanatory view representing an example of setting contents of cooperation setting included in the image information apparatus according to Embodiment 5;

FIG. 50 is an explanatory view representing an example of setting contents of cooperation setting included in the ubiquitous image module according to Embodiment 5;

FIG. 51 is an explanatory view representing an example of a data list of hardware engines that the ubiquitous image module can control, according to Embodiment 5;

FIG. 52 is an explanatory view illustrating hardware engines that the ubiquitous image module can practically control, according to Embodiment 5;

FIG. 53 is an explanatory view illustrating an example of a system configuration when a ubiquitous image module is connected to an image information apparatus through a bus line according to Embodiment 6;

FIG. 54 is an explanatory view schematically representing cooperation setting of hardware engines each included in the image information apparatus and the ubiquitous image module according to Embodiment 6;

FIG. 55 is an explanatory view schematically representing each cooperation setting of hardware engines included in the image information apparatus and the ubiquitous image module according to Embodiment 6;

FIG. 56 is an explanatory view illustrating a system configuration when the ubiquitous image module is connected to the image information apparatus through the bus line according to Embodiment 6;

FIG. 57 is an explanatory view representing an example of a data list of hardware engines that the ubiquitous image module can control, according to Embodiment 6; and

FIG. 58 is an explanatory view illustrating hardware engines that the ubiquitous image module can practically control, according to Embodiment 6.

### DETAILED DESCRIPTION OF THE PREFERRED EMBODIMENT

Hereinafter, the invention will be specifically explained referring to figures illustrating the embodiments.

### Embodiment 1

<Network>

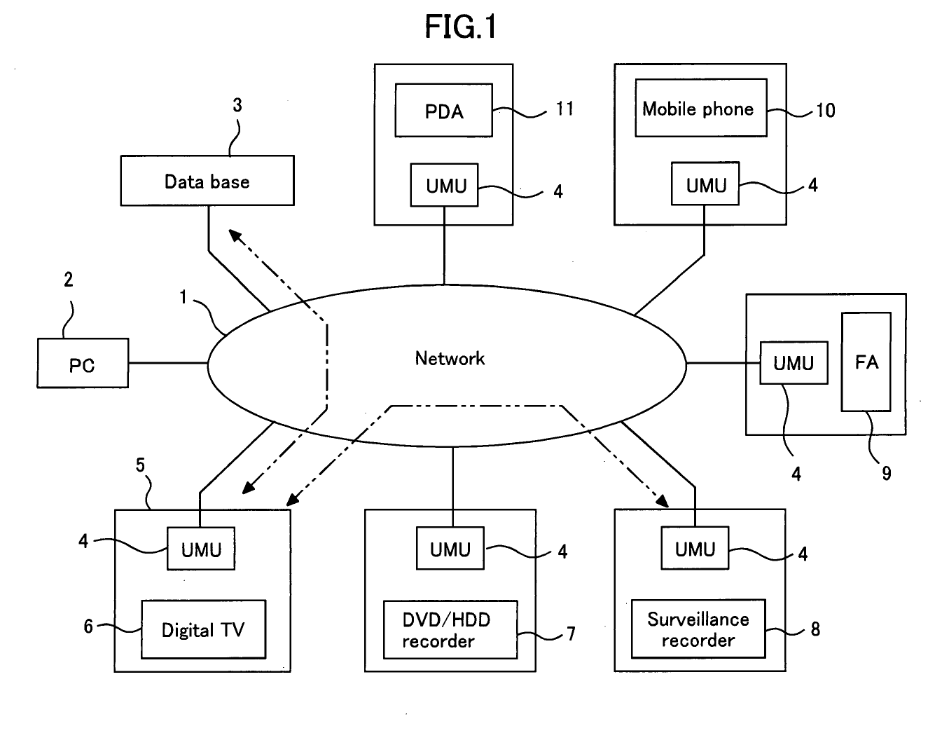

FIG. 1 is a view illustrating a network system including image information apparatuses according to Embodiment 1 of the present invention. Here, various kinds of image information apparatuses such as a digital television (digital TV), a DVD/HDD recorder, a monitor recorder, an FA (factory automation) apparatus in a factory, a mobile phone, and a PDA (personal digital assistant) that are illustrated as examples in FIG. 1, are connected to a network through their respective module units.

A network 1 is a network represented by a small-scale LAN and the large-scale Internet. Generally, client computers that are not illustrated are connected to the network, and a server for offering service to each client computer and for sending and receiving data is also connected to the client computers.

A computer (here, a personal computer is used as an example, and hereinafter referred to as a “PC”) PC 2 is a personal computer connected to the network 1 and is used for various services and applications such as sending/receiving of mails, development/browsing of homepages, and the like.

In a database 3, streaming data for image distribution, storage of image and music data, management data of FA (factory automation), various image data including monitoring screen images from a monitor camera and the like are stored.

A digital TV 6 is a display device for displaying image content corresponding to inputted digital signals. A DVD/HDD recorder 7 is a recorder as one of the image information apparatuses for storing image and music data into a recording medium such as a DVD (digital versatile disk) or an HDD (hard disk drive).

A monitor recorder 8 is a recorder as one of the image information apparatuses for storing, as monitoring image data, a picture of a state in an elevator or a store, etc. photographed by a monitor camera.

An FA 9 is an FA (factory automation) apparatus as one of the image information apparatuses in a factory. For example, image information in which a state of a production line is photographed is outputted from this FA 9.

A mobile phone 10 is a mobile phone as one of the image information apparatuses that, for example, can not be connected to the network by itself.

A PDA (personal digital assistant) 11 is a personal information terminal as one of the image information apparatuses for managing personal information and the like.

As described above, apparatuses capable of connecting to the network 1 can take various forms. In the embodiment of the present invention being specifically explained hereinafter, it is explained in detail that the differences of the hardware, the software, etc. between the apparatuses are absorbed by intervening a ubiquitous image module unit 4, as an example of the module unit, between each apparatus and the network 1, and the image information apparatus is connected to the ubiquitous image module unit 4, so as to configure a new image information apparatus.

As described above, by connecting the image information apparatus to the ubiquitous image module unit 4 to configure the new image information apparatus, not only the apparatus represented in this embodiment, even if the specification of the apparatus is modified, can be configured without accompanying modification and revision of the entire system LSI, but also an apparatus is obtained in which reduction in development cost and shortening a development period can be enhanced.

<Ubiquitous Module and Hardware Engine>

Recently, computer technology has made a remarkable progress, and in personal life and society, it has now become almost impossible to discuss human life without considering a product and system that incorporate computers. Among those technologies, the concept of “ubiquitous” has recently been drawing attention, in which a network represented by a LAN or the Internet is connected to the product or system incorporating computers, so that the computers independently communicates with each other so as to link and cooperatively perform processing.

One of the forms of its actual realization, taking this ubiquitous concept as a background, is a ubiquitous module (hereinafter referred to as a “UM”) or a ubiquitous-module unit (hereinafter referred to as a “UMU”) that is an aggregation of the module (here, the module and unit are generically named as ubiquitous-module units).

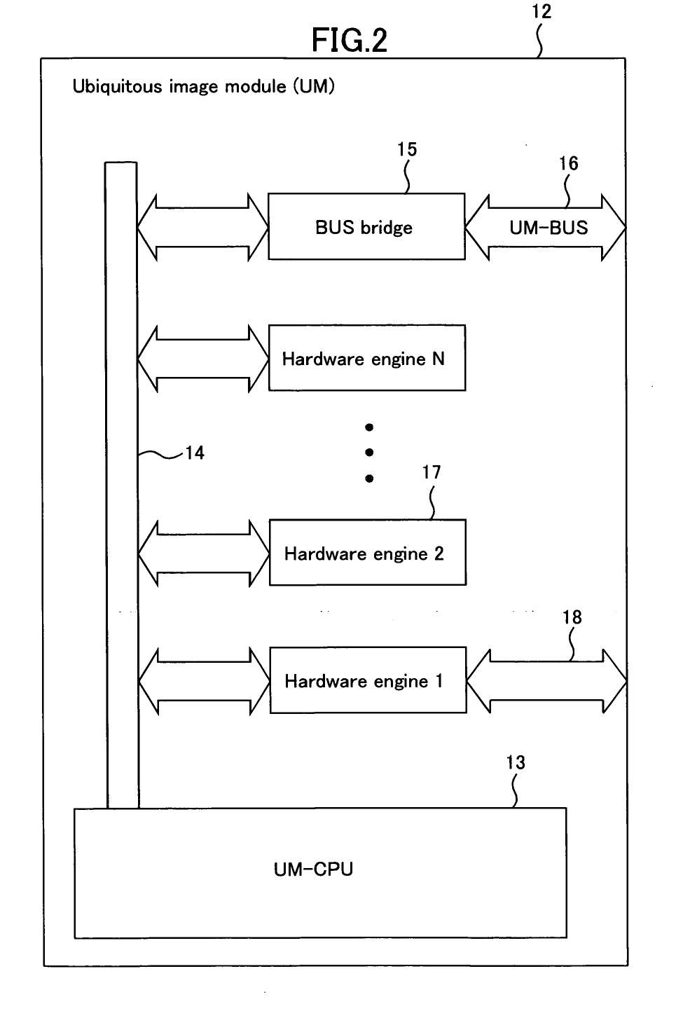

FIG. 2 is a view illustrating a schematic configuration of a ubiquitous module (abbreviated as “UM” in the figure) that becomes a main constituent (core) of the ubiquitous-module unit 4. Hereinafter, as an example, in order to explain the ubiquitous module and the ubiquitous image module unit that are related to images, the module and the unit are named as a ubiquitous image module and a ubiquitous image module unit, respectively. A ubiquitous image module 12 is composed of a UM-CPU 13 for controlling any of hardware engines 17 of the ubiquitous image module 12, a local bus 14 for connecting the UM-CPU 13 to the respective hardware engines, a general-purpose bus UM-BUS 16 for connecting an external image information apparatus to the ubiquitous image module 12, a bus bridge 15 for connecting the general-purpose bus UM-BUS 16 to the local bus 14, and the hardware engines 17 for realizing, by hardware, functions needed for various image-signal processing operations in the network.

Here, the hardware engines 17, for example, in order to connect to the network 1, can be provided with bus lines 18 for connecting it to a wired LAN, a wireless LAN, a serial bus, etc.

Each of the hardware engines 17 is an engine that, by installing the ubiquitous image module unit 4, for complementing and adding functions that are not originally included in the image information apparatus.

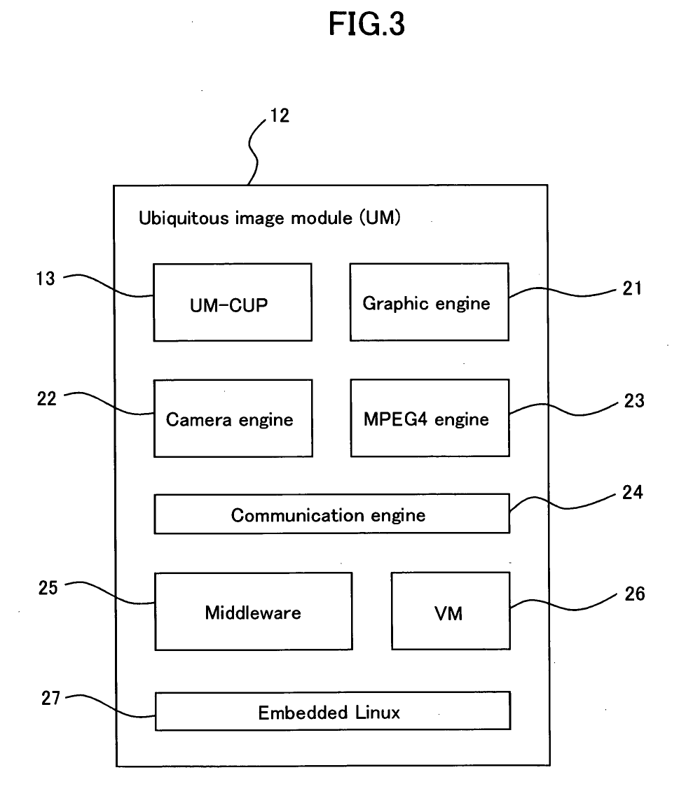

This engine is, for example, as illustrated in FIG. 3, a communication engine 24 for carrying communication functions, between the ubiquitous image module 12 and the network 1, which include wired LAN, wireless LAN, and Serial BUS communications for connecting the module to the network 1.

Moreover, the engines include a graphic engine 21 for improving drawing characteristics, a camera engine 22 for processing the image signals of a moving picture or a still picture, and an MPEG4 engine 23 (represented as an “MPEG4 engine” in the figure) for compressing moving-picture data using the MPEG4 (moving picture experts group 4) standard.

Here, each example of the engines set forth here is merely an example, and by including engines that enable to realize other functions needed for the image information apparatus, the functions can also be complemented.

The ubiquitous image module 12 includes: embedded OS 27 installed in the ubiquitous image module 12; middleware 25 operating on the embedded OS 27, and providing application software with more advanced and specific function than those of the embedded OS 27; a virtual machine (represented as “VM” in the figure) 26; and an application software (not represented in the figure) operating on the embedded OS 27; thus, the function of the image information apparatus to which a function, for example, for connecting to the network is added can be virtually realized by only the ubiquitous image module 12.

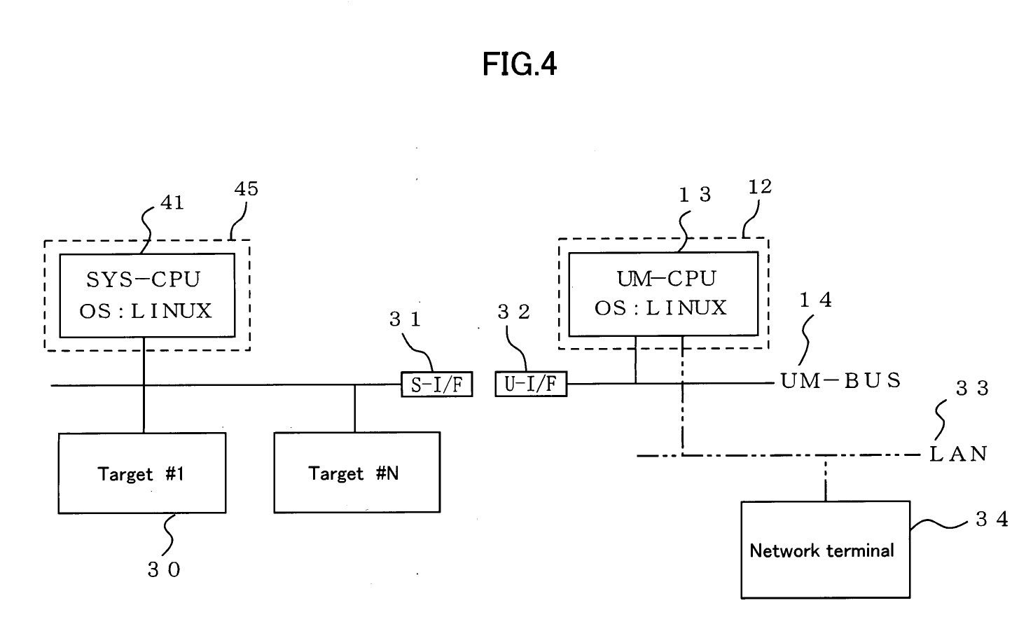

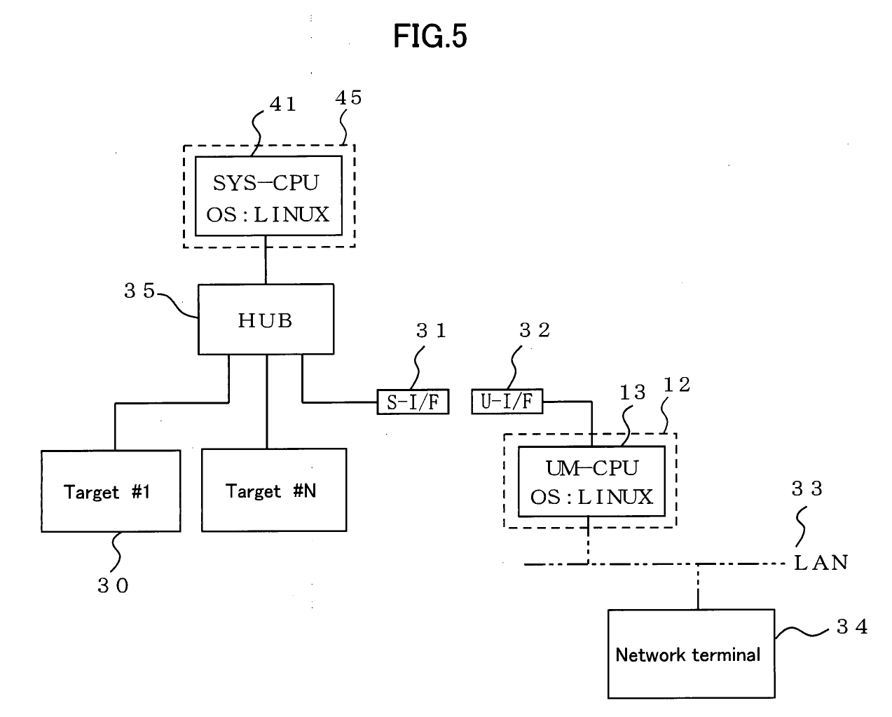

FIG. 4 and FIG. 5 represent topology (connection form of the network) for connecting, for example, the image information apparatus to the ubiquitous image module 12.

The connection form between an SYS-CPU 41 and the UM-CPU 13 can be achieved by any one of: bus-type connection in which a cable named as a bus is connected to a terminal; star-type connection in which terminals are connected with each other through an HUB 35 and hub communication apparatuses; and ring-type connection in which a ring-shaped cable is connected to a terminal.

Hereinafter, each topology is explained.

<Bus-Type Connection Topology>

FIG. 4 is a view illustrating an example of bus-type connection topology, in which the SYS-CPU 41 and the UM-CPU 13 are connected in the bus type. Moreover, the SYS-CPU 41 realizes a host-server function that manages, for example, system controlling of the image information apparatus, meanwhile the UM-CPU 13 realizes a network-server function. Here, the image information apparatus represented as an example operates to satisfy its product specifications only by the SYS-CPU 41 without any problem.

In the bus-type topology, as represented in FIG. 4, a system side interface S-I/F 31 and a ubiquitous-image-module side interface U-I/F 32 are configured to be electrically connected.

Owing to this connection, the SYS-CPU 41 and the UM-CPU 13 are connected with each other, which allow sending and receiving information between both of the CPUs. Therefore in a case, for example, in which an image information apparatus is desired to have a network function with higher performance and higher added value, which has not been originally included in the image information apparatus by connecting to the apparatus the ubiquitous image module unit 4 through the S-I/F 31 and the U-I/F 32, a network function to access, for example, a network terminal 34 on the LAN 33 can be realized.

<Star-Type Connection Topology>

FIG. 5 is a view illustrating an example of star-type connection topology, which is different from bus-type one in only that the SYS-CPU 41 and the UM-CPU 13 are connected in the star-type through the HUB represented as “HUB” in the figure) 35, and which is configured, as represented in FIG. 5, by electrically connecting through the HUB 35 the system side interface S-I/F 31 with the ubiquitous-image-module side interface U-I/F 32.

Owing to the connection, the SYS-CPU 41 and the UM-CPU 13 are connected through the HUB 35, and thus sending and receiving information between both of the CPUs becomes possible. Therefore in a case, for example, in which an image information apparatus is desired to have a network function with higher performance and higher added value, which has not been originally included in the image information apparatus, by connecting to the apparatus the ubiquitous image module unit 4 through the S-I/F 31 and the U-I/F 32, a network function to access, for example, a network terminal 34 on the LAN 33 can be realized.

<Ring-Type Connection Topology>

Here, although the ring-type connection is not explained referring to figures, a function similar to those of the bus-type and star-type connections described above can be satisfactorily realized in the ring-type.

<Interface Connection>

Here, the connection between the S-I/F 31 and the U-I/F 32 can be configured by adopting either parallel transfer conform to a standard such as ATA (AT attachment), PCI (peripheral components interconnect bus), SCSI (small computer system interface), or general-purpose BUS, or serial transfer conform to a standard such as IEEE-1394 (institute of electrical and electronic engineers 1394), USB (universal serial bus), or UART (universal asynchronous receiver transmitter) can be adopted.

Moreover, regarding a connection method of the image information apparatus with the ubiquitous image module unit 4 represented here as an example, a method such as connector connection used in a standard such as PC card or card BUS, card-edge-connector connection used for PCI bus connection or the like, or cable connection with an FPC cable, a flat cable, or an IEEE-1394 cable can be used.

<Explanation Relating to Image Signal Processing>

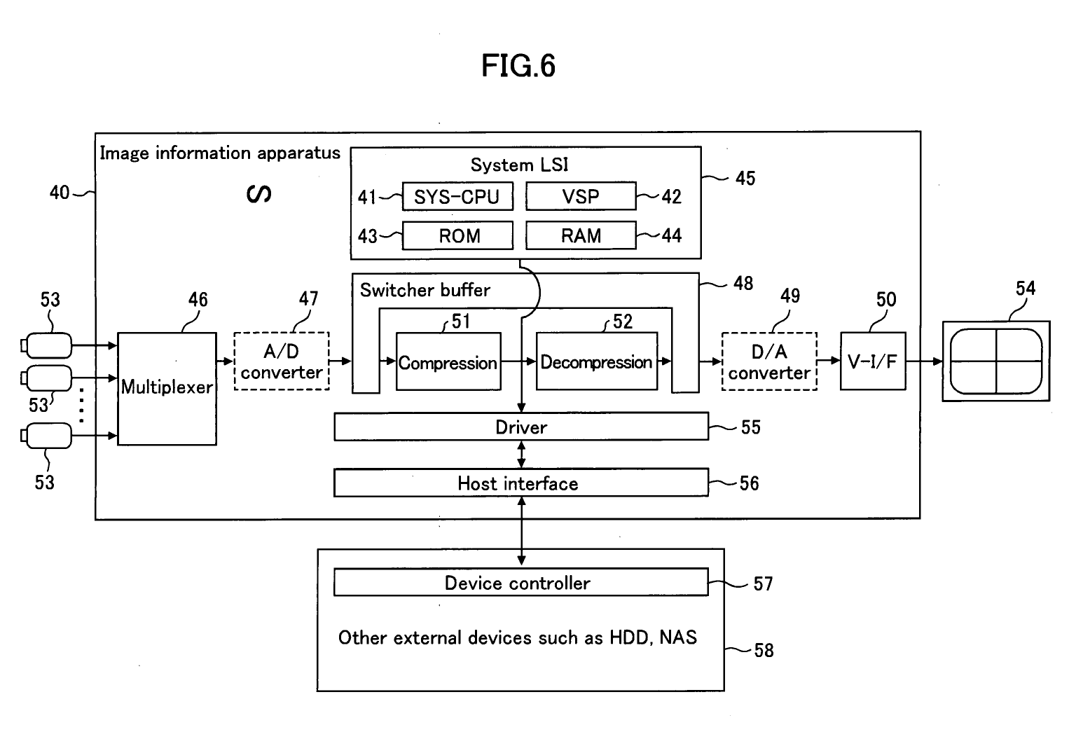

FIG. 6 is a block configuration view when other external apparatuses (for example, an HDD and NAS) are connected to the image information apparatus 40. Numeral 40 denotes the image information apparatus; and numeral 45 denotes a system LSI that is composed of portions as a SYS-CPU (system CPU) 41 for controlling the system, a VSP (video signal processor) 42 for processing image signals, a ROM 43, and a RAM 44.

Numeral 46 denotes a multiplexer; numeral 47 denotes an analog-digital (A/D) converting means; numeral 48 denotes a switcher buffer; numeral 49 denotes a digital-analog (D/A) converting means; numeral 50 denotes a video interface; numeral 51 denotes an image compression means; numeral 52 denotes an image decompression means; numeral 53 denotes cameras; and numeral 54 denotes a display unit.

It becomes possible for the image information apparatus 40 to operate and control the external equipment 5, based on a command from the SYS-CPU 41, with a driver 55 controlling, through a host interface 56, a device controller 57 included in external appliances 58 such as an HDD and an NAS.

In the example represented in the figure, the plurality of cameras 53 is connected to the outside of the image information apparatus 40. Image signals from these cameras 53 (camera input) are inputted to the multiplexer 46, so that each of the image signals to be inputted into the image information apparatus 40 can be switched by the multiplexer.

The camera input having been chosen by the multiplexer 46 is digitized by the analog-digital converting means 47. This digitized data, after passing through the switcher buffer 48, is compressed by the image compression means 51, and then stored in an external storage device such as an HDD.

During a normal monitoring operation, the camera input outputted from the multiplexer 46 is synthesized by the switcher buffer 48. Then, the composite image data is converted into an analog image signal by the digital-analog converting means 49, and displayed on the external monitor 54 through the video interface (V-I/F) 50.

On the other hand, during a playback operation, image data read out from the external apparatuses 58 such as an HDD is decompressed by the image decompression means 52. Then, the decompressed image data and each of the camera input are synthesized by the switcher buffer 48. The composite image data is converted into an analog image signal by the digital-analog converting means 49, and displayed on the external monitor 54 through the video interface (V-I/F) 50.

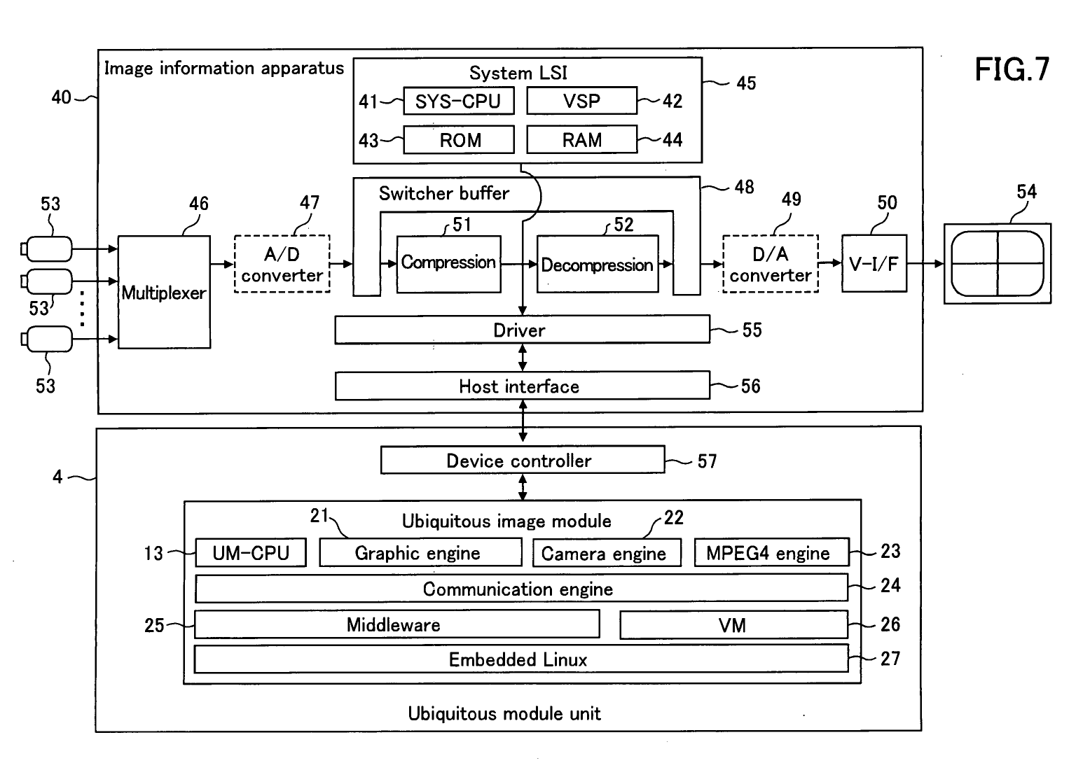

FIG. 7 is an example illustrating a configuration in which the external apparatuses 58 such as an HDD and an NAS in FIG. 6 are removed from the image information apparatus 40, but instead the ubiquitous image module unit 4 is connected to the image information apparatus 40 through the host interface 56 that is a connection interface.

The ubiquitous image module unit 4, after being connected to the network 1 (for example, the Internet) through the communication engine 24 based on a command from the UM-CPU 13, starts reading out image and audio data from other image information apparatuses connected to the network 1.

The image and audio data having been read out is decoded and graphic-processed by hardware engines such as the MPEG4 engine 23 and the graphic engine 21, outputted from the ubiquitous image module unit 4 in a data format usable by the image information apparatus 40, and then inputted into the image information apparatus 40. The data inputted into the image information apparatus 40 is signal-processed, by the video interface (V-I/F) 50, into a state in which the data can be displayed on the display unit 54, and then displayed on the display unit 54.

Moreover, a moving-picture or still-picture file inputted from the cameras 53 is, after image processing operations such as pixel number conversion and rate conversion have been performed by the camera engine 22 of the ubiquitous image module unit 4, graphic-processed by the graphic engine 21, and outputted in a data format usable by the image information apparatus 40. The data inputted into the image information apparatus 40 is also signal-processed, by the video interface (V-I/F) 50, into a state in which the data can be displayed on the display unit 54, and then displayed on the display unit 54.

Here, the processing by each hardware engine set forth is merely an example, and therefore the kind, a function or the like of the hardware engine can be suitably chosen.

In the above explanation, an example of a system has been explained in which the system displays the image data read out, based on the command from the UM-CPU 13, by the ubiquitous image module unit 4 connected to the image information apparatus 40; similarly, using a configuration that includes the ubiquitous image module unit 4 for processing audio signals, the configuration can also be applied to other functions such as those of playback apparatuses for audio input, display/distribution apparatuses of text input, and a storage device for storing input information.

Moreover, the apparatus can be also configured to include two ubiquitous image module units 4 that process, for example, image signals and audio signals, or include a plurality of other ubiquitous image module units 4.

<Explanation Relating to Network Connection>

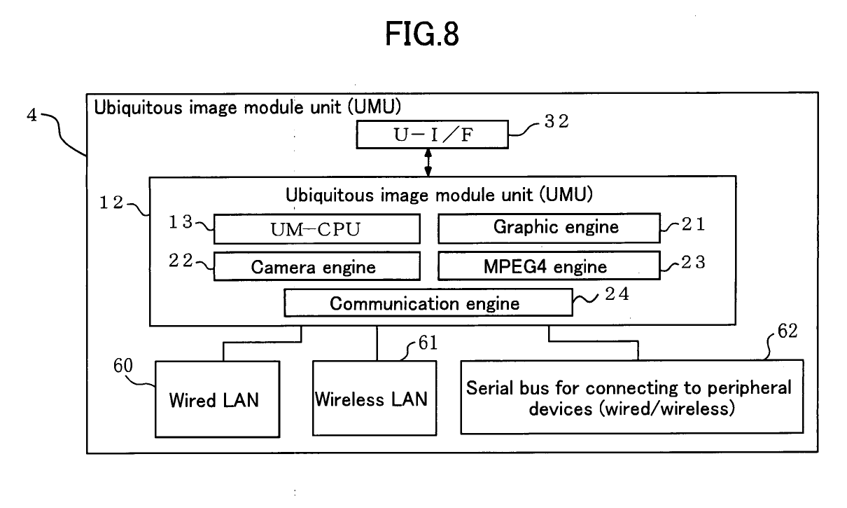

FIG. 8 is an example illustrating a specific configuration of the communication engine 24, in the ubiquitous image module unit 4 represented in FIG. 7, for connecting to an Internet environment.

The communication engine 24 includes a hardware engine and connection terminals for such as a wired LAN, a wireless LAN, and a Serial BUS. In the ubiquitous image module unit 4 configured such as above, connection to the network becomes possible through the wired LAN, the wireless LAN, and the Serial BUS such as IEEE-1394. The ubiquitous image module can also be configured not only to have terminals compatible with all of the connections, but to have a terminal compatible with any one of the connections. These terminals, etc. may be suitably chosen in accordance with concerned networks or products.

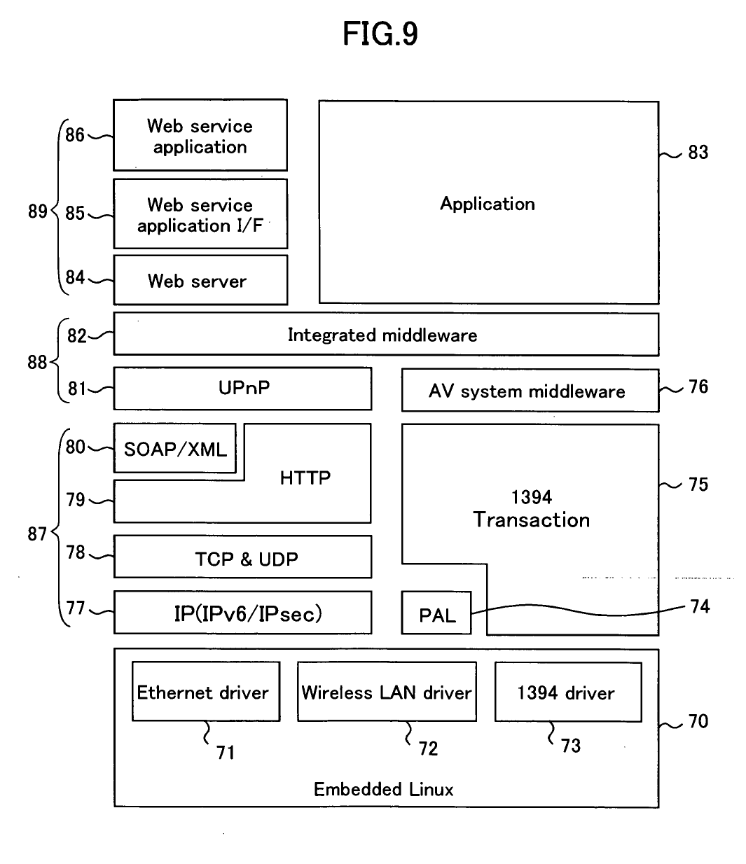

FIG. 9 is a view illustrating an example of a software block configuration of middleware in accordance with the Internet communication protocol in the communication engine 24 represented in FIG. 8.

Here, FIG. 9 represents a vertical relationship of each software block layer, that is, it schematically represents a relationship among embedded Linux 70 being the bottom layer (the nearest layer to the hardware), an application 83 being the top layer (the most distant layer from the hardware), and layers that intervene therebetween.

Similar to the configurational example represented in FIG. 8, a communication interface represented in FIG. 9 uses, for example, three kinds of hardware, that is, a wired LAN including 10BASE-T (transfer rate of 10 Mbps at the Ethernet physical layer. Here, “Ethernet” is a registered trademark of Xerox Corporation) and 100BASE-TX (transfer rate of 100 Mbps at the Ethernet physical layer), a wireless LAN including IEEE802.11a/b/g, and hardware for high speed serial communication such as IEEEE-1394, and device drivers for controlling those hardware.

Here, as represented in FIG. 8, the device drivers for controlling each hardware are, corresponding to each above-described hardware, an Ethernet driver 71, a wireless LAN driver 72, and an IEEE-1394 driver 73 (hereinafter referred to as a 1394 driver 73), respectively.

Referring to the figure, an IP stack 77 for processing Internet Protocol is arranged as a layer above those of the Ethernet driver 71 and the wireless LAN driver 72.

This IP stack 77 includes processing to support IPv6 (Internet Protocol version 6) as the next-generation Internet protocol having been further expanded from the present mainstream IP protocol (Internet Protocol version 4), and processing to support a protocol for security, that is, IPsec (IP security).

Above the 1394 driver 73, a 1394 transaction stack 75 is arranged to perform IEEE-1394 transaction processing. Moreover, in order that the 1394 transaction processing can be executed through the wireless LAN, a PAL (protocol adaptation layer) 74 is arranged between the wireless LAN driver 72 and the 1394 transaction stack 75.

The PAL 74 performs protocol conversion between the 1394 transaction and the wireless LAN. A TCP/UDP (transmission control protocol/user datagram protocol) stack 78 as a transport layer is arranged above the IP stack 77.

An HTTP (hyper text transfer protocol) stack 79 is arranged above the TCP/UDP stack 78 to perform protocol processing of HTTP.

Moreover, an SOAP/XML (simple object access protocol/extensible markup language) stack 80 is arranged, above the HTTP stack 79, to call data or service included in other computers, and performs protocol processing of SOAP for performing message communication based on XML using HTTP.

In the layers above that of embedded Linux 70, layers including the HTTP stack 79, the SOAP/XML stack 80, and the 1394 transaction stack 75 are included in middleware 87 conform to the IPv6-compatible Internet communication protocol.

Above the SOAP/XML stack 80 and the HTTP stack 79, as a layer above that, a UPnP (universal plug and play) stack 81 is arranged to perform universal plug-and-play processing as a protocol for realizing a plug-and-play function, based on the Internet communication protocol.

Moreover, AV system middleware 76 is arranged above the 1394 transaction stack 75 to perform processing for realizing a plug-and-play function of a network using IEEE-1394.

Integrated middleware 82 to mutually connect the respective networks is arranged above the UPnP stack 81 and the AV system middleware 76. Layers including the AV system middleware 76, the UPnP stack 81, and the integrated middleware 82 are included in universal plug-and-play middleware 88.

A layer above the integrated middleware 82 becomes an application layer 89. Moreover, in order to perform application linkage to the other computers on the network using SOAP, a Web server program 84, a Web service application interface 85, and a Web service application 86 are hierarchically arranged in a layer above that of the integrated middleware 82.

The Web service application 86 uses service (call data or service included in other computers, or performs message communication) provided by a Web server through the Web service application interface 85.

Here, the application 83 that does not use the service provided by the Web server communicates through the integrated middleware 82. For example, the application 83 such as above can include browser software using HTTP.

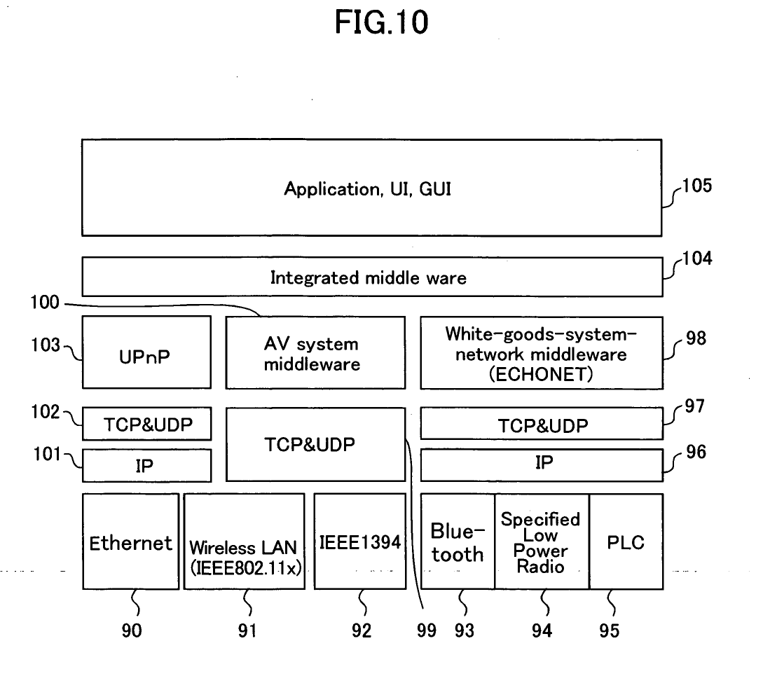

As illustrated in FIG. 10, other communication interfaces may be added to the software block of the communication protocol middleware represented in FIG. 9.

The configuration illustrated in FIG. 10, in addition to the software block configuration (each of device drivers) being connectable to the network by an Ethernet driver 90, a wireless LAN driver 91, and an IEEE-1394 driver 92 that are similar to those represented in FIG. 9, is added with, as a software block (each of device drivers) for connecting to a white goods system network, a Bluetooth driver 93 as a communication interface for mutually converting respective data by using wireless transmission suitable for a cellular phone and a consumer product, a Specified Low Power Radio driver 94 to perform wireless communication using a relatively weak electric wave, and a PLC (power line communication) driver 95 using a power line.

As represented in the figure, the Bluetooth driver 93, the Specified Low Power Radio driver 94, and the PLC driver 95, as the device drivers for controlling respective network interfaces, are arranged in the bottom layer of the software block configuration.

Above these device drivers, an IP stack 96, a TCP/UDP stack 97, and white-goods-system-network middleware (ECHONET) 98 are hierarchically arranged.

In such a case, integrated middleware 104 is arranged above AV system middleware 100, a UPnP stack 103, and the white-goods-system-network middleware 98, so that among networks through the device drivers represented in the figure, that is, through Ethernet, wireless LAN, IEEE-1394, Bluetooth, Specified Low Power Radio, and PLC, mutual communication becomes possible, and thus an operation of sending and receiving data becomes possible among the networks.

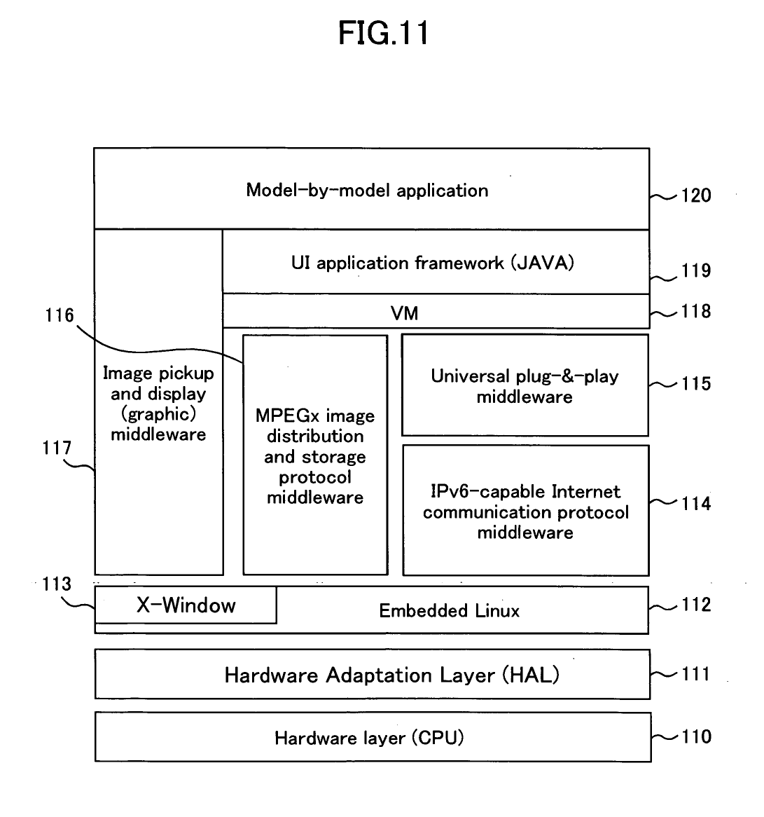

FIG. 11 is a view illustrating an example of a software block configuration of the ubiquitous image module 12 as Embodiment 1. In this example, hardware adaptation software HAL Hardware adaptation layer) 111 is arranged above hardware 110, such as CPU, to absorb the difference by virtualizing model dependence due to differences in microprocessors, cache configurations, I/O buses, interrupt-processing methods, and the like.

Embedded Linux 112 as a multi-task operating system is arranged above the HAL 111. Embedded Linux 112 controls respective hardware devices through software included in the HAL 111, and provides an execution environment of applications corresponding to each of the hardware devices.

Moreover, as a graphic system operating on embedded Linux 112, an X-Window (X-Window is a trademark registered by X Consortium Inc.) 113 is used. In the configuration illustrated in FIG. 11, four kinds of middleware operating in the layer above embedded Linux 112 are arranged, which are hereinafter explained.

First middleware performs communication processing for connection with the Internet, and is IPv6-compatible Internet communication protocol middleware 114 that also supports the IPv6 protocol having been explained in advance.

Second middleware is universal plug-and-play middleware 115 for automatically setting network connection with an apparatus when the apparatus is connected to the network.

This universal plug-and-play middleware 115 is hierarchically arranged in a layer above the IPv6-compatible Internet communication protocol middleware 114, so as to be able to use the protocol belonging to the IPv6-compatible Internet communication protocol middleware 114.

Third middleware is MPEGx image distribution storage protocol middleware 116 for performing processing operations of distribution, storage, and the like of multimedia data, by combination of encode/decode processing corresponding to MPEG2 or MPEG4, meta-data processing conform to MPEG7, and content management processing conform to MPEG21.

Fourth middleware is image pickup and display middleware 117 for taking control of the camera 53 and performing two-dimensional/three-dimensional graphic processing.

A Java virtual machine (represented as “VM” in the figure; Java is a registered trademark of Sun Microsystems, Inc.) 118, which the application-executing environment of Java, among the four kinds of middleware, is arranged in a layer above the universal plug-and-play middleware 115 and the MPEGx image distribution storage protocol middleware 116.

Moreover, a UL application framework (user interface application framework) 119 for facilitating creation of an application including a user interface is arranged in a layer above the Java virtual machine 118. Here, in this example, the UI application framework 119 is arranged in a layer above the Java virtual machine VM 118, and uses a JAVA-compatible framework.

The UI application framework 119 is a set of classes operating on, for example, the Java virtual machine 118. A model-by-model application 120 for realizing, by using the UI application framework 119 and the image pickup and display middleware 117, a function needed for each image information apparatus (model) to which the ubiquitous image module 12 is connected is arranged in the uppermost layer of the software block configuration represented in the figure.

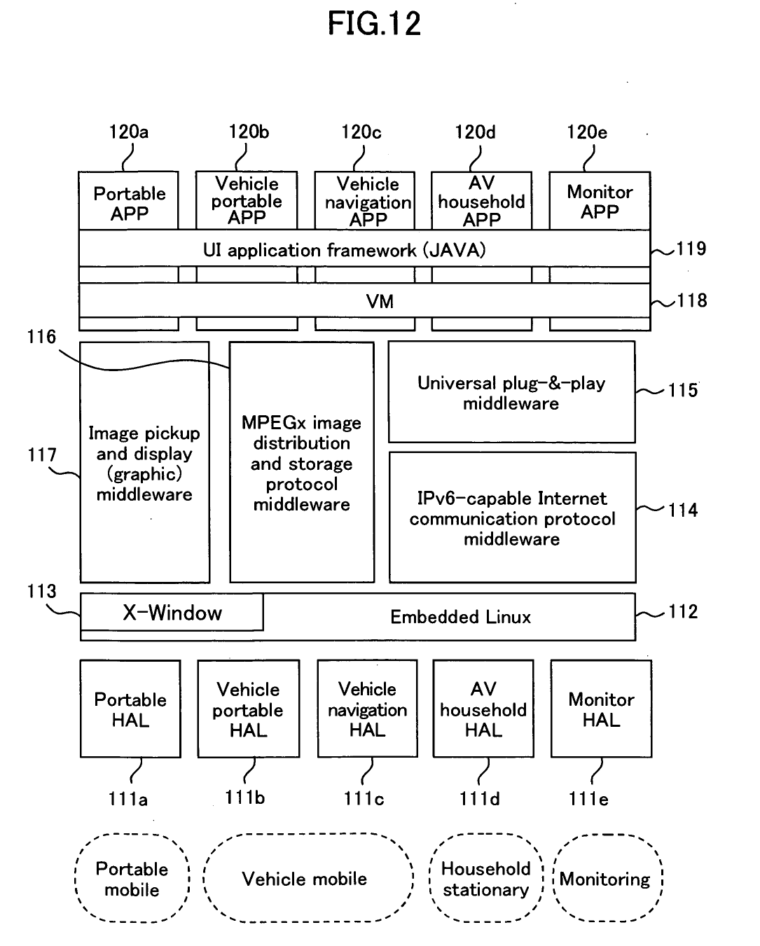

FIG. 12 is a view illustrating a software block configuration in which the ubiquitous image modules 12 are connected (applied) to each model. The configurational example illustrated in FIG. 12 not only includes the software block configuration represented in FIG. 11, but also includes software block configurations associated with a plurality of different models.

The configurational example represented in FIG. 12 includes the uppermost application layer 120e for each model, (in the example in the figure, a portable APP (portable-device application) 120a, a vehicle portable APP (in-vehicle portable-device application) 120b, a vehicle navigation APP (in-vehicle navigation application) 120c, an AV home-use APP (audio-visual household application) 120d, and a monitor APP (monitor application) 120e.) Hereinafter, these are referred to as APPs 120a-120e.

Moreover, HALs (hardware adaptation layers) 111a-111e for absorbing the difference in accordance with hardware are arranged in a layer above each layer of hardware, exemplified in the figure, such as a portable mobile, a vehicle mobile, a home-use stationary appliance, and a monitoring apparatus.

In the example represented in the figures, the portable HAL (portable-device HAL) 111a, the vehicle portable HAL (in-vehicle portable-device HAL) 111b, the vehicle navigation HAL (in-vehicle navigation HAL) 111c, the AV home-use HAL (audio-visual home-use HAL) 111d, and the monitor HAL (monitoring apparatus HAL) 111e are provided in accordance with models to be connected. Hereinafter, these are referred to as HALs 111a-111e.

These HALs 111a-111e are software composed of a portion to take control specific to each model, and a portion interfacing with embedded Linux 112 that is provided above these HALs 111a-111e.

On the other hand, the APPs 120a-120e are supplied with processing output of each middleware outputted from the image pickup and display middleware 117, the MPEGx image storage protocol middleware 116, and the universal plug-and-play middleware 115 that lie under these APPs 120a-120e, and the processing is performed in respective APPs 120a-120e in accordance with each model.

Here, the APPs 120a-120e include the Java virtual machine 118 and the UI application framework 119, and are configured to be able to send and receive data each other among the APPs 120a-120e.

Moreover, the other layers in the software block are configured to be shared. By configuring as above, processing appropriate to each model can be performed in each of the APPs 120a-120e, and functions corresponding to different model can also be realized with the minimum size of configuration.

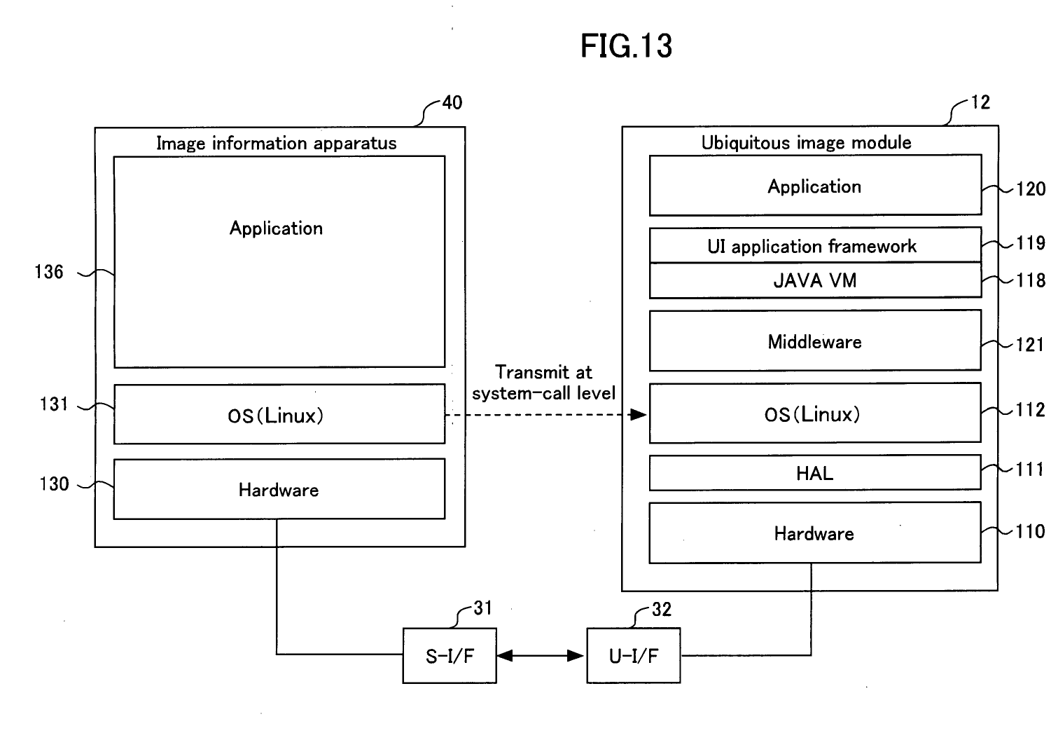

FIG. 13-FIG. 15 are explanatory views illustrating correlations between software blocks of the image information apparatus 40 and software blocks of the ubiquitous image modules 12.

<Transparent Access at System-Call Level>

FIG. 13 illustrates a case in which the software configurations of the image information apparatus 40 and the ubiquitous image module 12 agree up to the hierarchical levels of the operating systems. That is, the software block configuration of the ubiquitous image module 12 represented in FIG. 13 is for the most part similar to those having been explained referring to FIG. 12.

That is, the HAL 111 is arranged between the hardware 110 and embedded Linux 112 as the operating system; however, because the HAL 111 comes to play the role of an interface between the hardware 110 and embedded Linux 112, the HAL 111 for the most part can be considered to be part of either the hardware 110 or embedded Linux 112.

Moreover, the middleware 121, the Java virtual machine 118, and the UI application framework 119 each are arranged between embedded Linux 112 and the application 120; however, because these middleware 121, Java virtual machine 118, and UI application framework 119 come to play the role of interfaces between embedded Linux 112 and the application 120, these middleware 121, Java virtual machine 118, and UI application framework 119 for the most part can be considered to be part of either the application 120 or embedded Linux 112.

Here, the software block configuration of the image information apparatus 40 is made to be a hierarchical structure similar to the software block configuration of the ubiquitous image module 12.

As described above, by matching the hierarchical structures of the software blocks between the ubiquitous image module 12 with the image information apparatus 40, for example, embedded Linux 131 of the image information apparatus 40 can be configured in such a way that embedded Linux 112 of the ubiquitous image module 12 can be transparently accessed at a system-call level (specified function, which can be called from process, among functions that are provided by a basic function of an operating system such as memory management and task management included in the kernel of the operation system).

Accordingly, embedded Linux 131 of the image information apparatus 40 and embedded Linux 112 of the ubiquitous image module 12 can be logically hardware-wise and/or software-wise) connected (FIG. 13).

As a result, for example, using “open” command of a program in the image information apparatus 40, a hardware device connected to the ubiquitous image module 12 can be operated (opened).

<Transparent Access at API Level>

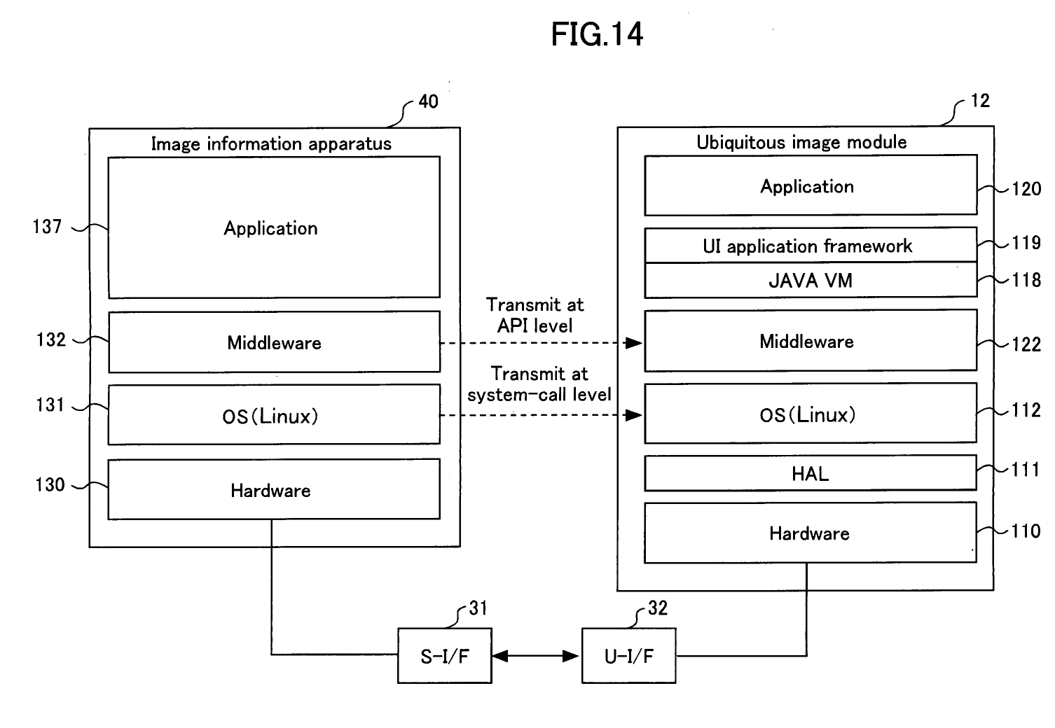

FIG. 14 is a view illustrating a software block configuration in which, similar to the configuration of the ubiquitous image module 12 represented in FIG. 13, the HAL 111 is arranged between the hardware 110 and embedded Linux 112 as the operating system, and the middleware 121, the Java virtual machine 118, and the UI application framework 119 each are arranged between embedded Linux 112 and the application 120.

The difference between the configuration represented in FIG. 14 and the configuration represented in FIG. 13 is that, in the image information apparatus 40, middleware 132 is arranged between embedded Linux 131 and an application 137.

Owing to such configuration, each software block configuration of the image information apparatus 40 and the ubiquitous image module 12 agrees up to each hierarchical levels of the middleware 132 and middleware 122 each.

That is, the middleware 132 of the image information apparatus 40 and the middleware 122 of the ubiquitous image module 12 are configured to be transparent to each other at the middleware API (application program interface) level.

Accordingly, with a program in the image information apparatus 40 calling the middleware API, operating the middleware 122 included in the ubiquitous image module 12 becomes possible, and with a program in the ubiquitous image module 12 calling the middleware API of the image information apparatus 40, operating the middleware 132 included in the image information apparatus 40 becomes possible.

<Transparent Access at Application-Design-Data Level>

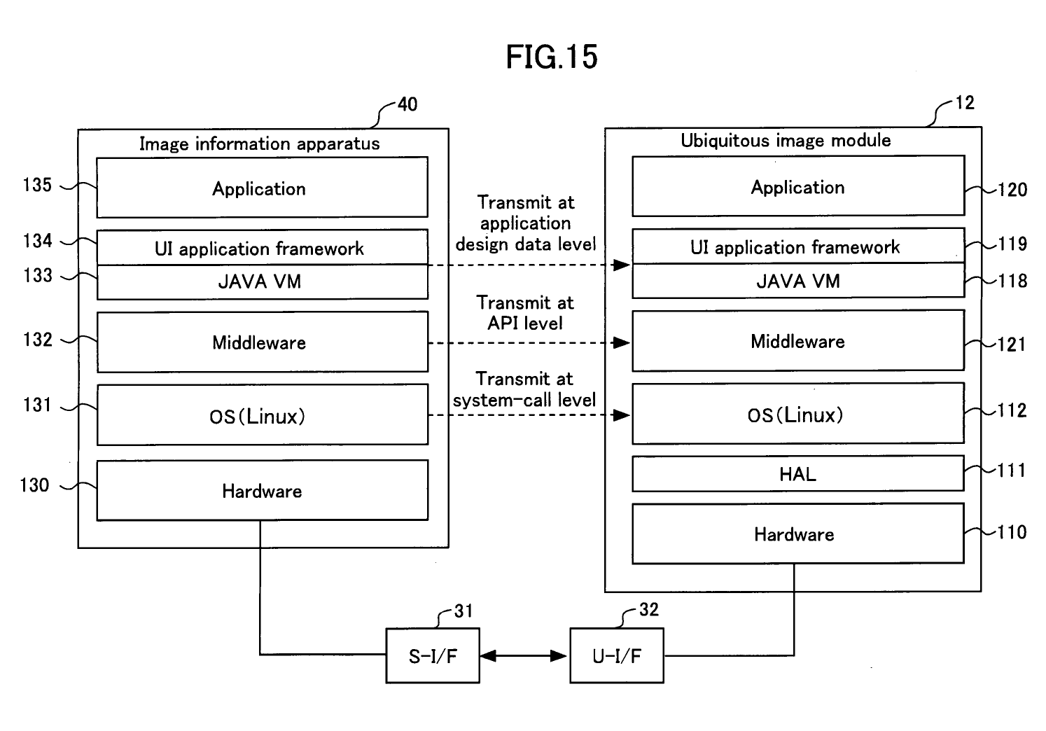

FIG. 15 is a view illustrating a software block configuration in which, similar to the configuration of the ubiquitous image module 12 represented in FIG. 14, the HAL 111 is arranged between the hardware 110 and embedded Linux 112 as the operating system, and the middleware 121, the Java virtual machine 118, and the UI application framework 119 each are arranged between embedded Linux 112 and the application 120.

The difference between the configuration represented in FIG. 15 and the configuration represented in FIG. 14 is that, in the image information apparatus 40, the middleware 132, a Java virtual machine 133, and a UI application framework 134 are arranged in series towards the upper level between embedded Linux 131 and an application 135.

According to such configuration, each software block configuration of the image information apparatus 40 and the ubiquitous image module 12 agrees up to each hierarchical level on the software block configurations of the Java virtual machine 133 and the UI application framework 134 included in the image information apparatus 40, and the Java virtual machine 118 and the UI application framework 119 included in the ubiquitous image module 12.

That is, the configuration between the UI application frameworks 134 and 119 of the Java virtual machine 133 and the UI application framework 134 included in the image information apparatus 40, and the Java virtual machine 118 and the UI application framework 119 included in the ubiquitous image module 12, is made transparent at an application-design-data level when each application of the image information apparatus 40 and the ubiquitous image module 12 is created.

Accordingly, regardless of the platform difference between the image information apparatus 40 and the ubiquitous image module 12, it becomes possible to create each application.

<Correlations in Each Software Block and Each Hardware Engine Between Image Information Apparatus and Ubiquitous Image Module>

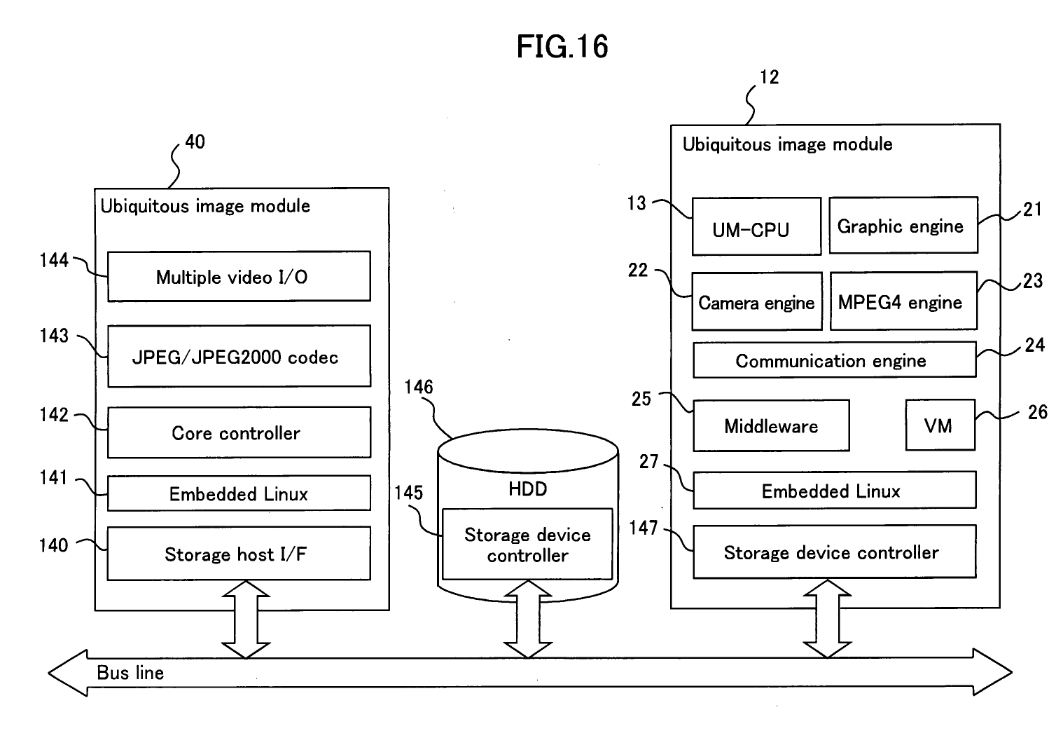

FIG. 16 is a view illustrating a system configurational example when the ubiquitous image module 12 is connected through a bus line to a storage I/F in common with an HDD 146.

The image information apparatus 40 is configured to include a multiple video input/output 144 for transmitting to and receiving from other apparatuses having image output an image signal, a JPEG/JPEG2000 codec 143 for compressing and/or decompressing JPEG/JPEG2000, etc., a storage host interface (represented as a “storage host I/F” in the figure) 140 for controlling the interface of storage apparatus such as an HDD 146, a core controller 142 for controlling the image information apparatus 40, and embedded Linux 141 as the same embedded operating system (OS) as the OS used in the UM-CPU 13.

When image data, for example, included in a camera connected to the network, which is inputted from the multiple video input/output 144 of the image information apparatus 40 is stored in the HDD 146, after this image data is compressed by the JPEG/JPEG2000 codec 143, the core controller 142 controls a storage device controller 145 of the HDD 146 through the storage host interface 140, and thus the compressed image data is stored in the HDD 146.

As described above, an example has been explained in which the image information apparatus 40 stores image data in the external HDD 146; similarly, an example is hereinafter described in which a software block or functional block of the ubiquitous image module 12 connected to the bus line is controlled through the storage host interface 140.

The core controller 142 controls through the storage host interface 140 a storage device controller 147 of the ubiquitous image module 12 connected to the bus line, whereby various engines (such as the camera engine 22 and the graphic engine 21) included in the ubiquitous image module 12 are used.

<Inter-Process Communication>

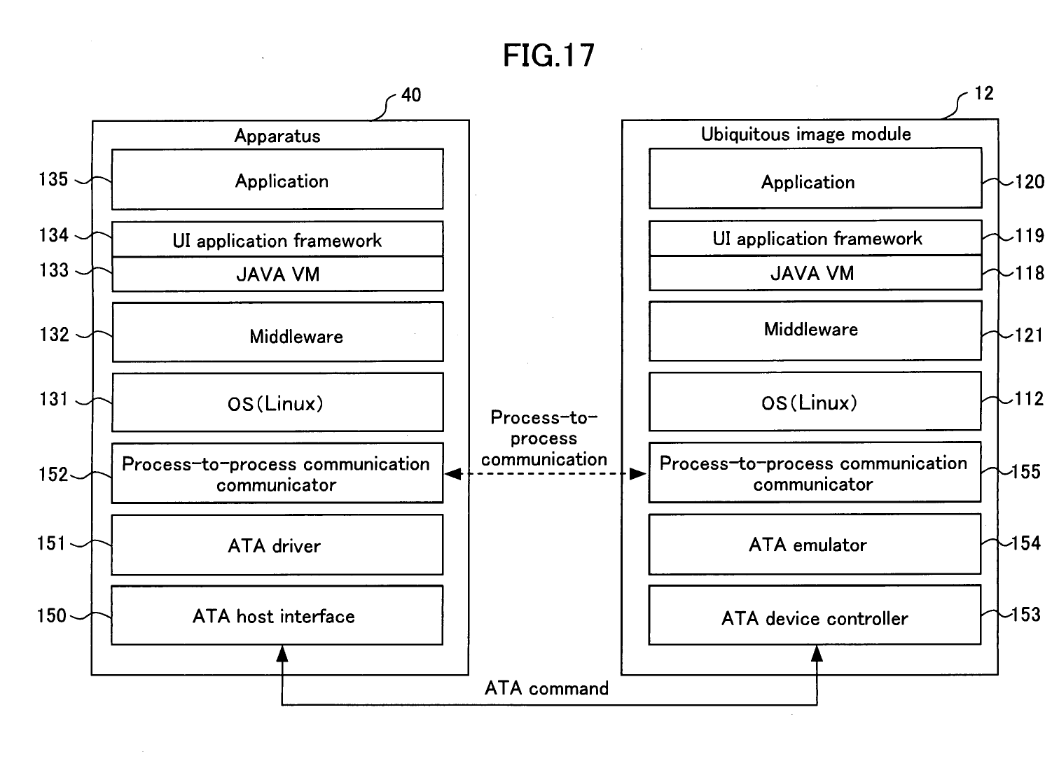

FIG. 17 is a view illustrating a software block configuration when an interface according to the ATA standard is used as an interface for connecting the image information apparatus 40 with the ubiquitous image module 12.

The difference between the software block configuration represented in FIG. 17 and the configuration represented in FIG. 16 is described as follows.

That is, in the image information apparatus 40, instead of the hardware 130, an inter-process communication communicator 152, an ATA driver 151, and an ATA host interface 150 have been provided in the lower layer than embedded Linux 131.

Moreover, in the ubiquitous image module 12, an inter-process communication communicator 155, an ATA emulator 154, and an ATA device controller 153 have been provided in the lower layer than embedded Linux 112.

The inter-process communication communicator 152 of the image information apparatus 40 and the inter-process communication communicator 155 of the ubiquitous image module 12 are modules for converting data into commands, according to the ATA standard, as an inter-process communication interface (command interface).

The inter-process communication communicator 152 of the image information apparatus 40 transmits, through the ATA driver 151 and the ATA host interface 150 provided on the side of the image information apparatus 40, to the ATA device controller 153 of the ubiquitous image module 12 a command of ATA (ATA command).

The ATA device controller 153 provided on the side of the ubiquitous image module 12 that has received the ATA command controls the ATA emulator so as to analyze the ATA command, and converts it by the inter-process communication communicator 155 into control data for inter-process communication.

Accordingly, it becomes possible for the process of the image information apparatus 40 and the process of the ubiquitous image module 12 to communicate between the processes. Thus, the image information apparatus 40 can use, for example, the application 120 included in the ubiquitous image module 12 connected by an interface according to the ATA standard (ATA interface).

<System Configuration when Including ATA Interface>

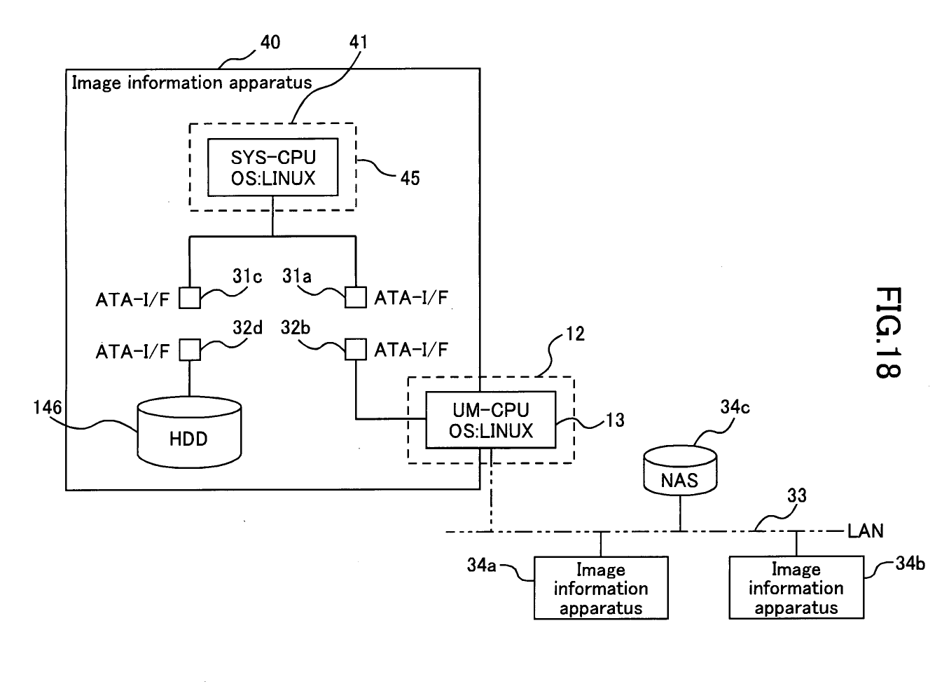

FIG. 18 is a view illustrating an example of a system configuration in Embodiment 1, when the ubiquitous image module 12 is connected to the ATA interface of the image information apparatus 40.

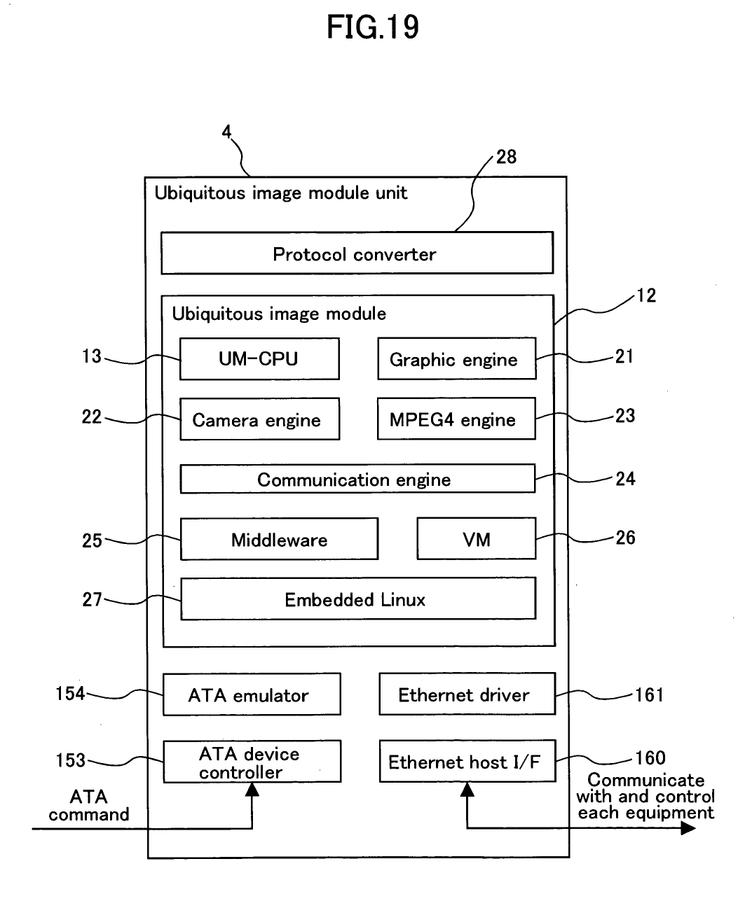

FIG. 19 is a view illustrating a software block configuration in the ubiquitous image module unit 4 represented in FIG. 18.

The ubiquitous image module unit 4 includes an ATA interface 32b, and it becomes possible to be used by the ATA interface 32b being mounted to an ATA interface 31a of the image information apparatus 40.

By mounting the ubiquitous image module unit 4, the image information apparatus 40 can communicate with and control, through the network, other apparatuses such as image information apparatus 34a and 34b as digital video recorders connected to the LAN 33, and an NAS (network attached storage) 34c as a data storage device.

In such cases, in the ubiquitous image module 12, a function for receiving the ATA command, and communicate with apparatuses connected to Ethernet becomes necessary.

Therefore, as represented in FIG. 19, the ubiquitous image module unit 4 including the ubiquitous image module 12 includes the ATA emulator 154 and the ATA device controller 153 for sending and receiving the ATA command, and an Ethernet driver 161 and an Ethernet host I/F 160 for managing communication and control when connecting with Ethernet.

On the other hand, inside the image information apparatus 40, the system CPU (SYS-CPU) 41 and the embedded HDD 146 are connected by the ATA interface 31c of the system CPU (SYS-CPU) 41 and the ATA interface 32d of the HDD 146.

In the image information apparatus 40 and the ubiquitous image module 12 configured as above, it becomes possible to mutually send and receive ATA commands; thus, the ubiquitous image module 12 receives ATA commands from the system CPU (SYS-CPU) 41 in the image information apparatus 40.

The ATA device controller 153 analyzed the ATA commands that have been received by controlling the ATA emulator 154.

The commands having been analyzed are converted by the protocol converter 28 into a protocol used on Ethernet, and communicate with and control, through an Ethernet driver 161 and an Ethernet host interface 160, each apparatus connected to the LAN 33.

By adopting such a configuration, for example, when it is determined that empty capacity of the internal HDD 146 included in the apparatus is not sufficient for data (content data) to be stored, in the image information apparatus 40 having the ubiquitous image module unit 12, it becomes possible to record all image data or remaining image data that could not be stored in the HDD included in the image information apparatus 40 itself in an internal HDD of the image information apparatus 34a or 34b such as the digital video recorder, or in a storage device such as the NAS (network attached storage) 34c outside the apparatus, connected to the LAN 33 to which the ubiquitous image module unit 12 is connected.

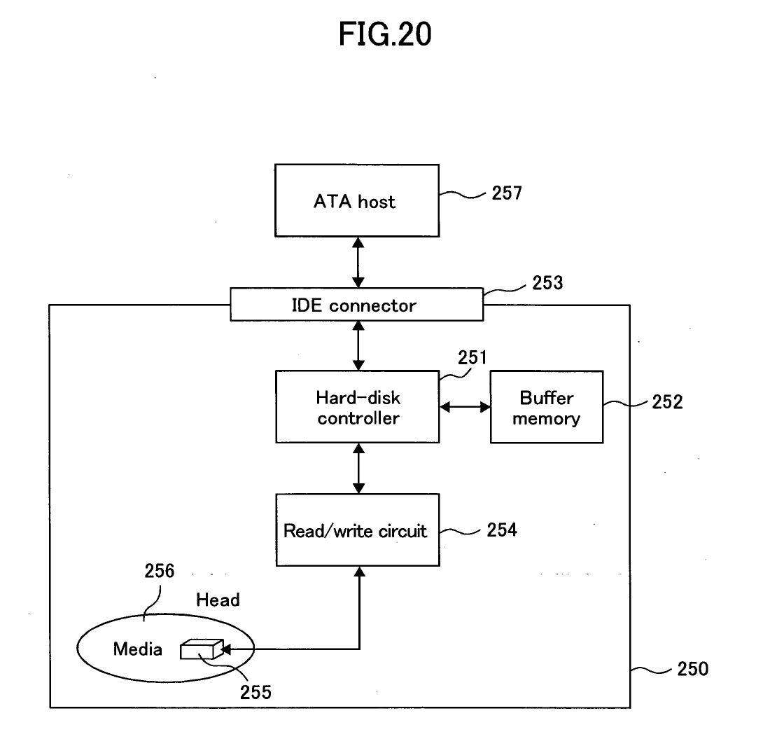

Now, a hardware configuration of a general hard-disk using an ATA interface is illustrated in FIG. 20. Here, a hard-disk 250 represented in FIG. 20 is, for example, the internal hard-disk of the image information apparatus 34a, the hard-disk in the NAS 34, or the HDD 146 in FIG. 16, and the hard-disk 250 becomes an ATA device. A hard-disk controller 251 plays a central role for controlling reading and writing data, and connected to a buffer memory 252 that stores data for temporarily reading and writing. Moreover, the hard-disk controller 251 is physically connected to an ATA host 257 through an IDE (integrated drive electronics) connector 253. Furthermore, the hard-disk controller 251 is connected to a head 255 for writing data into a medium 256 through a reading/writing circuit 254 for processing data encoding/decoding, etc. Here, in an actual hard-disk drive, a spindle motor for rotating the medium 256, a spindle driver for controlling the spindle motor, a stepping motor for operating the head 255, and a stepping-motor driver for controlling the stepping motor, etc. are included other than the above configurational elements; however, because only a portion related to a dataflow is represented, these elements are not represented in the figure.

Moreover, the hard-disk controller 251 includes an ATA device controller, and sending and receiving data between the ATA host 257 and the hard-disk controller 251 are entirely performed through ATA registers in the ATA device controller. The main registers related to reading and writing data are: a command register for executing command from the ATA host 257 to the hard-disk 250 as the ATA device; a status register for informing to the ATA host 257 a state of the ATA device; a data register for writing and reading actual data from the ATA host 257; and a head/device register, a cylinder low register, a cylinder high register, and a sector number register (hereinafter, these four registers are collectively referred to as “device/head register, etc.”) for designating a physical sector in the medium 256 into which data is written.

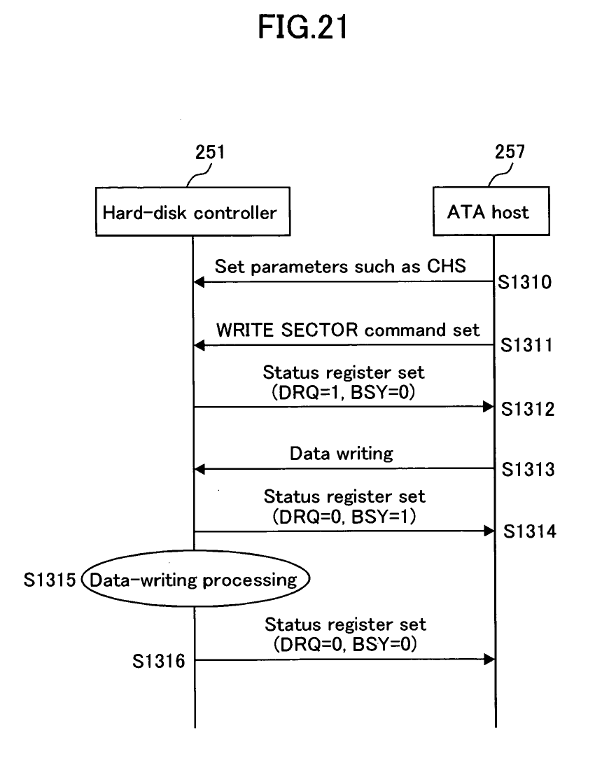

FIG. 21 illustrates a sequence, in which a “write sector” command is taken as an example, when data is written from the ATA host 257 into the hard-disk 250. First, after selecting as an ATA device the hard-disk 250 being a destination into which data is written, in Step S1310, the ATA host 257 sets a head number, a cylinder number, and a sector number for designating the physical sector of the medium 256 as a writing destination, to the ATA register such as the device/head register, etc. Next, in Step S1311, the ATA host 257 write the command code “30h” corresponding to the “write sector” command into the command register in the ATA register of the hard-disk controller 251. The hard-disk controller 251, after BSY bit of the status register is set to “1” in order to indicate that writing data is under preparation, actually prepares for writing the data. After the preparation has been completed, in order to indicate the preparation having completed, in Step S1312, the hard-disk controller 251 resets the DRQ bit and the BSY bit of the status register to “1” and “0”, respectively. In Step S1313, the ATA host 257 checks a state of this status register, and then continuously writes data by sectors into the data register in the ATA register. Here, when this data writing is started, in Step S1314, in order to indicate that the data is just under writing in the data register, the hard-disk controller 251 simultaneously sets the DRQ bit and the BSY bit of the status register to “0” and “1”, respectively. Here, data for one sector to be written in the data register is continually transmitted to the buffer memory 252 by the hard-disk controller 251. Simultaneously, the hard-disk controller 251 controls the head 255, and continually processes writing data that has been stored in the buffer memory 252 through the read/write circuit 254, into the sector, in the medium 256, having been designated in Step S1310 (Step S1315). When writing the data into the medium 256 is perfectly completed, in Step S1316, in order to indicate that writing the data into the medium 256 has been perfectly completed, the hard-disk controller 251 sets both the DRQ bit and the BSY bit of the ATA status register to “0”. At this moment, writing the data for one sector into the hard-disk 250 is completed.

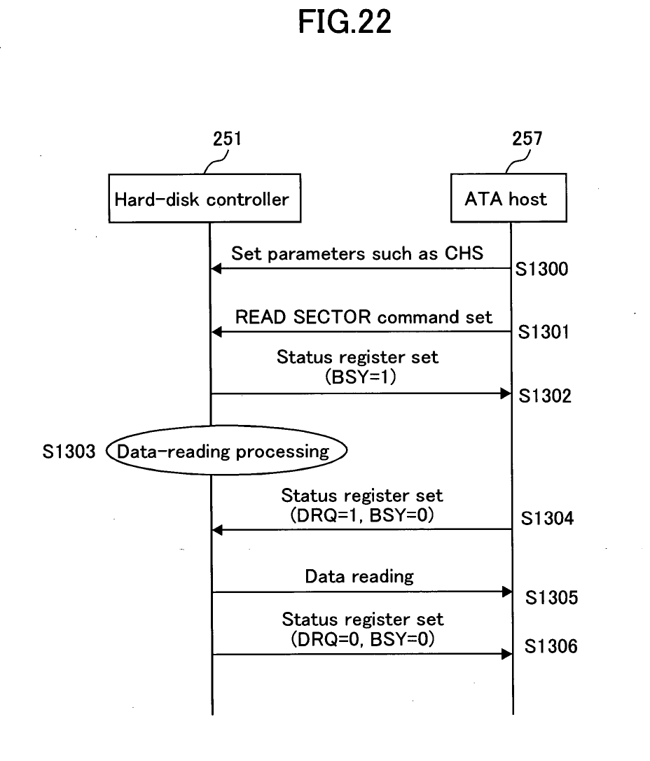

Next, a sequence is illustrated in FIG. 22, in which a “read sector” command is taken as an example, when the ATA host 257 reads out data from the hard-disk 250. First, after selecting as an ATA device the hard-disk 250 being a destination from which data is read out, in Step S1300, the ATA host 257 sets a head number, a cylinder number, and a sector number for designating the physical sector of the medium 256 as a reading destination in response to the ATA register such as the device/head register, etc. Next, in Step S1301, the ATA host 257 writes the command code “20h” corresponding to the “read sector” command into the command register in the ATA register of the hard-disk controller 251. In Step S1302, in order to indicate that the data is just under reading out from the medium 256, the hard-disk controller 251 sets the BSY bit of the status register to “1”. Simultaneously, the hard-disk controller 251 controls the head 255 in Step S1303, and reads out data, through the read/write circuit 254, from the sector in the medium 256 having been designated in Step S1300, and then, transmits to the buffer memory 252 data for one sector data. When storing into the buffer memory 252 the data is completed, in Step S1304, in order to indicate that the storage of the data into the buffer memory 252 has been completed, the hard-disk controller 251 sets the DRQ bit of the ATA status register to “1” and the BSY bit to “0”. In Step S1305, the ATA host 257 checks a state of this status register, and then continuously reads out data by sectors from the data register in the ATA register. When reading the data for one sector is completed, in Step S1306, the hard-disk controller 251 sets both the DRQ bit and the BSY bit of the status register in the ATA register to “0”. At this moment, the reading of the data for one sector from the hard-disk 250 is completed. The above description is a general operation of writing data into and reading out data from the hard-disk.

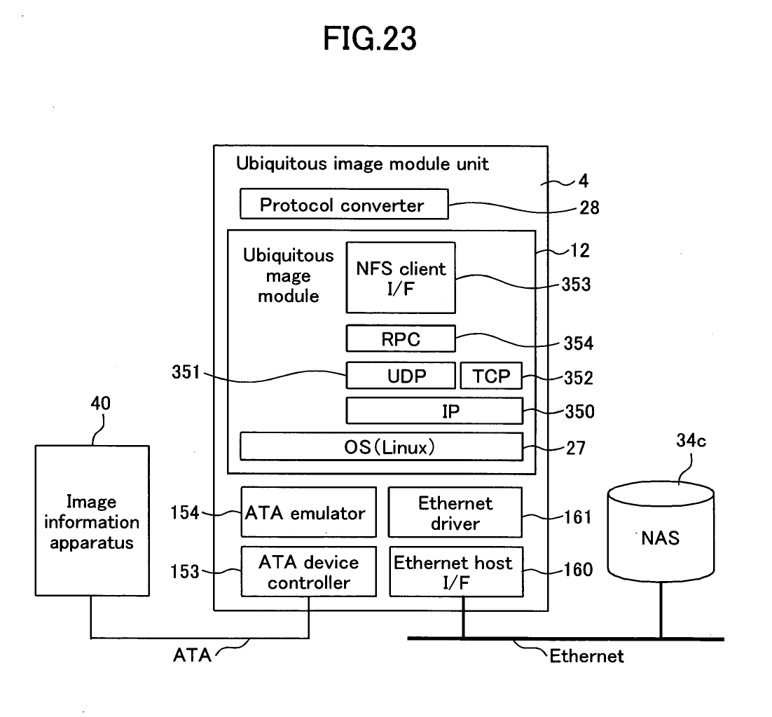

Next, the ubiquitous image module unit 4 for recording image data from the image information apparatus 40 into the NAS 34c that is connected to the LAN is explained. FIG. 23 illustrates a software configuration of the ubiquitous image module unit 12; hereinafter, each configurational element is explained using a LAN OSI reference model. The ubiquitous image module unit 12 and the NAS 34c are connected with each other by Ethernet in a physical layer and a data link layer. In the ubiquitous image module unit 12, an IP 350 as the Internet protocol is included in a network layer, which is a communication protocol, above the physical layer and the data link layer. Here, although not illustrated in the figure, in the NAS 34c IP is also installed as a network layer. Moreover, in the ubiquitous image module unit 12, a TCP 351 and a UDP 352 as transport layers above the network layer are included, and as a protocol for sharing files with apparatuses that are connected to the LAN through the LAN, an NFS (network file system) client I/F 353 is also installed above the session layer. A communication protocol for the file data between the NAS 34c and the ubiquitous image module unit 12 is performed using the NFS. A protocol converter 28 converts an NFS-format command issued from the image information apparatus 40 into ATA-format one. The NFS client I/F 353 is software for performing communication, according to the NFS protocol, with NFS server software, which is not illustrated in the figure, installed in the NAS 34c. The NFS client I/F 353 transmits to and receives from the NAS 34c through the UDP 352 a message for calling a remote procedure corresponding to process requested from the protocol converter 28. As a protocol for calling the remote procedure, RPC remote procedure call) is used.

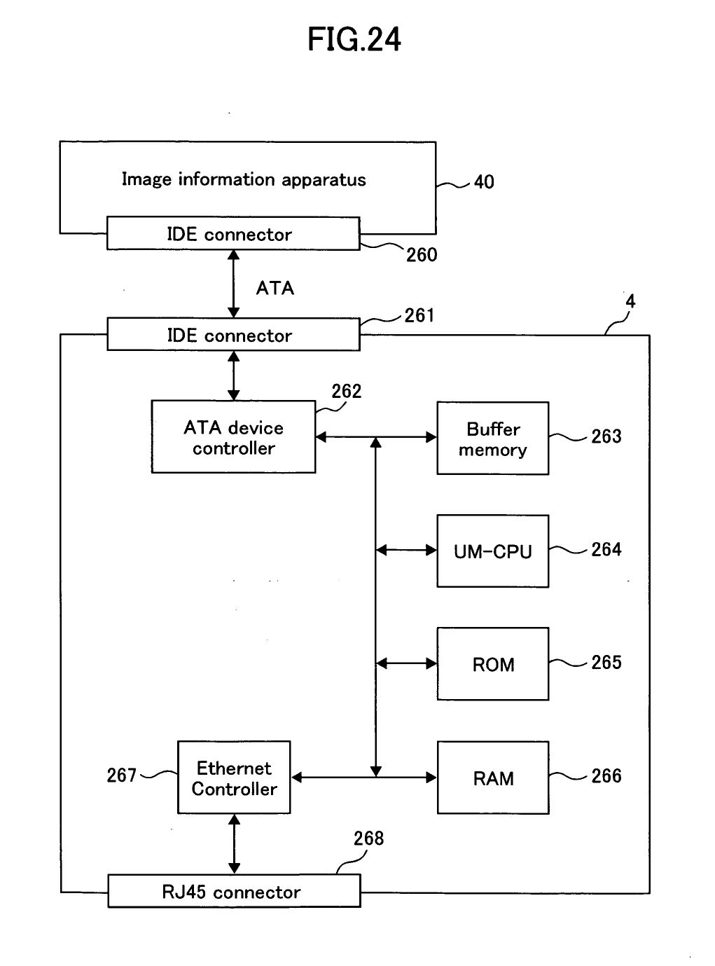

FIG. 24 illustrates a hardware configuration of the ubiquitous image module 12. As illustrated in the figure, the image information apparatus 40 and the ubiquitous image module unit 4 are physically connected using IDE connectors 260 and 261. An ATA device controller 262 is physically connected to the IDE connector 261, and the ATA register in the ATA device controller 262 can be read and written by the CPU of the image information apparatus 40. To the ATA device controller 262, is connected a buffer memory 263 for temporarily storing data that has been written by the image information apparatus 40 and data that has been requested to read our. This buffer memory 263 is included in the ATA device controller 153 represented in FIG. 23, and can also be read and written by a UM-CPU 264, that is, the CPU of the ubiquitous image module 12. Moreover, the ATA register in the ATA device controller can also be read and written by the UM-CPU 264. In the ubiquitous image module unit 4, a ROM 265 for storing programs that the UM-CPU 264 executes and file systems, and a RAM 266 that the UM-CPU 264 uses as a work area when executing a program, etc., other than those described above are mounted, each of which is connected to the UM-CPU 264. Furthermore, an Ethernet controller 267 for controlling Ethernet communication is also connected to the UM-CPU 264, and can read from and write into the UM-CPU 264. A connector 268 such as an RJ45 connector is connected beyond the Ethernet controller 267, and the ubiquitous image module 4 is connected to the Ethernet network through the RJ45 connector 268.

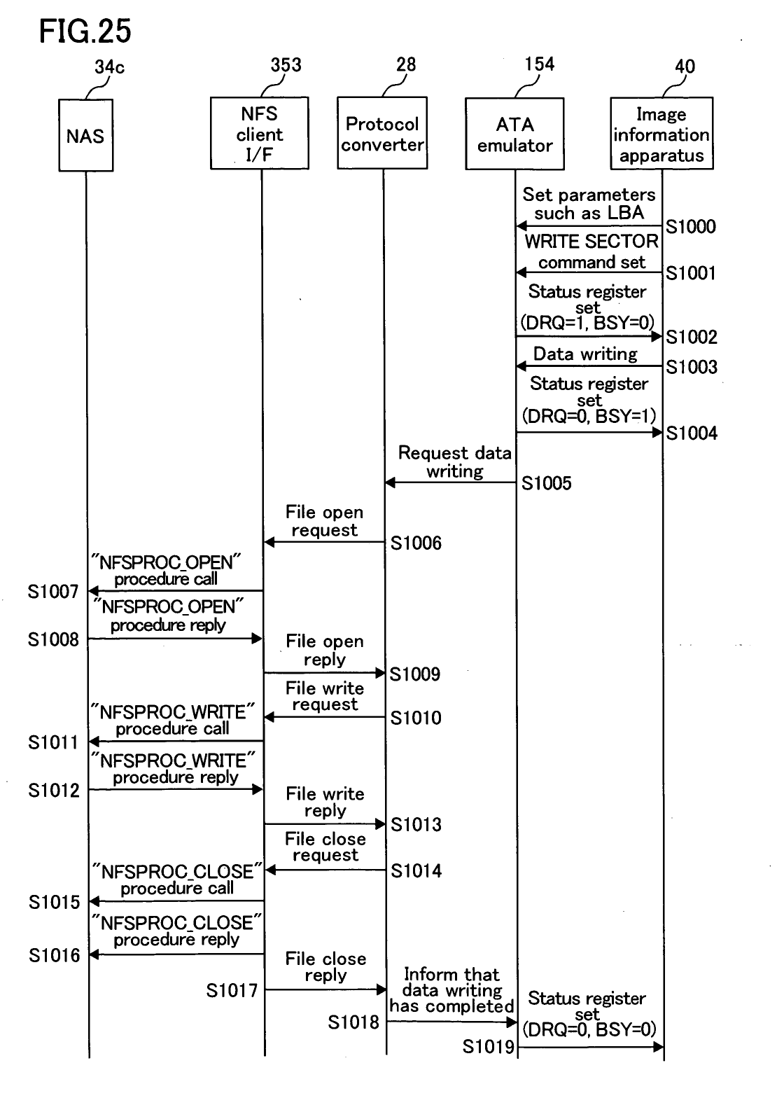

Next, an operation is explained in detail in a case in which data is recorded from the image information apparatus 40 into the NAS 34c. FIG. 25 illustrates a sequence when data is written from the image information apparatus 40 into the NAS 34c. First, the image information apparatus 40 selects and recognizes the ubiquitous image module unit 12 as an ATA device. Thereby, the image information apparatus 40 recognizes that a data writing operation, which is explained hereinafter, is to be performed with respect to the ATA device. Next, in Step S1000, the image information apparatus 40 sets a logical block address LAB, etc., corresponding to the ATA register such as the device/head register in the ubiquitous image module unit 12. Thereby, a destination in which data is written is designated. Next, in Step S1001, the image information apparatus 40 writes the command code “30h” corresponding to the “write sector” command that means writing data for one sector, into the command register of the ATA register in the ubiquitous image module unit 12. The ATA emulator 154, after the BSY bit of the status register is set to “1” in order to indicate that writing data have been prepared, actually prepares for writing the data. After the preparation is completed, in Step S1002, the ATA emulator 154 resets the DRQ bit and the BSY bit of the status register to “1” and “0”, respectively. Thereby, the image information apparatus 40 recognizes, in the ATA device connected to the image information apparatus itself, that the preparation for writing data has been completed. The image information apparatus 40 having recognized a state of the status register in Step S1003, continuously writes data sector-by-sector into the data register in the ATA register. Here, at the same time as this data writing is started, the ATA emulator 154 simultaneously sets the DRQ bit and the BSY bit of the status register to “0” and “1”, respectively (step S1004). Thus, the state of the status register is maintained until Step S1019 described later. That is, the state, in which the DRQ bit and the BSY bit of the status register are set to “0” and “1”, respectively, means that data is written from the image information apparatus 40 into the NAS 34c through the ubiquitous image module 12.

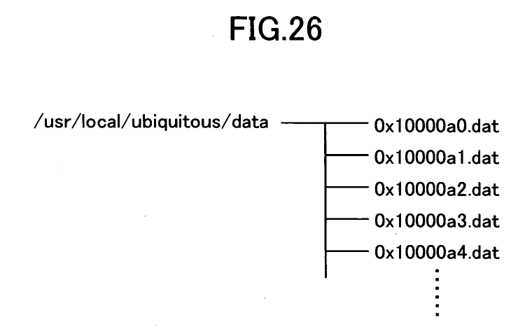

Data for one-sector written in the data register is forwarded, as required, to the buffer memory included in the ATA device controller 153. After writing data for the one-sector into the buffer memory 263 has been completed, in Step S1005, request for writing data from the ATA emulator 154 into the protocol converter 28 is issued. In Step S1006, the protocol converter 28 having received the request for writing data issues to the NFS client I/F the “file open” request. Here, the “file open” request in Step S1006 is a command executed with a file name being designated; therefore, when the designated file exists, the designated existing file is opened, meanwhile, when the designated file does not exist, the designated-name file is newly created. The file opened or newly created by the “file open” request is a file for storing into an arbitrary directory of the NAS 34c data for one-sector that have been written into the buffer memory in Step S1003; therefore, as represented in FIG. 26, a unique file name is desirable, for example, a name corresponding to LBA.

In Step S1007, the NFS client I/F 353 transmits, according to the NFS protocol, an “NFSPROC_OPEN” procedure call message to the NAS 34c, through the UDP 351. The NFS server program in the NAS 34c creates, according to the procedure call message, a file having a file name designated and placed in the directory designated in Step S1006. After creating the file, in Step S1008, the NFS server program transmits to the NFS client I/F 353 an “NFSPROC_OPEN” procedure reply message. In Step S1009, the NFS client I/F 353 replies to the protocol converter 28 “file open” reply indicating that the file has been created. Next, in Step S1010, the protocol converter 28 makes a request to the NFS client I/F 353 for file writing. This file writing request is a request for writing into the file having been opened in Step S1007 data for one-sector stored in the buffer memory 263. In Step S1011, the NFS client I/F 353 transmits to the NAS 34c data for one-sector and an “NFSPROC_WRITE” procedure call message. The NFS server program in the NAS 34c writes, according to this procedure call message, into the designated file the data having been received. After writing has been completed, in Step S1012, the NFS server program transmits to the NFS client I/F 353 an “NFSPROC_WRITE” procedure reply message. In Step S1013, the NFS client I/F 353 replies to the protocol converter 28 a file writing reply.

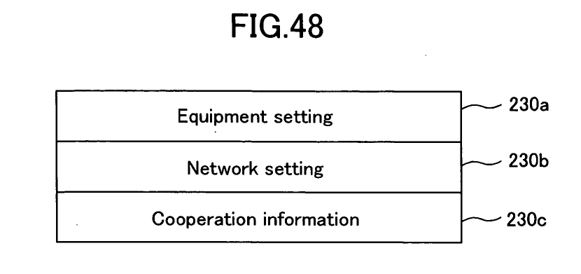

In Step S1014, the protocol converter 28 makes a request for “file dose” to the NFS client I/F 353 for dosing the file in which the data has been written a while ago. In Step S1015, the NFS client I/F 353 having received the “file dose” request replies to the NSA 34c a “NFSPROC_CLOSE” procedure call message. After dosing the designated file according to this procedure call message, in Step S1016, the NFS server program in the NAS 34c transmits to the NFS client I/F 353 a “NFSPROC_CLOSE” procedure reply message. In Step S1013, the NFS client I/F 353 replies to the protocol converter 28 the “file dose” reply. In Step S1018, the protocol converter 28 transmits to the ATA emulator 154 information in which the data writing has been completed. After receiving this, the ATA emulator 154 sets both the DRQ bit and the BSY bit of the status register to “0”. According to the above procedure, data for one-sector is written in the NAS 34c connected with the network. Writing into a plurality of sectors is realized by repeating a series of the operations. In FIG. 48, an example of data files written in the NAS 34c is represented. In this example, the data files are stored below a directory /usr/local/ubiquitous/data. The file names include an extension of “.dat” added to 28-bit LAB represented with hexadecimal number. In this example, data for five sectors in which LBAs are “0x1000a0”-“0x1000a4” is stored.

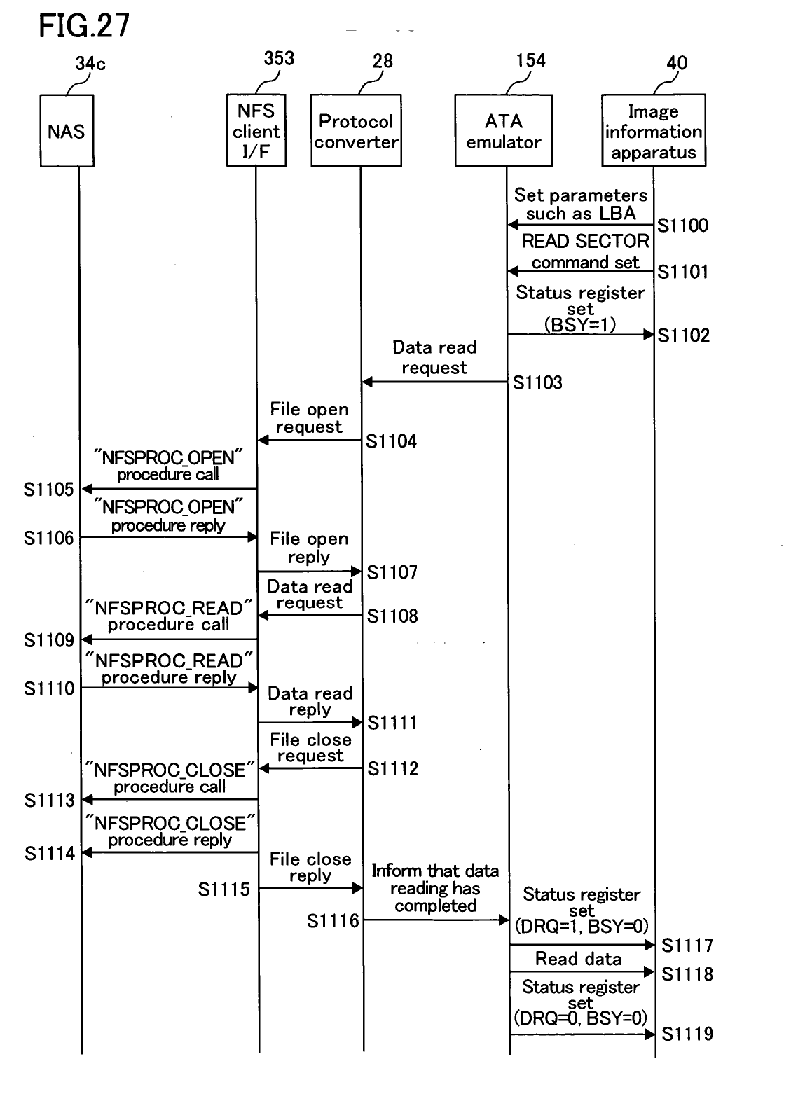

Next, an operation is explained in detail in a case in which data is read out from the NAS 34c to the image information apparatus 40. FIG. 27 illustrates a sequence when the image information apparatus 40 reads out data from the NAS 34c. First, the image information apparatus 40 selects and recognizes the ubiquitous image module unit 12 as an ATA device. Thereby, the image information apparatus 40 recognizes that a data reading operation, which is explained hereinafter, is to be performed to the ATA device. Next, in Step S1100, the image information apparatus 40 sets a logical block address LBA, etc., with respect to the ATA register such as the device/head register in the ubiquitous image module unit 12. Thereby, a destination to which data is read out is designated. Next, in Step S1101, the image information apparatus 40 writes the command code “20h” corresponding to a “read sector” command that means reading data for one-sector, in the command register of the ATA register in the ubiquitous image module unit 12. In Step S1102, the ATA emulator 154 sets the BSY bit of the status register to “1” in order to indicate the reading of data is being processed. Subsequently in Step 1103, request for data reading from the ATA emulator 154 to the protocol converter 28 is issued. In Step 1104, the protocol converter 28 having received the request for the data writing issues to the NFS client I/F 353a “file open” request. This file is a file of data for one-sector stored in an arbitrary directory of the NAS 34c, as explained in the above writing operation section, and the file name is assumed to be given in correspondence to LBA as illustrated in FIG. 48. The protocol converter 28 determines the file name corresponding to LBA of the sector set in the device/head register, etc. In Step S1105, the NFS client I/F 353 transmits, depending on the NFS protocol, the “NFSPROC_OPEN” procedure call message to the NAS 34c through the UDP 351. The NFS server program in the NAS 34c opens, according to the procedure call message, a file on the designated directory, having the designated file name. After the file has been opened, in Step S1106, the NFS server program transmits to the NFS client I/F 353 the “NFSPROC_OPEN” procedure reply message. In Step S1107, the NFS client I/F 353 replies to the protocol converter 28 the “file open” reply that indicates the file has been opened. Next, in Step S1108, the protocol converter 28 makes a request to the NFS client I/F 353 for file reading. This file reading request is a request for reading data for one-sector stored in the opened file. In Step S1109, the NFS client I/F 353 transmits to the NAS 34c the “NFSPROC_READ” procedure call message. The NFS server program in the NAS 34c reads out, according to this procedure call message, data from the designated file. After reading has been completed, in Step S1110, the NFS server program transmits to the NFS client I/F 353 the “NFSPROC_WRITE” procedure reply message that includes data having been read out from the file. In Step S1111, the NFS client I/F 353 replies to the protocol converter 28 the “file read” reply that includes data having been read out. After receiving the “file read” reply, the protocol converter 28 transmits to the buffer memory 263 the data having been read out.

After transmitting to the buffer memory 263 the data having been read out, in Step S1112, the protocol converter 28 makes a request to the NFS client I/F 353 of the “file dose” for dosing the file in which data has been read out a while ago. In Step 1113, the NFS client I/F 353 having received the “file dose” request transmits to the NSA 34c the “NFSPROC_CLOSE” procedure call message. After dosing the designated file according to this procedure call message, in Step S1114, the NFS server program in the NAS 34c transmits to the NFS client I/F 353 the “NFSPROC_CLOSE” procedure reply message. In Step S1115, the NFS client I/F 353 replies to the protocol converter 28 the “file dose” reply. In Step S1116, the protocol converter 28 transmits to the ATA emulator 154 information in which the data reading has been completed. After receiving this information, in Step S1117, the AT emulator 154 sets the DRQ bit and the BSY bit of the ATA status register to “1” and “0”, respectively. In Step S1118, the image information apparatus 40 checks a state of this status register, and then continuously reads out data for one-sector from the ATA data register. After reading the data for one-sector has been completed, in Step S1119, the ATA emulator 154 sets both the DRQ bit and the BSY bit of the ATA status register to “0”. As a result, the data for one-sector of ATA is enabled to be read out from the NAS 34c connected to the network. Reading a plurality of sectors can be realized by repeating a series of the operations.

As explained above, the ubiquitous image module unit 4 converts the data that has been outputted from the image information apparatus 40 and designated to be written in any physical sector into file-format, and then transmits it to the NAS 34c. Thereby, the image information apparatus 40 may perform the same process as a case in which the image information apparatus itself usually performs, that is, writes data into a recorder locally connected to the image information apparatus itself. On the other hand, the NAS 34c deals with the data in the file-format, which has been transmitted from the ubiquitous image module unit 4, similarly to the usual data, and then designates a physical sector into which the file-format data is written by its own determination.

That is, by converting into a logical protocol for sharing files data writing instruction to the physical sector, it becomes possible to write data into a recorder that has not been originally included in the image information apparatus 40, but connected to the network.

Moreover, similarly to the data reading, the image information apparatus 40 may perform the same process as a case in which the image information apparatus itself usually performs, that is, reads out data from the recorder locally connected to the image information apparatus itself. The NAS 34c deals with an instruction to read data in the file-format, which has been transmitted from the ubiquitous image module unit 4, similarly to an instruction to read usual data, and then designates its own physical sector in which data in the file-type is written, so as to read the data.

That is, by converting into a logical protocol for sharing files the instruction to read data from the physical sector, the data reading becomes possible from the recorder that has not been originally included in the image information apparatus 40, but connected to the network.

As described above, using a ubiquitous image module unit according to this embodiment, a function that has not been originally included in an image information apparatus can be realized. That is, not only functional expansion of the image information apparatus becomes possible without accompanying modification or revision of a system LSI of the image-information-apparatus, but also reduction in LSI-development cost and shortening in a development period becomes possible.

Here, in this embodiment, although an NAS has been taken as a storage, as long as an NFS server function is included, a non-volatile memory, MO, or the like may be used. Moreover, although an NFS has been taken as a protocol for sharing files, an SMB (server message block), an APF (apple talk filing protocol), or the like may be used.

### Embodiment 2

<System Configuration when Including Ethernet Interface>

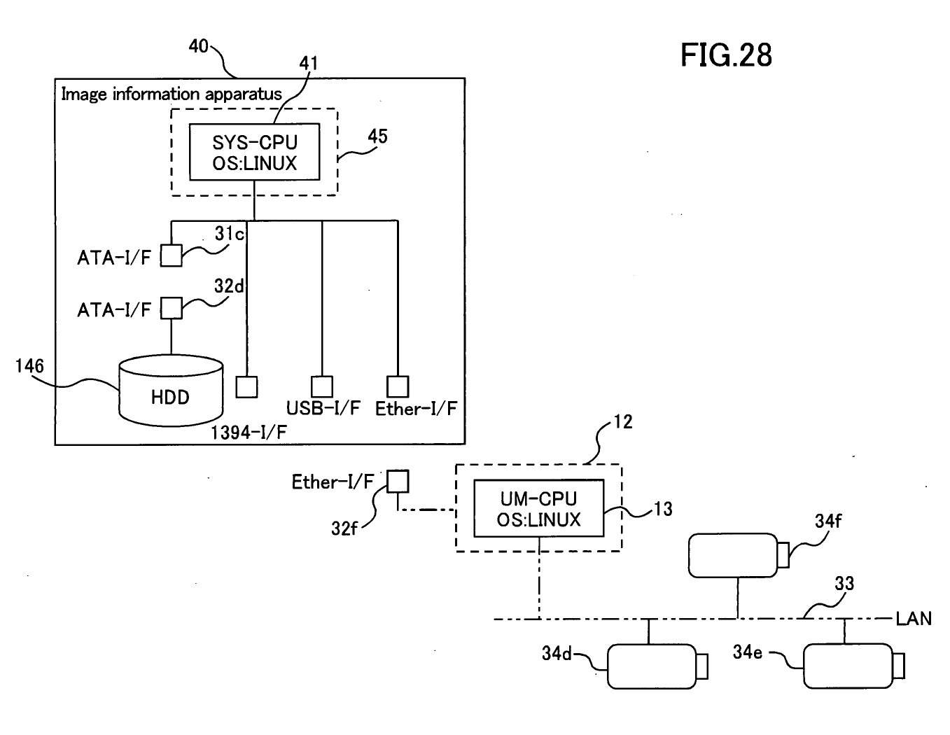

FIG. 28 is a view illustrating an example of a system configuration, when the ubiquitous image module 12 is connected to an Ethernet interface of the image information apparatus 40.

The ubiquitous image module unit 4 including the ubiquitous image module 12 has an Ethernet interface 32f, which is connected to an Ethernet interface 31e of the image information apparatus 40.

Due to the connection with this ubiquitous image module unit 4, the image information apparatus 40 can communicate with and control, through a network such as an LAN, other apparatuses, such as network cameras 34d, 34e, and 34f that are connected to the LAN 33.

Here, in the image information apparatus 40, although a protocol used for communicating with and controlling a NAS is installed, a protocol for communicating with and controlling the network cameras provided outside the apparatus is not installed. In such a case, by connecting the ubiquitous module unit 12, the image information apparatus 40 can also communicate with and control, through the network, the network cameras 34d, 34e, and 34f that are connected to the LAN 33.

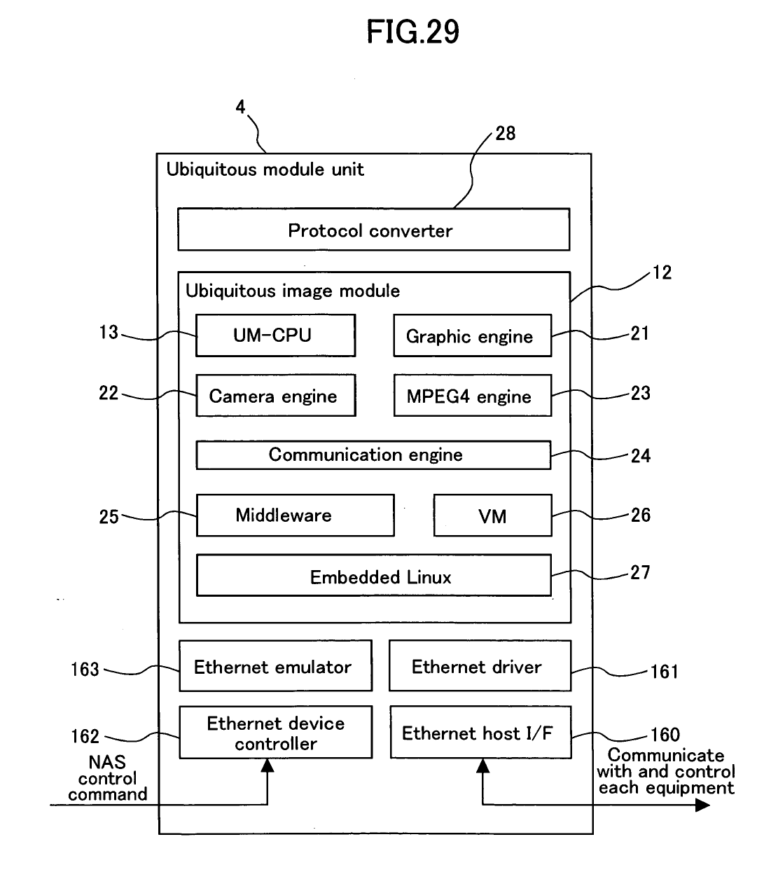

FIG. 29 is a view illustrating an example of a software block configuration in the ubiquitous image module unit 4 including the ubiquitous image module 12 illustrated in FIG. 28.

When the image information apparatus 40 tries to use any one of the network cameras 34d, 34e, and 34f that are provided outside the apparatus, the ubiquitous image module 12 receives a protocol communicating with and controlling an NAS, so as to communicate with and control the network camera connected to Ethernet.

The ubiquitous image module 12 receives the NAS communication/control protocol from the system CPU 41 of the image information apparatus 40. An Ethernet device controller 162 analyzes the NAS communication/control protocol that has been received by controlling an Ethernet emulator 163.

The analyzed protocol is converted by a protocol converter 28 to a protocol used for communicating with and controlling any one of the network cameras 34d, 34e, and 34f that are connected to Ethernet, and communicates with and controls, through the Ethernet driver 161 and the Ethernet host interface 160, the any one of the network cameras 34d, 34e, and the apparatuses 34f that are connected to the LAN 33.

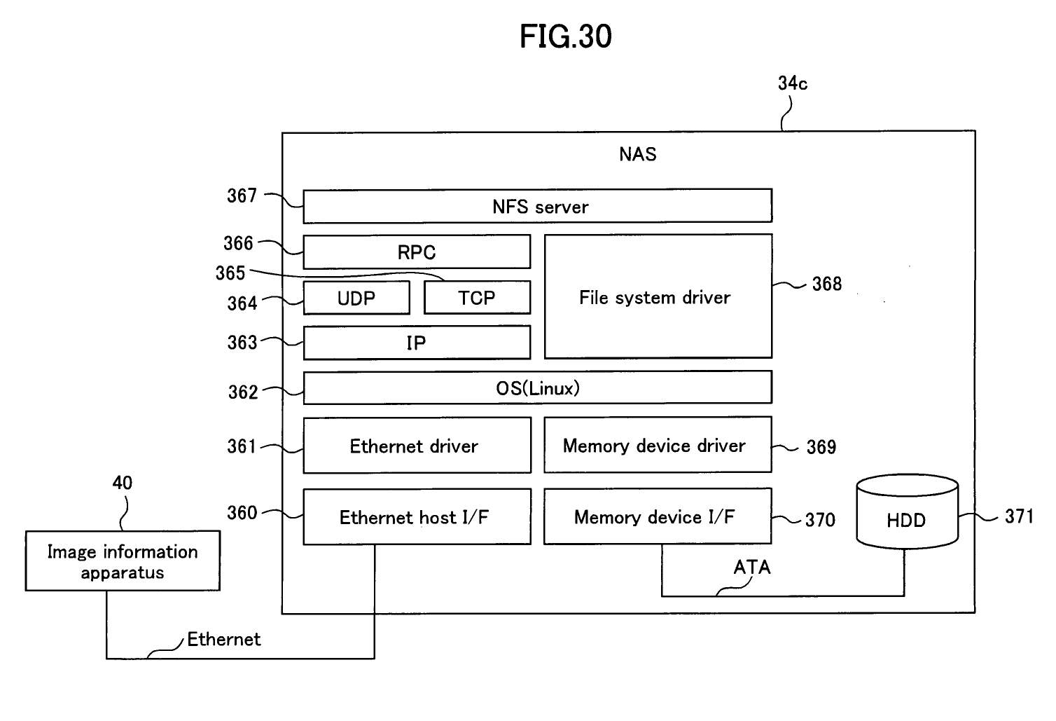

Hereinafter, the ubiquitous image module 12 according to this embodiment is explained further in detail. First, a software block diagram of a general NAS, for example, the NAS 34c represented in FIG. 18, is illustrated in FIG. 30. In the NAS 34c, an Ethernet host I/F 360 and an Ethernet driver 361 are installed for connecting to the image information apparatus 40 using Ethernet. Moreover, an IP 362 that is the Internet protocol as an upper communication protocol is installed, and a TCP 363, a UDP 364, and a remote procedure call 366 are installed above the IP. On the other hand, an HDD 371 for memorizing data having been transmitted from the image information apparatus 40, a memory device I/F 370 for connecting to the HDD 371, and a memory device driver 369 are also mounted. Thus, NFS server software 367 starts a file system driver 368 according to a request from the image information apparatus 40, and data having been received from the image information apparatus 40 is memorized in the HDD 371. Usually, the communication protocol between the memory device I/F 370 and the HDD 371 is ATA or ATAPI (ATA packet interface). Here, it is characteristic that a NAS can be recognized and used as a local memory device by other apparatuses such as the image information apparatus 40 connected to a LAN.

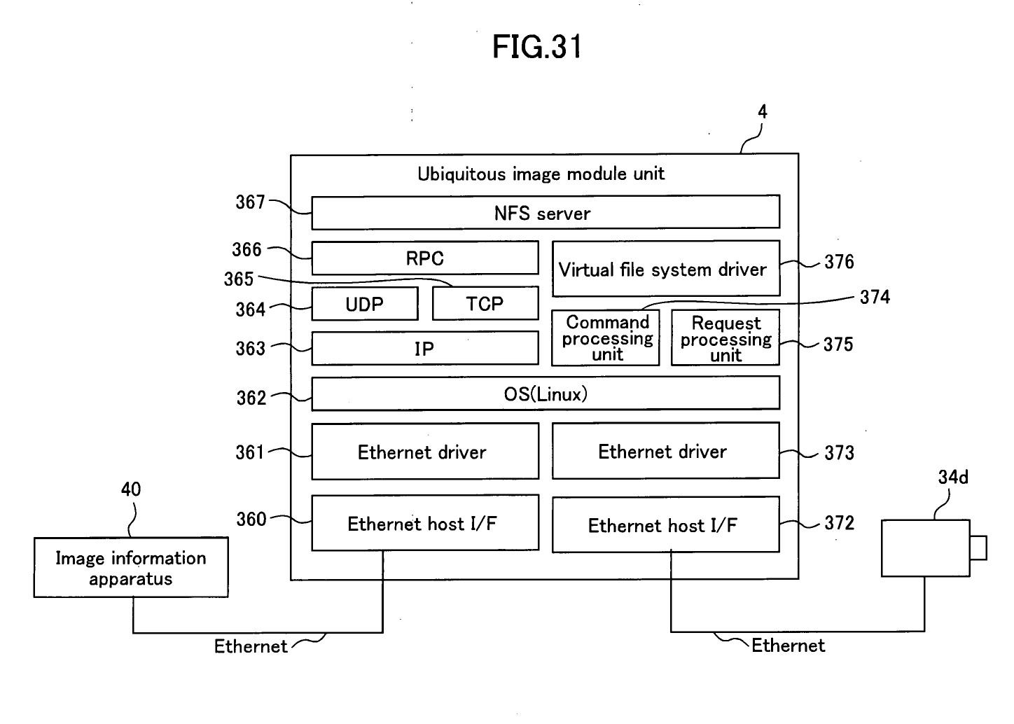

Next, a software block configuration of the ubiquitous image module 12 according to the embodiment is illustrated in FIG. 31. The difference from the NAS 34c represented in FIG. 30 is that, in order to connect the network camera 34d, an Ethernet host I/F 372, an Ethernet driver 373, a virtual file system driver 376, a command processing unit 374, and a request processing unit 375 are mounted. Here, an NFS mount protocol is used as a communication protocol between the image information apparatus 40 and the ubiquitous image unit 12, and HTTP is used as a communication protocol between the ubiquitous image unit 12 and the network camera 34d.

Here, as an example of the virtual file system 376, for example, a Linux Proc file system is known. This Linux Proc file system has a function providing an interface with the Linux Kernel by reading and writing a file that seems to be in a certain directory. That is, by using of the Proc file system, accessing a file in a directory is to read a Kernel state, and writing to the file is to change the Kernel setting. The virtual file system driver 376 of the ubiquitous image module unit 12 in this embodiment also has a function such as that of the Linux Proc file system.

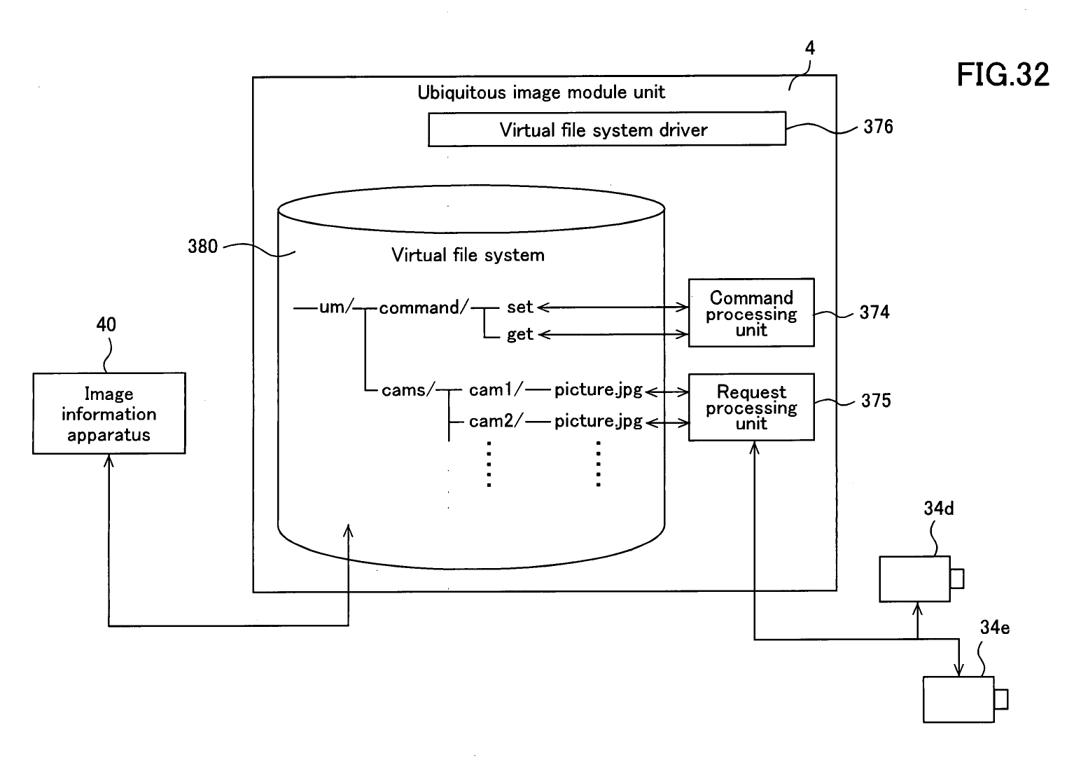

A virtual file system 380 created by the virtual file system driver 376 is illustrated in FIG. 32. Here, this virtual file system 380 is expressed by directories as represented in the figure, and the directories are recognized by the image information apparatus 40. “Set” and “get” files are located under the created command directory, and each of the files is connected to command processing unit 374. Accessing the “set” or “get” file enables the image information apparatus 40 to instruct to connect the ubiquitous image module unit 12 with the cameras 34d and 34e, and check connection states of the cameras 34d and 34e connected to the command processing unit 374. On the other hand, directories named such as “cam1” and “cams2” are placed under a “cams” directory, and the directories each are associated with respective cameras. Moreover, “picture.jpg” files are located under the “cams1” and “cams2”, respectively. Each of these “picture.jpg” files is connected to the request processing unit 375. Accessing each “picture.jpg” file enables the image information apparatus 40 to get pictures from the cameras through the request processing unit 375. Here, a “jpg” file format has been used as a picture file format; however, “gif” and “bmp” file formats may also be used, that is, file format is not particularly limited to these formats.

As described above, accessing the virtual file system 380 that has been created by the virtual file system driver 376 enables the image information apparatus 40 to control the cameras 34d and 34e through the command processing unit 374 and the request processing unit 375, and to get picture data. That is, through the ubiquitous image module unit 12, the image information apparatus 40 comes to recognize picture data from the cameras 34d and 34e as picture data from the NAS.

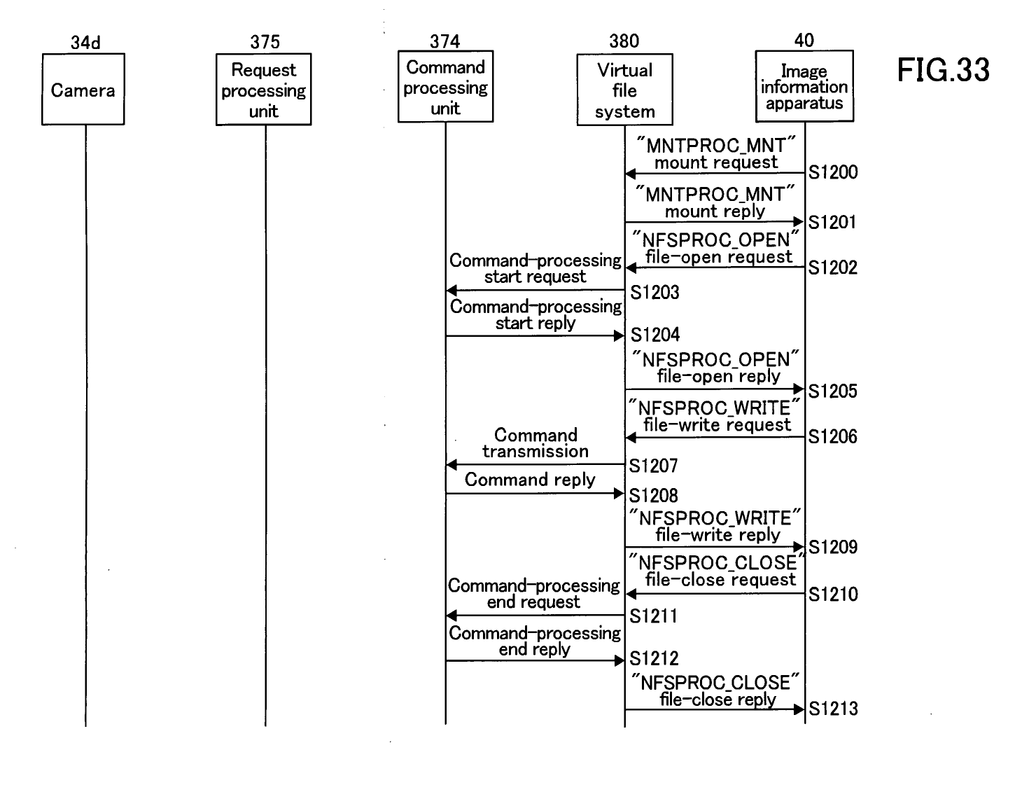

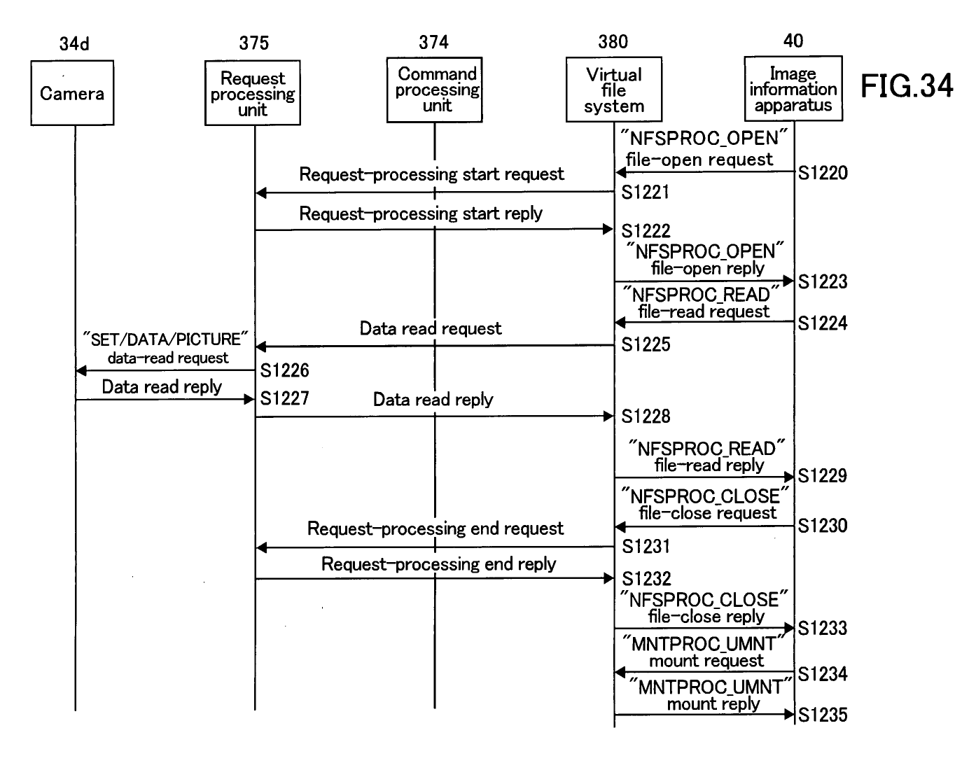

Hereinafter, the operation of the image information apparatus 40, when operating the camera 34d, is explained in detail using FIG. 33 and FIG. 34. Here, the operation in this embodiment is roughly divided into a sequence when, as represented in FIG. 33, the image information apparatus 40 is associated with the camera 34d, and a sequence when, represented in FIG. 34, the image information apparatus 40 gets picture data from the camera 34d. First, the sequence in FIG. 33, when the image information apparatus 40 is associated with the camera 34d, is explained. In Step S1200, in order to recognize the virtual file system 380 that has been created by the virtual file system driver 376 included in the ubiquitous image module unit 12, the image information apparatus 40 issues, using MNT as the communication protocol, to the ubiquitous image module 12 the “MNTPROC_MNT” mount request. After the virtual file system driver 376 of the ubiquitous image module unit 12 having received the mount request creates a virtual file system 380, in Step S1201, the virtual file system 380 replies that to the image information apparatus 40 as a “MNPPROC_MNT” mount reply. This processing enables the image information apparatus 40 to recognize the virtual file system 380 and access it.

Next, in order to associate, for example, the camera 34d connected to the network, with the directory “cam1” of the virtual file system 380, in Step S1202, the image information apparatus 40 firstly issues to “command/set” of the virtual file system 380 an “NFSPROC_OPEN” file open request. In Step S1203, the virtual file system 380 having received the file open request issues to the command processing unit 374 a command-processing-start request. After receiving the command-processing-start request, the command processing unit 374 recognizes that the camera 34d is associated with the directory of the virtual file system 380, and then in Step S1204, the command processing unit 374 replies that as a command-processing-start reply. The “command/set” of the virtual file system 380 having received this command-processing-start reply, replies that, in Step S1205, to the image information apparatus 40 as an “NFSPROC_OPEN” file open reply. This processing enables the image information apparatus 40 to send commands to the “command/set”.

In order to actually associate the camera 34d with the directory “cam1” of the virtual file system 380, in Step 1206, the image information apparatus 40 issues to the “command/set” of the virtual file system 380 a file writing request “NFSPROC_WRITE” that associates the camera 34d with the directory “cam1”. The “command/set” of the virtual file system 380 having received the file writing request transmits, in Step S1207, to the command processing unit 374 a command for associating the camera 34d with the directory “cam1”. After having executed the command, in Step S1208, the command processing unit 374 replies that as a command reply after completion of the association. The virtual file system 380 having received this command reply replies that, in Step S1209, to the image information apparatus 40 as an “NFSPROC_WRITE” file writing reply. Owing to this processing, the camera 34d is associated with the directory “cam1”, and thus writing processing from the image information apparatus 40 to the directory “cam1” resultantly becomes the operation by the camera 34d.

Thereafter, when it is further desired that the other cameras are associated with the directory, or the other commands are transmitted to the camera 34d, the processing operations from Step S1206 to Step S1209 are further performed.

When all of the commands have been transmitted, in order to indicate that the command transmission to the command processing unit 374 does not occur, in Step S1210, the image information apparatus 40 issues to the “command/set” of the virtual file system 380 a “NFSPROC_CLOSE” file dose request. In Step S1211, the “command/set” of the virtual file system 380 having received the file dose request issues to the command processing unit 374 a command-processing-end request. After recognizing that there is no command from the image information apparatus 40 to the command processing unit 374, the command processing unit having received a command-processing-start request replies that, in Step S1212, as a command-processing-finish reply. The “command/set” of the virtual file system 380 having received this command-processing-finish reply replies that, in Step S1213, to the image information apparatus 40 as a “NFSPROC_CLOSE” file dose reply.

Owing to this series of processing operations, the directory included in the virtual file system 380 is associated with the camera connected to the network, and writing processing from the image information apparatus 40 to the directory is converted into an actual operation of the camera. That is, the camera can be actually operated by the NFS command having been included in the image information apparatus 40.

Next, the sequence in FIG. 34, when the image information apparatus 40 gets pictures from the camera 34d, is explained. Here, in the state prior to Step S1220 in FIG. 34, the association between the camera 34d and the directory “cam1” represented in FIG. 33 is assumed to have been completed.

First, in order to get picture data from the camera 34d, in Step S1220, the image information apparatus 40 issues to the directory “cma1/picture.jpg” of the virtual file system 380 the “NFSPROC_OPEN” file open request. In Step S1221, the directory “cma1/picture.jpg” of the virtual file system 380 having received the file open request issues to the request processing unit 375 a request-processing-start request. After receiving the request-processing-start request, the request processing unit 375 recognizes that the picture data is requested to be obtained from the camera 34d, and then, in Step S1222, the request processing unit replies that as a request-processing-start reply. In Step S1223, the directory “cma1/picture.jpg” of the virtual file system 380 having received this request-processing-start reply replies that to the image information apparatus 40 as the “NFSPROC_OPEN” file open reply. This processing enables the image information apparatus 40 to issue to the “cma1/picture.jpg” a picture data request.

In order to actually get picture data from the camera 34d, in Step S1224, the image information apparatus 40 issues to the “cma1/picture.jpg” of the virtual file system 380 a file reading request “NFSPROC_READ” for reading the picture data of the camera 34d. In Step S1225, the “cma1/picture.jpg” of the virtual file system 380 having received the file reading request transmits to the request processing unit 375 the data reading request for reading the picture data from the camera 34d. Moreover, in Step S1226, the request processing unit having received the data reading request issues to the camera 34d a data reading request “GET/DATA/PICTURE”. In Step S1227, the camera 34d having received the data reading request replies to the request processing unit 375 the data reading reply including photograph picture data. Moreover, in Step S1228, the request processing unit 375 replies the data reading reply including the picture data. In Step S1229, the “cma1/picture.jpg” of the virtual file system 380 having received a data reading reply including this picture data replies to the image information apparatus 40 the picture data as a “NFSPROC_READ” file reading reply. This processing enables the photograph picture data captured by the camera 34d to be viewed on the image information apparatus 40.

Thereafter, when it is also further wanted to get picture data from the camera 34d or the other cameras, the processes from Step S1224 to Step S1229 are performed.

When all picture data has been completed to get, in order to indicate that no picture-getting request to the request processing unit 375 is generated, in Step S1230, the image information apparatus 40 issues to the “cma1/picture.jpg” of the virtual file system 380 an “NFSPROC_CLOSE” file dose request. In Step S1231, the “cma1/picture.jpg” of the virtual file system 380 having received the file close request issues to the request processing unit 375 a request-processing-end request. After recognizing no picture-getting request from the image information apparatus 40 to itself, in Step S1232, the request processing unit 375 having received the request-processing-start request replies that as a request-processing-end reply. In Step S1233, the “cma1/picture.jpg” of the virtual file system 380 having received this request-processing-end reply replies that to the image information apparatus 40 as a “NFSPROC_CLOSE” file close reply.

Last, in Step S1214, in order to cancel the recognition of the virtual file system 380, the image information apparatus 40 issues to the ubiquitous image module 12 a “MNTPROC_UMNT” dismount request. After finishing the virtual file system 380, in Step S1215, the virtual file system driver 376 of the ubiquitous image module unit 12 having received the dismount request replies that to the image information apparatus 40 as an “MNTPROC_UMNT” dismount reply. By this processing, the image information apparatus 40 finishes recognizing the virtual file system 380.

This series of processing operations enables photographed picture data by the camera 34d connected to the network to be watched on the image information apparatus 40. That is, the picture photographed by the camera can be watched by the NFS command having been included in the image information apparatus 40.

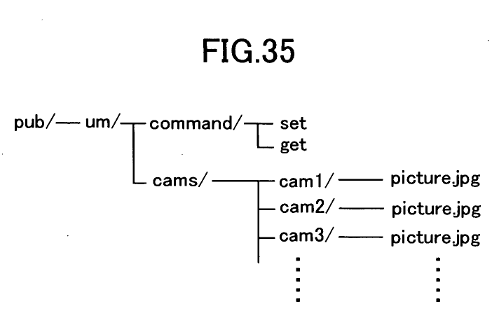

Here, the directory configuration of the virtual file system 380 is not limited to that represented in FIG. 32. The directory structure represented in FIG. 35 is the same as the structure of the virtual file system 380 in FIG. 32; however, this structure is characteristic in that a picture getting file is provided for each of the command transmitting/receiving files and each of the plurality of camera directories.

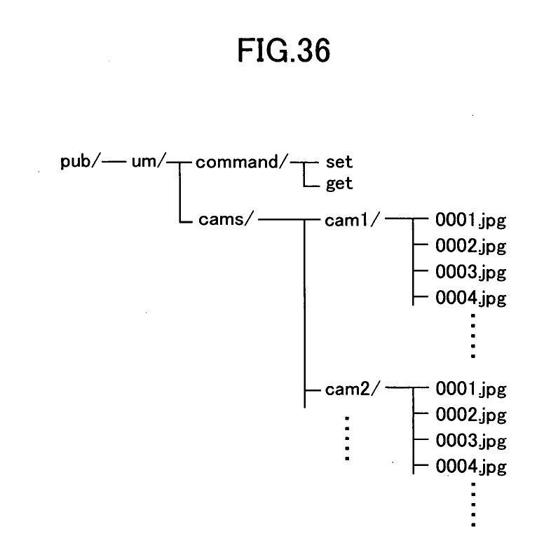

The directory structure represented in FIG. 36 is characteristic in that a plurality of picture getting files is provided for each of the camera directories, which is suitable for cases when, for example, pictures are continuously read out from the cameras.

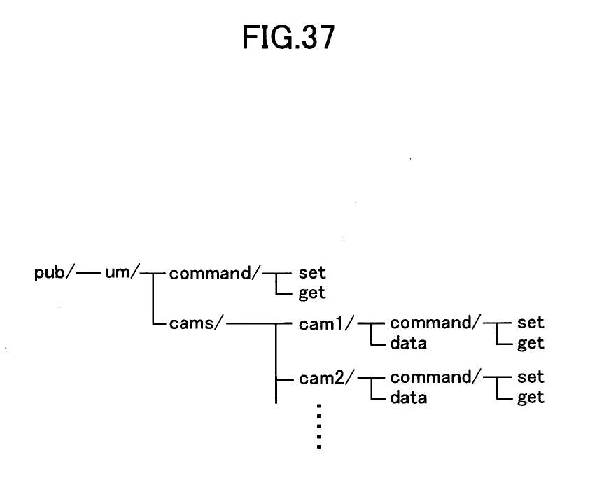

Moreover, the directory structure represented in FIG. 37 is another example, which is characteristic in that the command transmitting/receiving files are also provided, corresponding to the cameras, in each of the camera directories. This is suitable provision for reading out the pictures while controlling each of the cameras.

As explained above, using an existing function of reading and writing files using the NFS included in the image information apparatus 40, picture data can be gotten from the camera connected to the network. Here, in a case of the image information apparatus 40 having no NFS function, the virtual file system 380 is created by simulating the directory configuration and the data format when data is recorded from the image information apparatus to a conventional NAS. That is, in a domain in which the image information apparatus 40 recognizes images, a present picture can be displayed by playing back the picture data recorded in an NAS, and a present camera picture can be recorded by copying to another memory device the picture data that has been recorded in the NAS. In this case however, because the information related to a camera in use, etc. cannot be set by the image information apparatus 40, it is necessary that the information be given to the ubiquitous image module unit 12 in advance as the initialized value, or the ubiquitous image module unit 12 be set from outside.

Here, photographed picture data by the camera connected to the network, using a camera engine included in the ubiquitous image module 12 may be converted into a format that is suitable for displaying on the image information apparatus. Moreover, in this embodiment, the NFS server 367, the virtual file system driver 376, the command processing unit 374, and the request processing unit 375, that are included in the ubiquitous image module unit each have been deemed to be independent software; however, software may be used in which part or all of them are combined together.

By adopting such a configuration, the ubiquitous image module unit 12 can be configured to perform protocol-conversion between the NAS communication/control protocol and the network-camera communication/control protocol (the NAS control command can be transmitted to and received from the exterior of the apparatus).

Accordingly, maintaining intact, for example, the configuration of the image information apparatus 40 itself associated with the communicating/control protocol to the NAS, and without newly adding a configuration for the communication/control protocol to any one of the network cameras 34d, 34e and 34f, communication with and control of any one of the network cameras 34d, 34e and 34f connected to the LAN 33 can be performed through the network. That is, development of a new LSI, etc. accompanied by adding functions becomes needless.

Here, Embodiment 2 is the same as Embodiment 1 except for those described above, the explanation is omitted.

### Embodiment 3

<Configuration with System Interface on Image Information Apparatus Side>

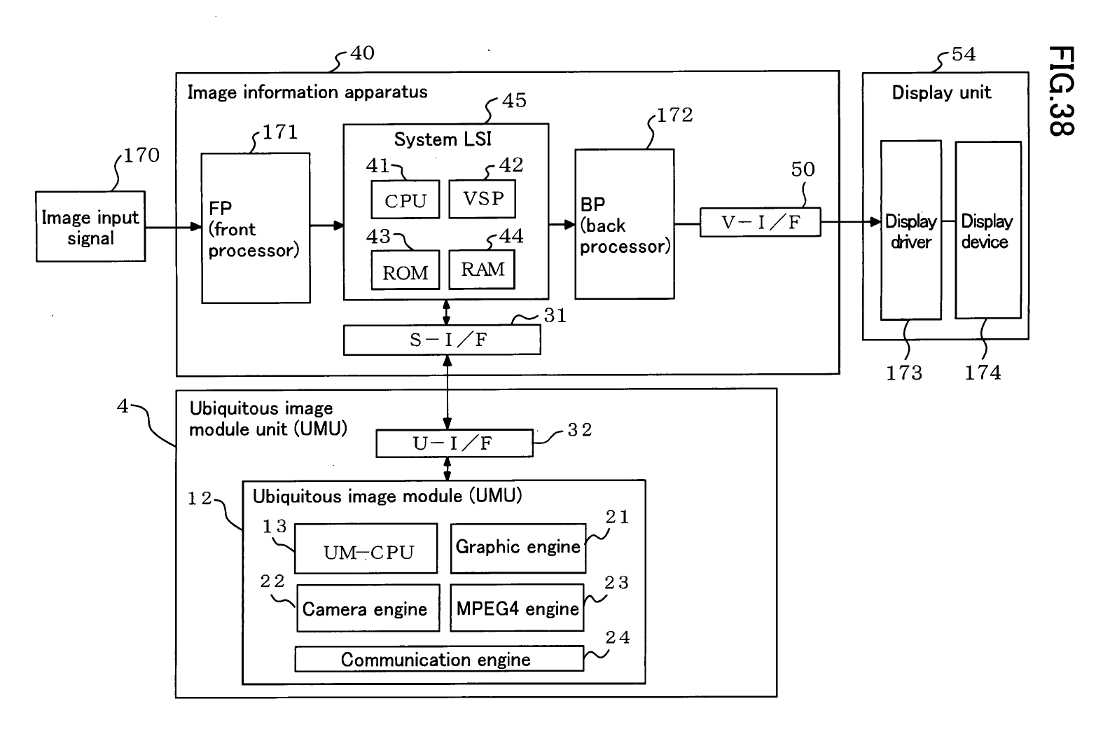

FIG. 38 is a view illustrating an example of a system configuration, when the ubiquitous image module unit 4 is connected to the image information apparatus 40. The image information apparatus 40 illustrated in FIG. 38 is configured to include the S-I/F 31, instead of the driver 55 and the host interface 56 illustrated in FIG. 7.

Moreover, the ubiquitous image module unit 4 is configured to include the ubiquitous image module 12 and the U-I/F 32. By connecting each of the interfaces S-I/F 31 and the U-I/F 32, without development of a new system LSI, the image information apparatus 40 having the function of the ubiquitous image module 12 can be realized.

After connecting to the Internet environment through the communication engine 24, the ubiquitous image module unit 4 downloads image and audio data, etc. from the other image information apparatus connected to the Internet.

The image and audio data, etc. downloaded undergoes decode processing or graphic processing in the MPEG4 engine 23, the graphic engine 21, etc. included in the ubiquitous image module 12. Then, the ubiquitous image module unit 4 outputs, through the U-I/F 32 and the interface S-I/F 31, image and audio data, etc. whose data format is utilizable in the image information apparatus 40.

Regarding the image and audio data having been inputted into the image information apparatus 40, the image data is signal-processed into a state displayable on the display unit 54, and displayed on the display unit 54, while the audio data is outputted from an audio output unit that is not illustrated in the figures.

Moreover, regarding moving picture and still picture files, for example, inputted from the network cameras (for example, the network cameras 34d, 34e, and 34f connected to the network represented in FIG. 28), picture processing, specific to the cameras, such as changing the number of pixels, and changing their displaying rate is performed in the camera engine 22 of the ubiquitous image module unit 4.

Furthermore, the data of the moving picture and still picture files having been picture-processed is graphically-processed by the graphic engine 21, and then outputted in a data format utilizable in the image information apparatus 40 through the U-I/F 32 and the interface S-I/F 31.

The data having been inputted into this image information apparatus 40 is signal-processed into a state displayable on the display unit 54, and displayed on the display unit 54.

Here, in the above explanation, regarding each engine processing represented in FIG. 38, although only an example is represented, procedure for using the engines and the function thereof may be different from these.

Moreover, although the configurational example illustrated in FIG. 38 is an example of a system for displaying image data, the configuration similar to the example above can be applied to a system or apparatus having other functions such as replaying audio input, displaying and delivering text input, and storing information.

<Ubiquitous Image Module Unit Including Function of Video Input/Output for Displaying>

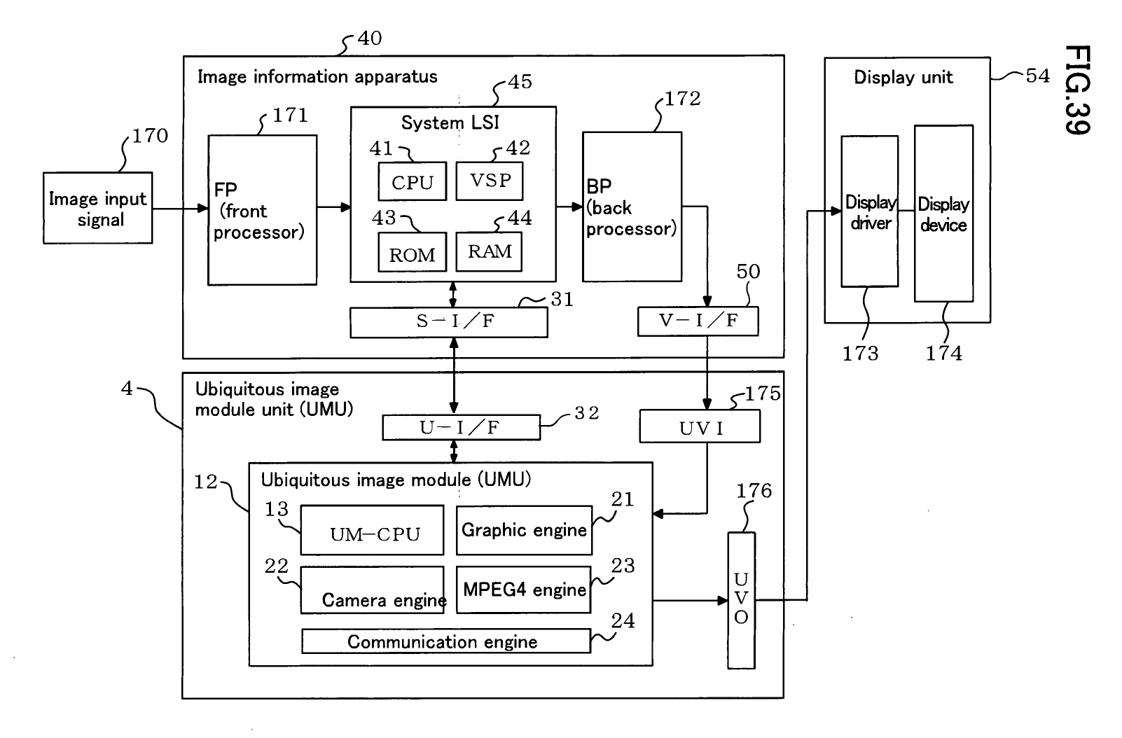

FIG. 39 is a view illustrating an example of a configuration when a function for displaying images on the display unit 54 is provided in the ubiquitous image module unit 4 according to Embodiment 3.

A UVI (ubiquitous video input) 175 is a video input terminal of the ubiquitous image module unit 4, which configures an interface connectable to the video output terminal V-I/F (video interface) 50 of the image information apparatus 40.

A UVO (ubiquitous video output) 176 is a video output terminal from the ubiquitous image module unit 4 to the display unit 54, and connected to an input interface (not illustrated) of the display unit 54. Image data inputted from this input interface is displayed on a display device 174 through a display driver 173.

According to such a configuration as above, for example, it becomes possible for images outputted from the image information apparatus 40 to be overlaid on a display screen of the graphic engine 21 included in the ubiquitous image module 12.

Moreover, according to such a configuration as above, because it becomes possible not only for image data to be sent and received between the S-I/F 31 and the U-I/F 32, but also for the image data to be outputted through the V-I/F 50, the UVI 175, and the UVO 176, it becomes possible to supply the image data to the ubiquitous image module 12 without decreasing the transmission efficiency of a universal bus connected between the S-I/F 31 and the U-I/F 32.

If the image information apparatus 40 is not compatible with the network, a configurations for screen-overlay outputting that composites graphic data on the Internet with image signals outputted from the apparatus itself and displays the composite signals are generally complicated.

However, by providing the ubiquitous image module 12 with the UVI 175 and the UVO 176 so as to have an overlay function, in the image information apparatus 40, expansion functions such as the overlay can be easily realized without developing anew the system LSI 45.

Here, Embodiment 3 is the same as Embodiment 1 except for those described above.

<Another Data Storage Interface>

In Embodiment 1 described above, although ATA has been used as a storage interface (data storage interface), another storage interface such as SCSI (small computer system interface) may be used.

Moreover, in Embodiment 1 described above, although ATA or SCSI has been used as the data storage interface, an interface having a storage protocol set such as USB (universal serial bus) or IEEE-1394 may be used.

<Communication Between Programs>

Here, although Embodiments 1 and 2 described above have been configured in such a way that the communication between processes is performed using a communicator for communicating between the processes, communication between programs may be used through a communicator for communicating between the programs.

### Embodiment 4

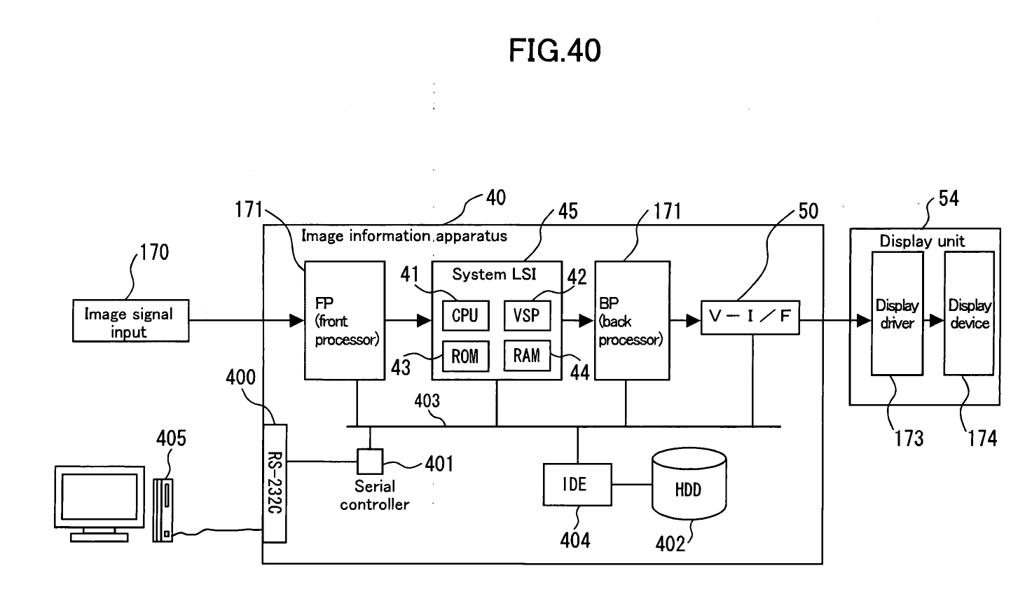

In this embodiment, a case is explained in which the ubiquitous image module unit 12 is operated using a Web browser. First, a hardware configuration of a conventional image information apparatus 40 is illustrated in FIG. 40. Here, the image information apparatus 40 represented in the figure is assumed to have an RS-232C interface 400 as a serial interface for connecting to external apparatuses.

A front processor 171, the system LSI 45, a back processor 172, and the V-I/F 50 are connected to the image information apparatus 40 through a PCI bus 403 as the internal bus. Moreover, a built-in HDD 402 and the RS-232C interface 400 are also connected to the PCI bus 403 through an IDE interface 404 and a serial controller, respectively.

Next, a case is explained in which the image information apparatus 40 is operated using a personal computer (PC) 405. The PC 405 and the image information apparatus 40 are connected with each other through an RS-232C cable as represented in the figure; thus, communication can be performed with each other. First, a user must install into the PC 405 exclusive software for controlling the image information apparatus 40. Then, using the exclusive software, it becomes possible that the user operates the image information apparatus, for example, outputs or records picture data. That is, when the user issues a process command through the exclusive software, after this process command has been converted into an RS-232C command, the RS-232C command is transmitted to the image information apparatus through the RS-232C cable. The system LSI 45 of the image information apparatus 40 understands the command inputted from the RS-232C interface 400, and performs needed process. The processing results are replied, through the RS-232C interface 400, to the exclusive software of the personal computer as the source that has issued the process command.

According to such procedure, the user can operate the image information apparatus 40 using the exclusive software, for controlling the image information apparatus 40, installed in the PC. Therefore, in order to operate the conventional image information apparatus 40, exclusive software for operate the image information apparatus 40 had to be installed in the PC 405. In this embodiment, a method for operating the image information apparatus 40 using a Web browser that has been preinstalled as a standard in the recent PC, that is, a method for operating the image information apparatus 40 using the ubiquitous image module unit 12 is explained.

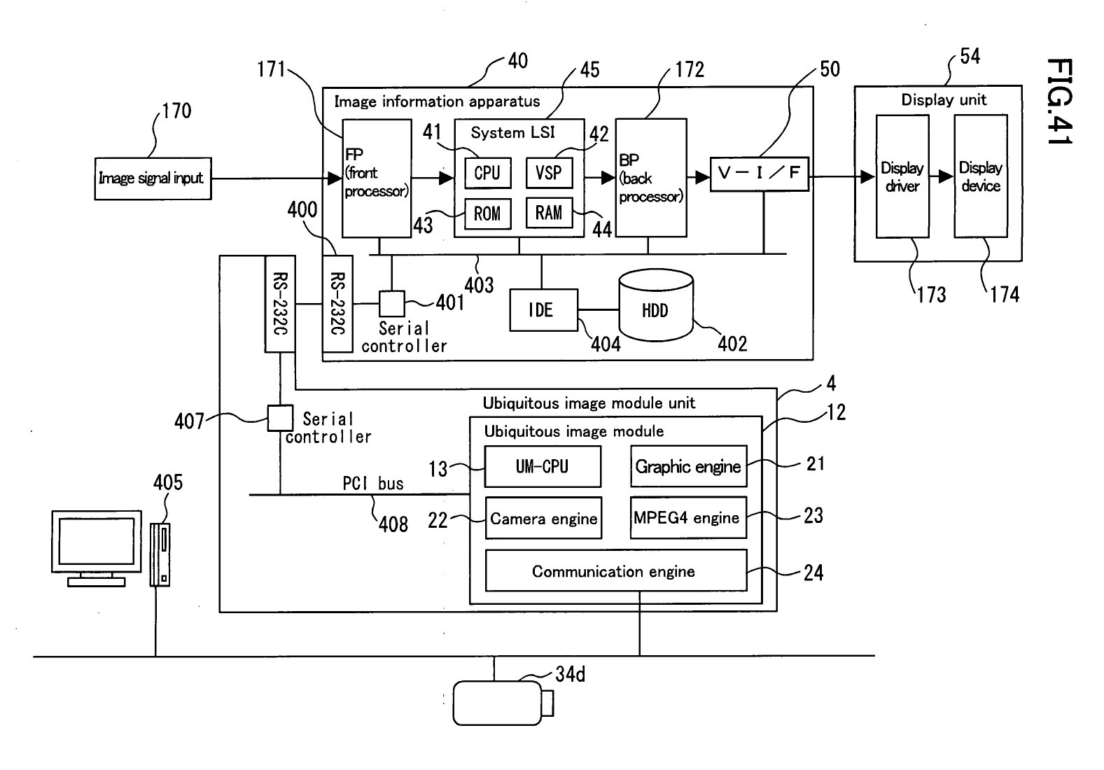

A hardware configuration of the ubiquitous image module unit 12 in this embodiment is illustrated in FIG. 41. The ubiquitous image module unit 4 is connected to the image information apparatus 40 through an RS-232C cable interface 406 by the RS-232C cable, and connected to the PC 405 and the camera 34d through the communication engine 24 by Ethernet. Moreover, inside the ubiquitous image module unit 4, the ubiquitous image module unit 4 and the RS-232C cable interface 406 are connected with each other through a serial controller 407 by a PCI bus.

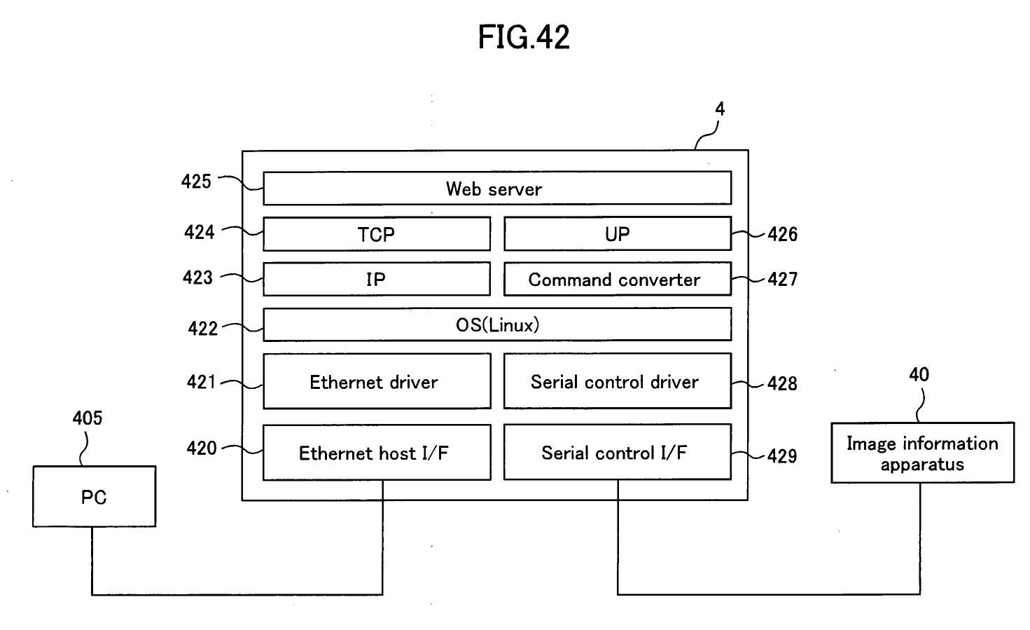

A software configuration of the ubiquitous image module unit 12 in this embodiment is illustrated in FIG. 42. The PC 405 and the ubiquitous image module unit 12 are connected to Ethernet as the physical layer and the data-link layer, and an Ethernet I/F 420 and an Ethernet driver 421 are installed in the ubiquitous image module unit 12. Moreover, in the ubiquitous image module unit 12, the Internet protocol 423 is installed in the network layer, as a communication protocol, above the physical layer and the data-link layer, and a TCP 424 and a UDP 426 are installed as the transport layer above the network layer. Moreover, a Web browser 425 is installed above the session layer. Here, the Web browser 409 is assumed to be installed in the PC 405.

On the other hand, the image information apparatus 40 and the ubiquitous image module unit 12 are physically connected with each other by the RS-232C cable, and a serial control I/F 429 and a serial control driver 428 are installed in the ubiquitous image module unit 12. Moreover, a command converter 427 for converting a request from the Web browser of the PC 405 into an RS-232C command is also installed therein.

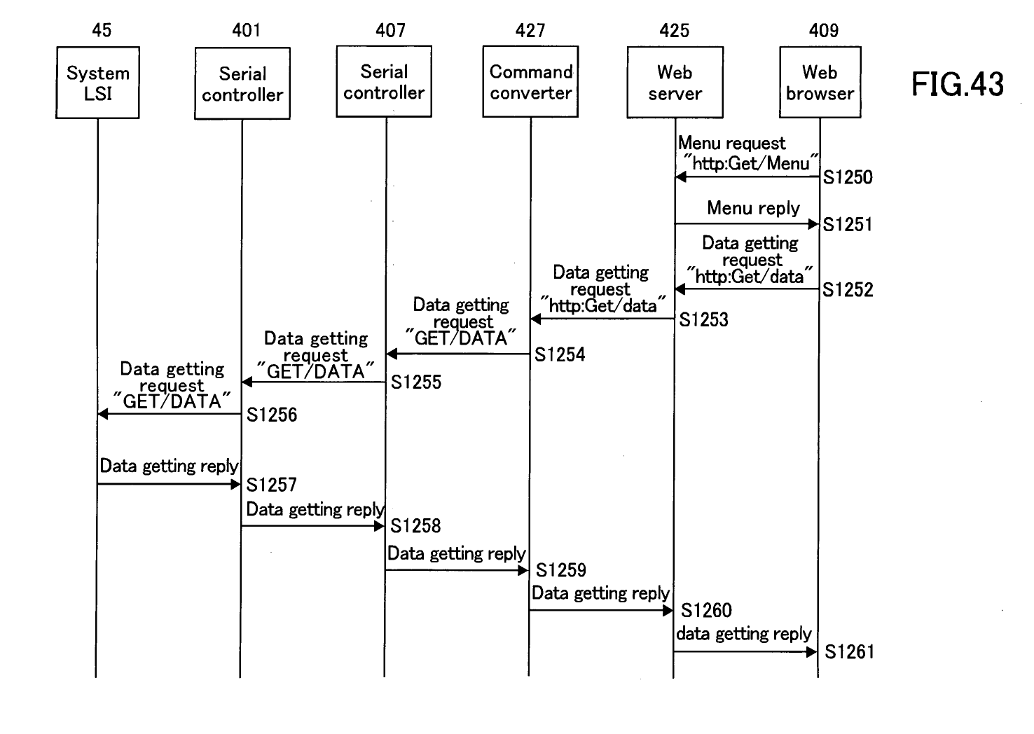

Next, an operation is explained when, for example, picture data displayed on the image information apparatus 40 is gotten from the Web browser of the PC 405. FIG. 43 illustrates a sequence when picture data displayed on the image information apparatus 40 is gotten from the Web browser. First, in Step S1250, the Web browser 409 installed in the EPC 405 transmits to the Web server of the ubiquitous image module unit 12 a menu request “http:Get/menu”. In Step S1251, the Web server 425 returns to the Web browser 409 a menu reply including a menu. According to this processing, a menu screen is displayed on the Web browser 409 of the PC 405. Thus, it becomes possible for the user to perform, using this operation screen, an operation to the image information apparatus 40.

The user performs an operation in order to get, from the operating screen displayed on the Web browser 409, the picture data displayed on the image information apparatus 40. Through this operation, in Step S1252, the Web browser 409 transmits to the Web server the data getting request “http:Get/data”; then, in Step S1253, the Web server 425 transmits to the command converter 427 a data getting request “http:Get/data” having been received. In Step S1254, the command converter 427 converts the data getting request “http:Get/data” to a data getting request “GET/DATA” as RS-232C command data, and transmits to the serial controller 407 the data getting request “GET/DATA”. In Step S1255, the serial controller 407 included in the ubiquitous image module 12 transmits to the serial controller 401 of the image information apparatus 40 the data getting request “GET/DATA” through the RS-232C cable. Last, in Step S1256, the system LSI 45 in which the data getting request “GET/DATA” has been transmitted from the serial controller 401 understands this command, and gets the picture data.

In Step S1257, the system LSI 45 returns to the serial controller 401 the data getting reply including the picture data. Moreover, the data getting reply including the picture data is returned from the serial controller 401 included in the image information apparatus 40 to the serial controller 407 included in the ubiquitous image module unit 12 in Step S1258, and from the serial controller 407 to the command converter 427 in Step 1258 and Step S1259, respectively. In Step S1260, the command converter returns to the Web server 425 the http-protocol data getting reply that has been converted from the RS-232C data getting reply, and the picture data. In Step S1261, the Web server 425 returns to the Web browser 409 the http-protocol data getting reply and the picture data. After Step S1261, the picture data having been gotten from the image information apparatus 40 becomes visible to the user through the Web browser 409, and in addition, it becomes also possible to write into picture data displayed by the image information apparatus 40, etc.

As explained above, using the ubiquitous image module unit according to this embodiment eliminates necessity of installing exclusive software for controlling the image information apparatus 40, and enables the operation of the image information apparatus 40 using the Web browser that is preinstalled in standard. Moreover, using the ubiquitous image module unit according to this embodiment, it is also possible that a picture transmitted from the camera 34d is displayed on and recorded in the image information apparatus 40. Furthermore, the ubiquitous image module according to this embodiment can also be applied to conventional image information apparatuses.

Here, the http command and the RS-232C command “GET/DATA” used in this explanation each are only an example; therefore, as long as commands meet functions that are desired by a user the expression format is no object.

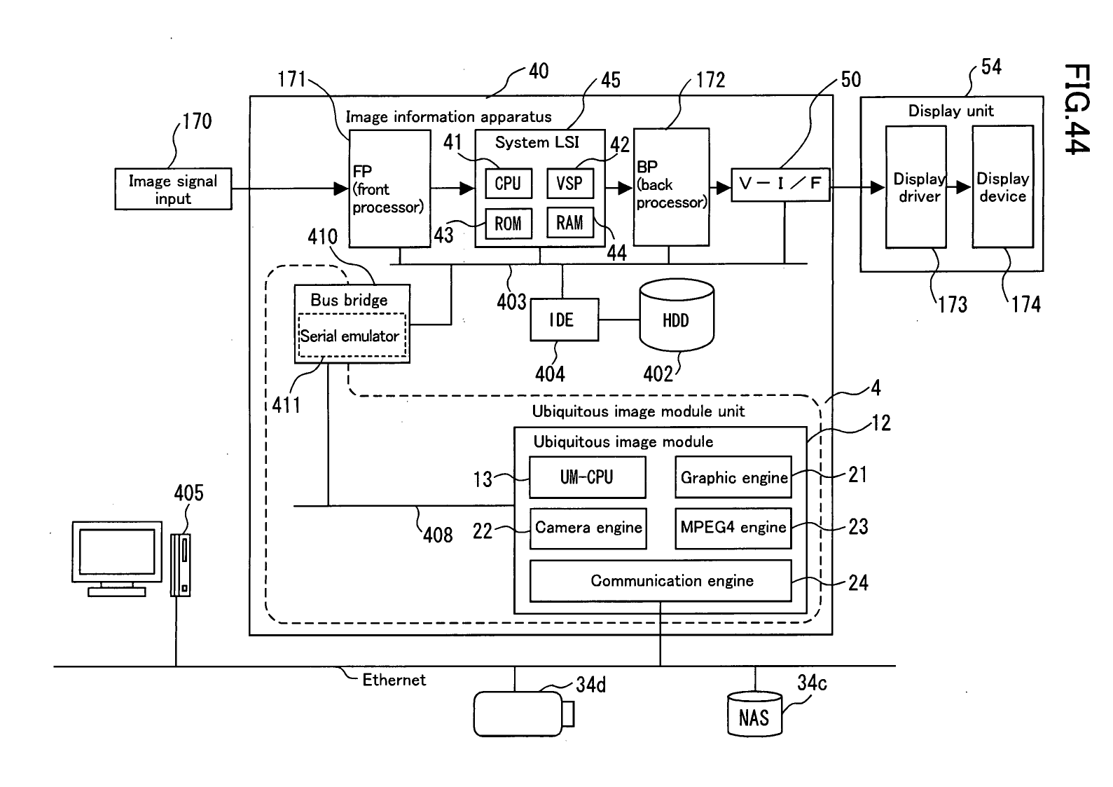

Moreover, another example in which the ubiquitous image module according to this embodiment is applied is illustrated in FIG. 44. The image information apparatus represented in FIG. 44 is different from that in the image information apparatus 40 represented in FIG. 41 in that the ubiquitous image module unit is embedded inside the apparatus. That is, in FIG. 41, a case is assumed in which the ubiquitous image module unit 12 is connected to a conventional image information apparatus. However, if an image information apparatus having a ubiquitous image module as represented in FIG. 44 is used, the ubiquitous image module and the image information apparatus need not be connected with each other by RS-232C. Therefore, it is advantageous that the communication between them is not limited to the physical communication speed of the RS-232C interface whose communication speed is slower comparing to that of Ethernet, etc.

The portion connected to the serial controller by RS-232C in FIG. 41 is connected by a bus bridge 410 in FIG. 44. That is, this bus bridge 410 connects the PCI bus 403 inside the image information apparatus with the PCI bus 408 inside the ubiquitous image module unit. Inside the bus bridge 410, a serial emulator 411 is provided for transferring data similar to the serial controller. The serial emulator 411 is controlled by both the PCI buses 403 and 408, and transmits the data to the opposite-side bus, similarly to the case of the serial transference. Therefore, as represented in FIG. 41, software in the configuration in which the communication was performed using the serial controllers 401 and 407 can be used without being changed. Moreover, because communication is not limited by the physical speed of the RS-232C communication, it becomes possible to transfer data at high speed. Here, if the software can be changed, a bridge other than the serial emulator 411, such as a shared-memory type may be used, or a plurality of systems may be used together.

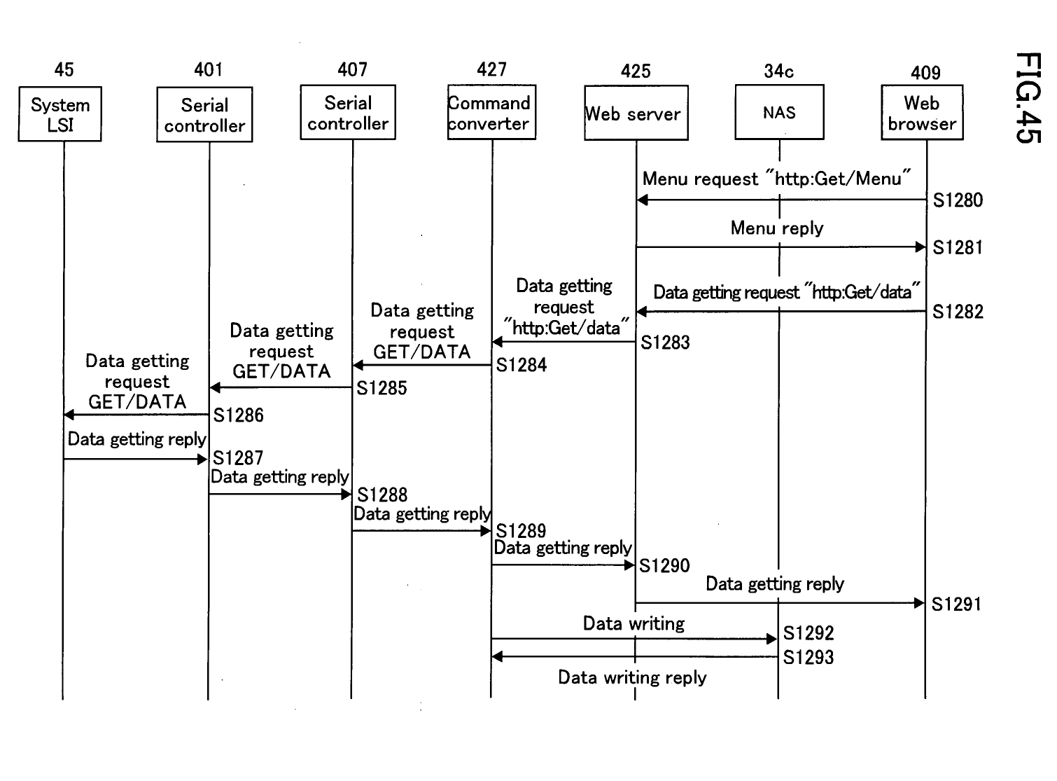

A sequence with which picture data displayed on the image information apparatus 40 is gotten from the Web browser is represented in FIG. 45. This figure differs from FIG. 43 in that the picture data having been read out from the image information apparatus 40 is also recorded in the NAS 34c connected to the network. That is, in Step S1292 of data writing, the command converter 427 records as the data writing into the NAS 34c the picture data having been read out from the image information apparatus 40. After the recording has been completed, the NAS 34c replies to the command converter 427 in Step S1322 of data writing reply. As explained above, the image information apparatus inside which the ubiquitous image module is embedded may be used.

### Embodiment 5

<Flag Related to Included Engine and Cooperation Setting>

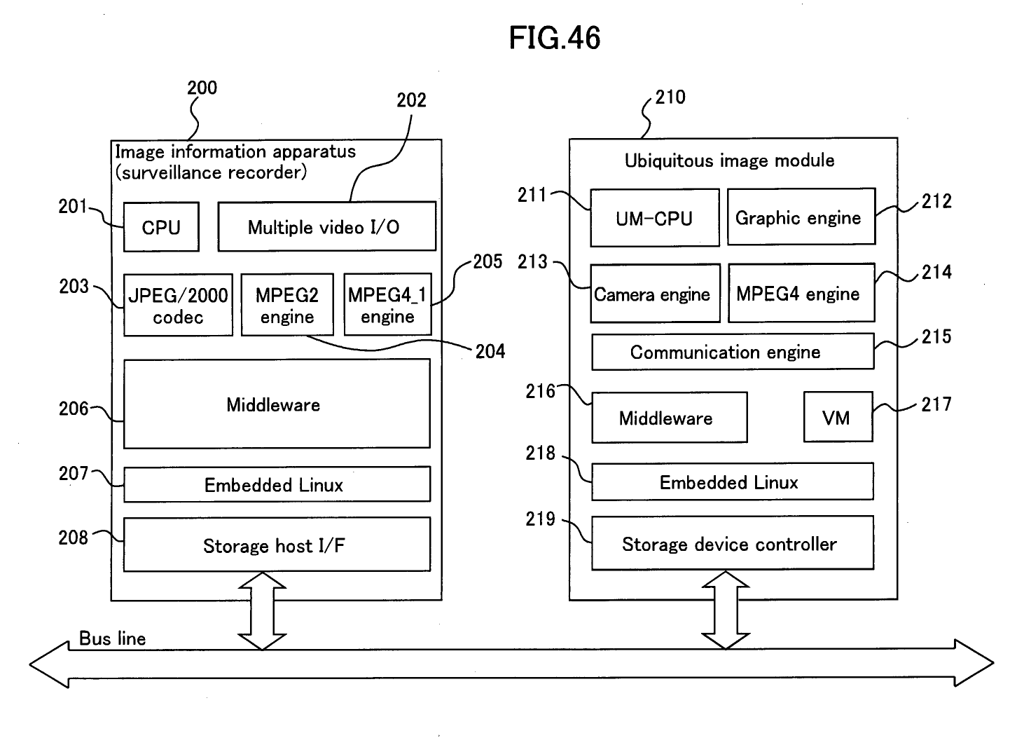

FIG. 46 is a view schematically representing a system configuration of an image information apparatus to which a ubiquitous image module according to Embodiment 5 is applied.

A monitor recorder 200 as an example of an image information apparatus is composed of a CPU 201 for controlling the surveillance recorder 200, a multiple video I/O 202 for transmitting to and receiving from other apparatuses having an image output image signals, a JPEG/2000 codec 203 for compressing and decompressing JPEG/JPEG2000, etc., an MPEG2 engine 204 for compressing a moving picture, an MPEG4_version 1 engine (represented as an MPEG4_{—}1 engine in the figure) 205, middle ware 206, a storage host I/F 208 for controlling interfaces of storage apparatuses, and embedded Linux 207, as OS, that is, the same embedded OS as a UM-CPU 211.

Moreover, a ubiquitous image module 210 is configured to have functional blocks such as a UM-CPU 211 for controlling this ubiquitous image module 210, a graphic engine 212 for improving drawing characteristics, a camera engine 213 for processing signals of moving and still pictures, etc. taken by a camera, an MPEG4_version 2 engine represented as an MPEG4_{—}2 engine in the figure) 214 for compressing and decompressing a moving picture, and in a communication engine 215 used in wired LAN and wireless LAN for connecting to network circumstances, and serial bus communication, etc. Here, functional blocks such as the MPEG4_version 1 engine 205, and the MPEG4_version 2 engine 214 related to compressing moving pictures are generally referred to as an MPEG4 engine.

Here, among the functional blocks included in the ubiquitous image module 210, the examples each raised in the above description are only an example, functions needed for the surveillance recorder 200 can be realized by each of the engines included in the ubiquitous image module 210.

The ubiquitous image module 210 is connected to the storage host I/F 208 of the surveillance recorder 200. The MPEG4 engines installed in the surveillance recorder 200 and the ubiquitous image module 210 are the MPEG4_version 1 engine 205 and the MPEG4_version 2 engine 214 corresponding to version 1 and 2 of MPEG4, respectively, in the example represented in FIG. 46.

When the ubiquitous image module 210 does not use the MPEG4_version 1 engine 205 but uses another engine (such as a hardware engine or a software engine), the UM-CPU 211 of the ubiquitous image module 210 controls through a storage device controller 219 the storage host I/F (storage host interface) 208 of the surveillance recorder 200.

Accordingly, it becomes possible for the ubiquitous image module 210 to operate the multiple video I/O 202, the JPEG/2000 codec 203, and the MPEG2 engine 204 that are installed in the surveillance recorder 200.

<Cooperation Setting>

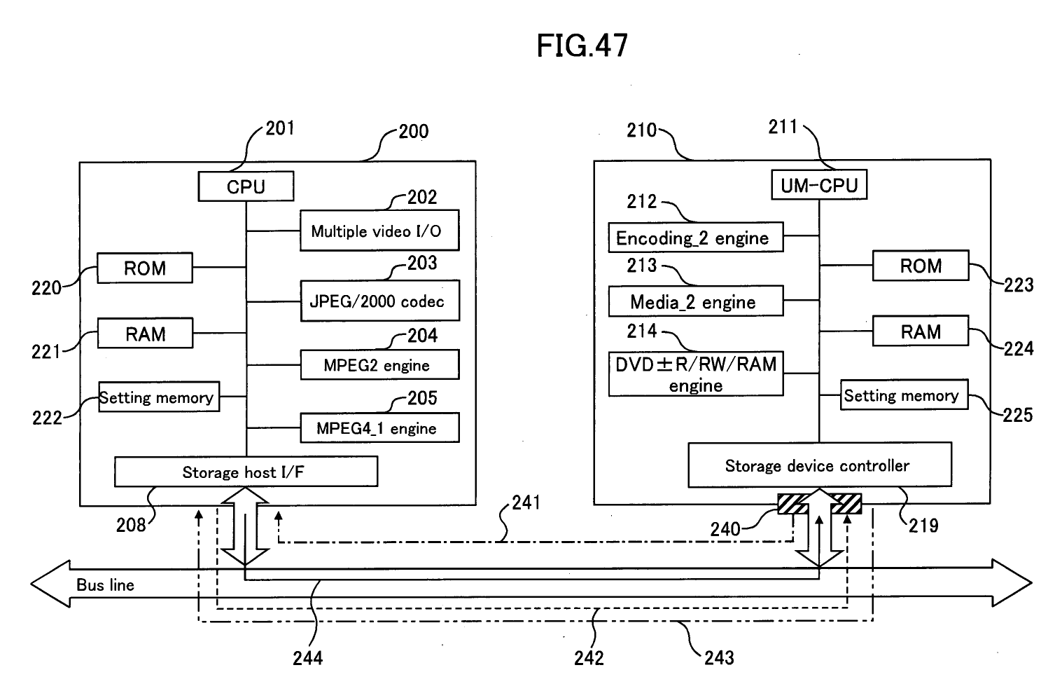

Hereinafter, a specific explanation is carried out referring to FIG. 47-FIG. 52. FIG. 47 is a schematic view illustrating another example of a system configuration of the image information apparatus to which the ubiquitous image module 210 according to Embodiment 5 is applied.

In the surveillance recorder 200, numeral 220 denotes an ROM, numeral 221 denotes an RAM, and numeral 222 denotes a setting memory. Similarly, in the ubiquitous image module 210, numeral 223 denotes an ROM, numeral 224 denotes an RAM, and numeral 225 denotes a setting memory.

FIG. 48 is a schematic view representing an example of setting information stored in the setting memories 222 and 225. As represented in the figure, in the setting memory 222 and/or the setting memory 225, various settings such as apparatus setting 230a, network setting 230b, and cooperation setting 230c are stored.

In the surveillance recorder 200 represented in FIG. 47, the apparatus setting 230a is a setting that the surveillance recorder 200 gives to each of apparatuses, for example, the settings of the number of a camera to be operated and of timing to change a camera among cameras connected to the network.

Moreover, the network setting 230b is a setting of an address and a communication system needed for the surveillance recorder 200 for communicating with apparatuses connected to the network.

In the configuration according to Embodiment 5, the setting memory 222 and/or the setting memory 225 included in the surveillance recorder 200 and the ubiquitous image module 210 connected to the surveillance recorder have the cooperation setting 230c in which each of engines included in the surveillance recorder 200 and the ubiquitous image module 210 connected to the surveillance recorder is tabularized in a form corresponding to the administration number (administration No.).

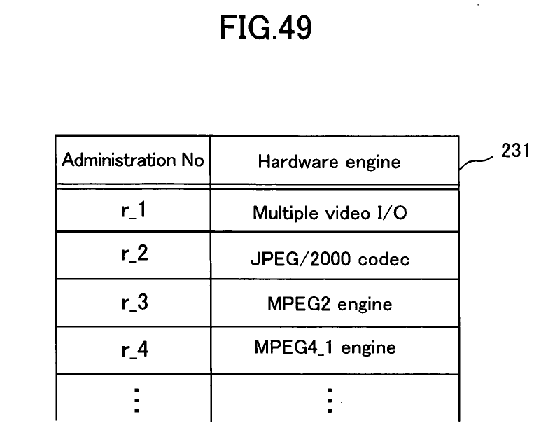

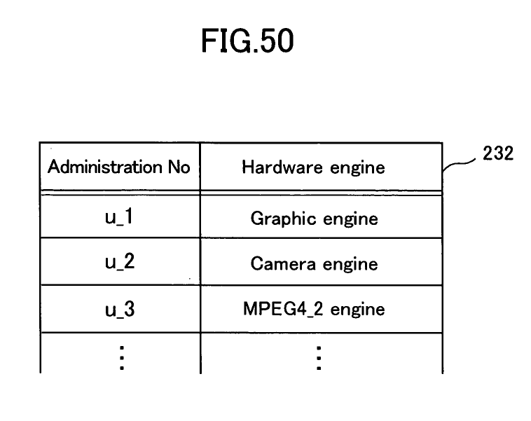

FIG. 49 and FIG. 50 each are an example of setting contents of the cooperation setting 230c according to Embodiment 5. FIG. 49 represents contents of cooperation setting 231 stored in the setting memory 222 of the surveillance recorder 200.

As represented in FIG. 49, in the cooperation information 231, the hardware engines that the CPU 201 of the surveillance recorder 200 controls, and the information such as the administration number (administration No.) for administrating them are stored corresponding to each of the hardware engines.

FIG. 50 represents contents of cooperation setting 232 stored in the setting memory 225 of the ubiquitous image module 210.

As represented in the figure, in the cooperation information 232, the hardware engines that the UM-CPU 211 of the ubiquitous image module 210 controls, and the information such as the administration number (administration No.) for administrating them are stored corresponding to each of the hardware engines.

Needless to add, those represented in the figures as above each are only an example; therefore, regarding the contents of the cooperation setting 231 and 232, other settings may be also stored, if necessary. The other settings mean settings related to, for example, functional blocks related to audio data processing and text data processing that can deal with data other than image information.

FIG. 47 is a schematic view schematically illustrating each of the hardware engines of the ubiquitous module 210 and the surveillance recorder 200 as an example of the image information apparatus according to Embodiment 5.

As represented in FIG. 46, FIG. 25, and FIG. 27, the surveillance recorder 200 includes the multiple video I/O 202 as a hardware engine that the CPU 201 of the surveillance recorder 200 itself controls, the JPEG/2000 codec 203, the MPEG2 engine 204, and the MPEG4_{—}1 engine 205, as its basic hardware engines.

On the other hand, as represented in FIG. 46, FIG. 25, and FIG. 28, the ubiquitous image module 210 includes the graphic engine 212 as a hardware engine that the UM-CPU 211 of the ubiquitous image module 210 itself controls, the camera engine 213, and the MPEG4_{—}2 engine 214, as its basic hardware engines.

Here, the storage host I/F 208 of the surveillance recorder 200 can disclose the hardware devices. That is, the hardware devices that the surveillance recorder 200 administrates are made to come into a state recognizable by the ubiquitous image module 210.

<Operation Based on Cooperation Setting>

Hereinafter, referring to FIG. 47, the operation is explained. When the ubiquitous image module 210 is mounted to the storage host I/F 208 of the surveillance recorder 200, the ubiquitous image module 210 detects that it has been connected to the storage host I/F 208, and turns on a switch that starts a program related to the following signal transmitting and receiving (Step A, 240).

This switch is composed of, for example, a hardware switch or a software switch that enables to supply electric power to the ubiquitous image module 210, and by the switch-on operation of this switch, electric power is applied at least to the UM-CPU 211.

As described above, in the surveillance recorder 200 and the ubiquitous image module 210, the hardware engines that the CPUs (CPU 201 and UM-CPU 211) in the respective setting memories 222 and 225 control, and information such as the administration number for administrating them (cooperation setting 231 and 232) are stored corresponding to each of the hardware engines.

The ubiquitous image module 210 transmits to the storage host I/F 208 of the surveillance recorder 200 hardware engine information that the surveillance recorder 200 administrates, and a request signal for getting the cooperation setting 231, which is information such as the administration number for administrating these hardware engines (Step B, 241).

The storage host I/F 208 having received this request signal transmits to the ubiquitous image module 210 the cooperation setting 231 stored in the setting memory 222 of the surveillance recorder 200 (Step C, 242).

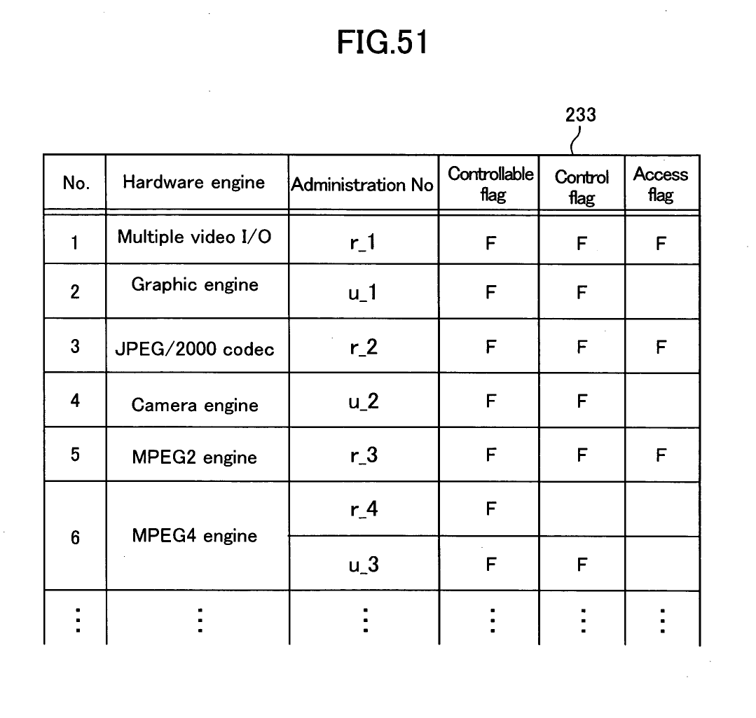

The ubiquitous image module 210 creates, based on the received cooperation setting 231 of the surveillance recorder 200 and the cooperation setting 232 stored in the setting memory 225, a data list 233, as schematically represented in FIG. 51, of the hardware engines that the ubiquitous image module 210 can control.

In the data list 233, information related to each of the hardware engines of the surveillance recorder 200 and the ubiquitous image module 210 is set as a data category of the “hardware engine”.

The data list 233 includes:

A. the number represented as “No.” corresponding to each of the hardware engines, and

B. “the administration number (administration No.)” represented in a format expressing the “(apparatus attribute)_(hardware engine attribute)”.

Explaining about this B, in the example represented in FIG. 51, regarding r_1, r_2 . . . , r indicates the hardware engines provided on the image information apparatus side (here, the surveillance recorder 200), meanwhile regarding u_1, u_2, . . . , u indicates the hardware engines provided on the ubiquitous image module 210 side.

Moreover, the data list 233 also includes each of flags, represented as Symbol F in FIG. 51, as follows:

C. the “controllable flag” representing whether the ubiquitous image module 210 controls each of the hardware engines,

D. the “control flag” representing whether the ubiquitous image module 210 actually controls, as a result of considering the version of each hardware engine, etc., and

E. the “access flag” representing a hardware engine that has to access, from the ubiquitous image module 210, the surveillance recorder 200, among the hardware that the ubiquitous image module 210 represented by this “control flag” controls.

The “controllable flag” in the data list 233, as described above, represents a state in which the hardware engines included in the surveillance recorder 200 and the ubiquitous image module 210 are unified. Therefore, as represented in FIG. 51, the “controllable flag” is given to all of the hardware engines.

As described above, regarding the “controllable flag” and the “control flag”, in the event of the surveillance recorder 200 being connected with the ubiquitous image module 210 the UM-CPU 211 operates to unite the information related to the hardware engines included in both the recorder and the module; thereby, the accessibility to the hardware engines whose characteristics has been further improved in advance improves. That is, because the surveillance recorder 200 and the ubiquitous image module 210 each holds the “controllable flag” and the “control flag”, the above unifying operation can be performed in a short period of time.

Here, MPEG4-related hardware engines, among the hardware engines in the data list 233, used for compressing and decompressing with MPEG4 are the MPEG4_{—}1 engine (administration No. r_4) included in the cooperation setting 231 of the surveillance recorder 200, and the MPEG4_{—}2 engine (administration No. u_3) included in the cooperation setting 232 of the ubiquitous image module 210 as represented in FIG. 50.

Here, out of the MPEG4_{—}1 engine and the MPEG4_{—}2 engine the MPEG4_{—}2 engine (administration No. u_3 in FIG. 50) whose contents have been further revised is used for compressing and decompressing MPEG4.

That is, in the example of FIG. 51, the MPEG4_{—}2 engine is used for compressing and decompressing MPEG4. Accordingly, in the example of the data list 233 represented in FIG. 51, the “control flag” is given to all of the hardware engines except for that of r_4 in administration No. 6.

Hardware engines, among the hardware engines to which this “control flag” has been given, by which the ubiquitous image module 210 has to access the surveillance recorder 200 are those represented with administration numbers r_1, r_2, and r_3. Accordingly, the “access flag” is given to the hardware engines represented with administration numbers r_1, r_2, and r_3.

As explained above, each of the flags is given corresponding to the hardware engines included in each of the surveillance recorder 200 and the ubiquitous image module 210.

Then, the UM-CPU 211 of the ubiquitous image module 210 outputs to the surveillance recorder 200 an access request signal for accessing the hardware engine included in the surveillance recorder 200 to which this “access flag” has been given (Step D, 243).

The CPU 201 of the surveillance recorder 200 that has received the access request signal accesses the hardware engine designated by the received access request signal.

Here, in this example, the access from the hardware engine of the ubiquitous image module 210 to that of the surveillance recorder 200 is given to the hardware engines, represented by administration numbers of r_1, r_2, and r_3, to which the access flag of the above data list has been given.

The hardware engine accessed by the CPU 201 performs processing of the hardware engine, and the processing result is transmitted to the CPU 201 of the surveillance recorder 200.

The CPU 201 of the surveillance recorder 200 transmits to the ubiquitous image module 210 the received processing result (Step E, 244).

By performing a series of processing operations from Step A to Step E having been explained above, the UM-CPU 211 of the ubiquitous image module 210 can substantially control the CPU 201 of the surveillance recorder 200.

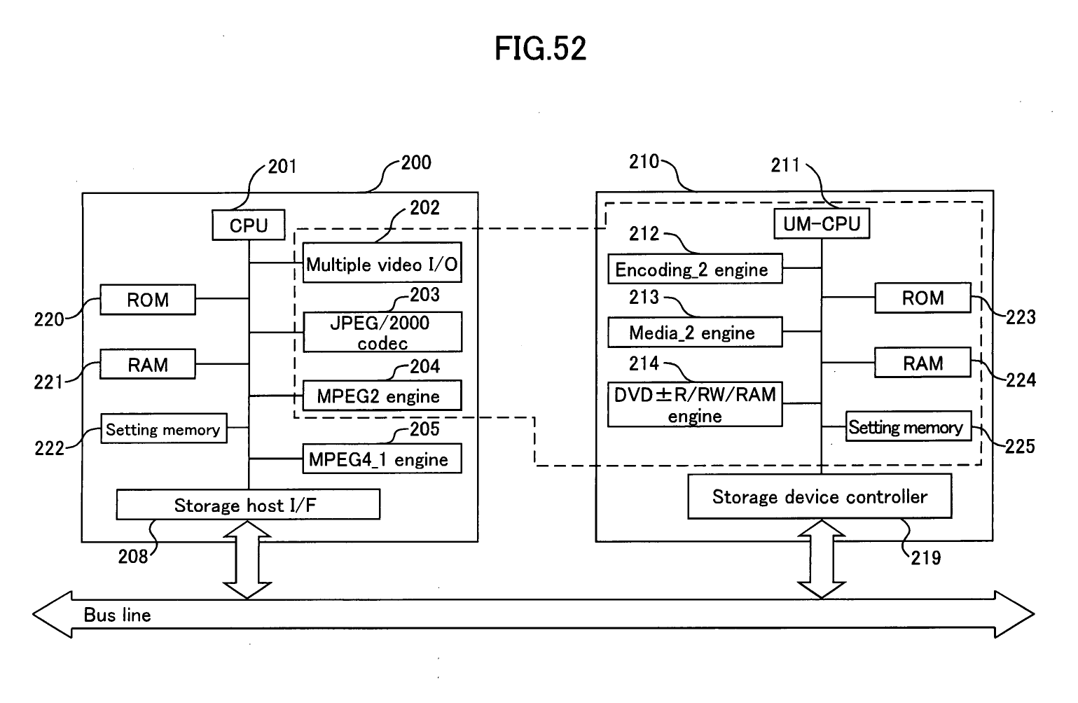

That is, schematically illustrating this case, the case is equivalent to that the UM-CPU 211 substantially controls the portion surrounded by a broken line in FIG. 52. Therefore, by configuring as described above, regarding a function that the image information apparatus does not fundamentally have, or the connected ubiquitous image module does not fundamentally have, complementary relationships can be formed by connecting the image information apparatus and the ubiquitous image module, and using the above data list that represents the complementary relationships, the accessibility can be improved.

Here, in Embodiment 5 those except for the above description are the same as those in Embodiment 1.

### Embodiment 6

<Attaching and Detaching Hardware (Hardware Engine) and Operation>

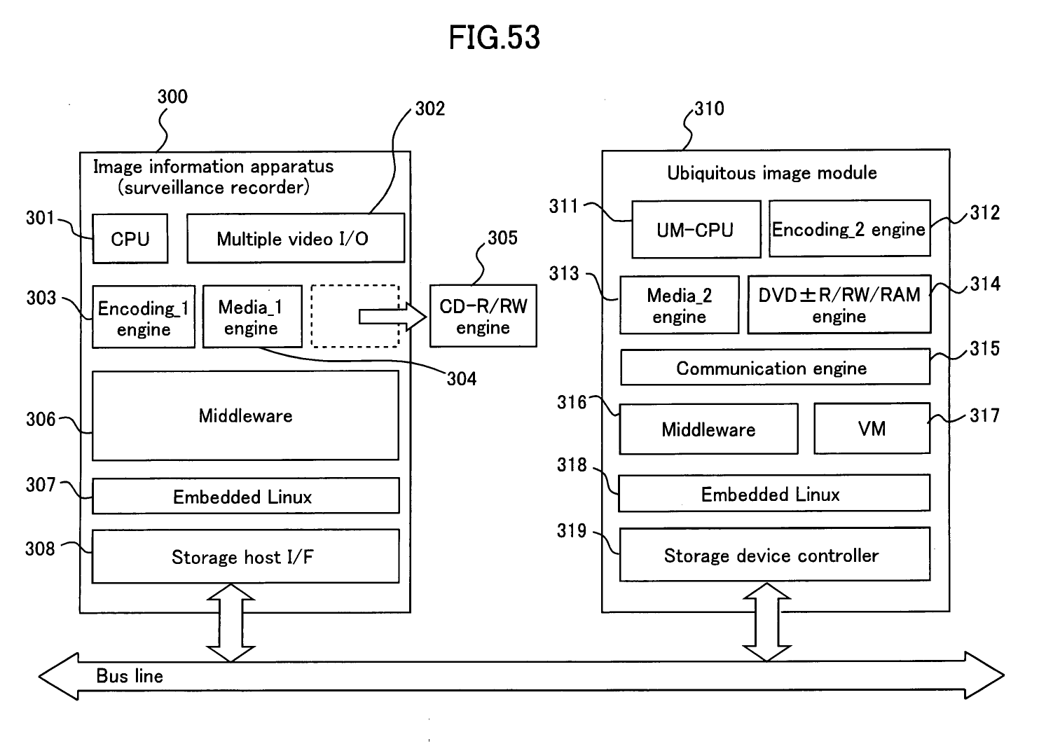

FIGS. 53 and 34 are system configurational views, when a ubiquitous image module 310 is connected (attached) through the bus line to a surveillance recorder 300 as an example of the image information apparatus.

FIGS. 53 and 34 represent that the surveillance recorder 300 was attached with a CD-R/RW drive to a portion surrounded by a broken line. Hereinafter, an example is explained in which after this CD-R/RW drive has been detached from the surveillance recorder 300, a new attachment module including a DVD±R/RW/RAM drive and a new card medium is connected to the surveillance recorder 300.

Although the CD-R/RW drive was connected to the surveillance recorder 300 through a storage host interface (storage host I/F) 308, the new attachment module is connected to the storage host I/F 308 in which vacant space has been created due to detaching of the CD-R/RW drive.

An encrypting engine (encrypting_{—}1 engine) 303 inside the surveillance recorder 300 is a hardware engine for encrypting communication information, for example, when the surveillance recorder 300 communicates with another image information apparatus through the network.

A media engine (media_{—}1 engine) 304 is a hardware engine for controlling writing and reading data into/from card media, and a CD-R/RW engine is a hardware engine for controlling writing and reading data into/from CD-R/RW.

A DVD±R/RW/RAM engine 314 inside the ubiquitous image module 310 is a hardware engine for controlling writing and reading data into/from DVD±R/RW/RAM devices.

Here, the encrypting_{—}1 engine 303 and media_{—}1 engine 304 inside the surveillance recorder 300 can perform old-type encrypting process and control (support) card media, respectively, and they are assumed to be replaced by an encrypting_{—}2 engine 312 and a media_{—}2 engine 313 inside the ubiquitous image module 310.

A CPU 301, a multiple video I/O 302, middleware 306, embedded Linux 307 and a storage host I/F 308 each are fundamentally similar to those explained in the above-described embodiments.

Moreover, a UM-CPU 311, a communication engine 315, middleware 316, a Java virtual machine VM 317, embedded Linux 318, and a storage device controller 319 inside the ubiquitous image module 310 each are fundamentally similar to those explained in the above described embodiments.

The fundamental configuration of cooperation setting that has been embedded in the ubiquitous image module 310 is similar to that represented in FIG. 47.

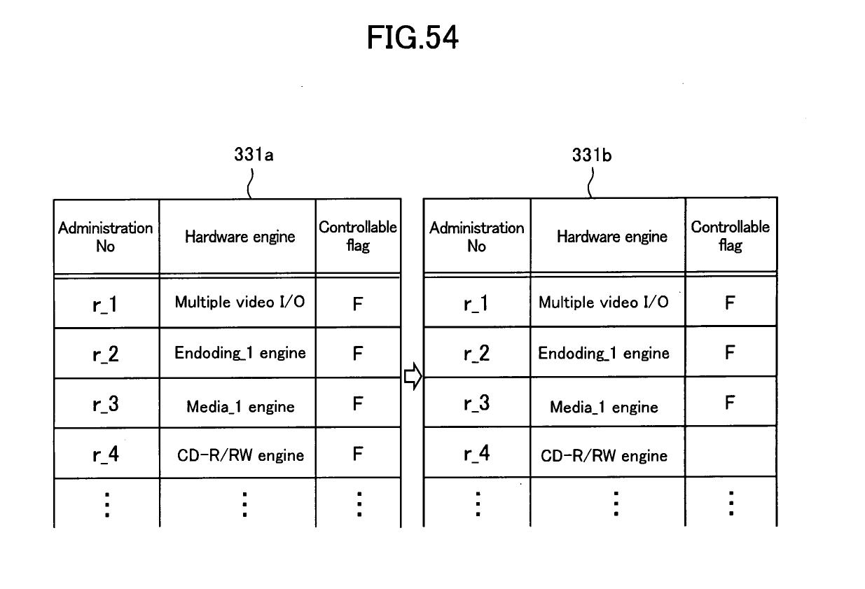

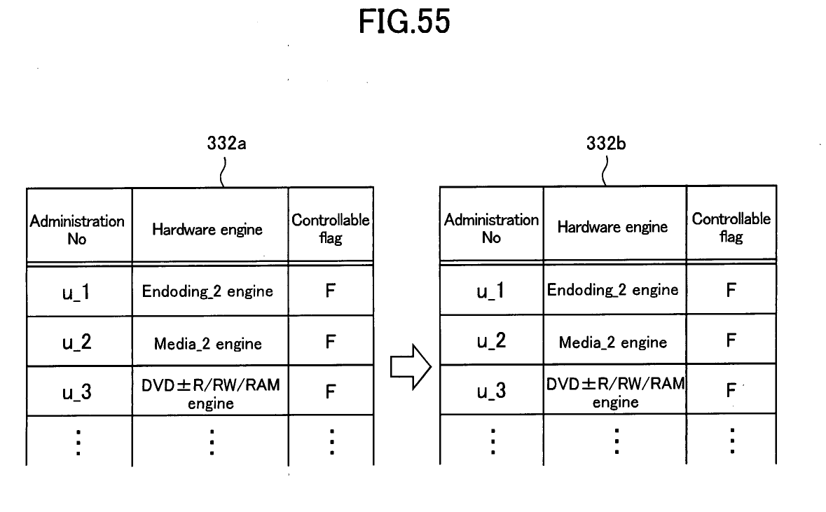

FIG. 54 and FIG. 55 each are cooperation settings for hardware engines, of each of the surveillance recorder 300 and the ubiquitous image module 310 store in ROMs 320 and 323 of the surveillance recorder 300 and the ubiquitous image module 310, respectively.

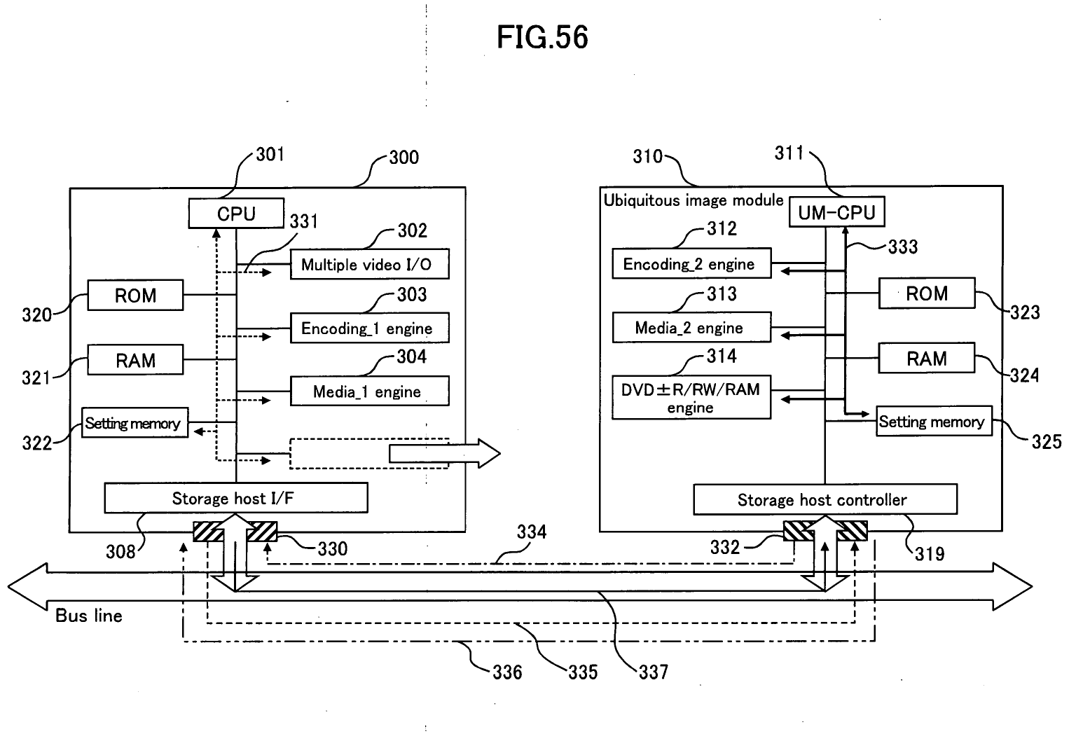

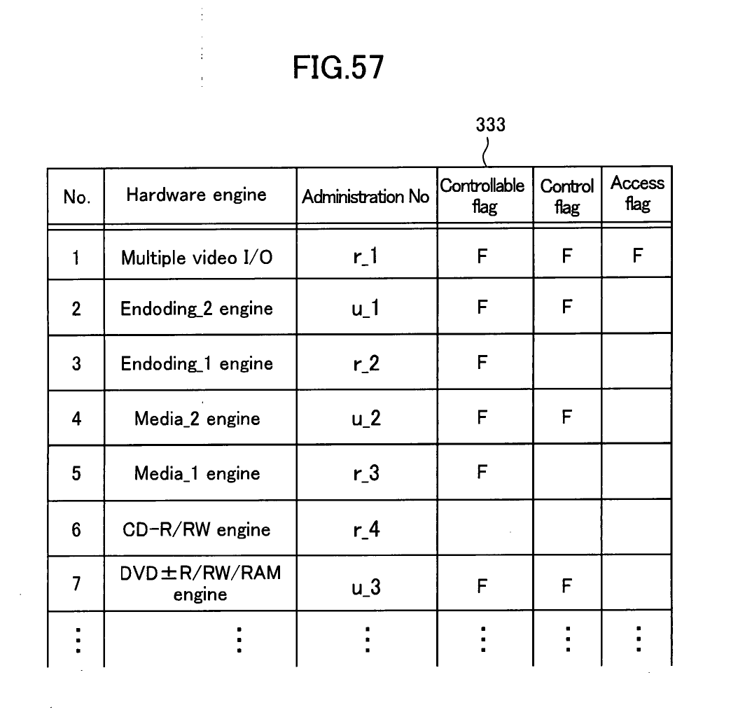

Here, through a procedure represented in FIG. 56 described later, the ubiquitous image module 310 creates and updates a data list with respect to hardware engines represented in FIG. 57.

As illustrated in FIG. 56, the UM-CPU 311 of the ubiquitous image module 310 can practically control the CPU 301 of the surveillance recorder 300.

<Rewrite (Update) Flag List>

FIG. 56 is a system configurational view representing an operation in which the ubiquitous image module 310 in Embodiment 6 controls the hardware engines inside the surveillance recorder 300.

As described above, in this example, by attaching the ubiquitous image module in which the CD-R/RW drive of the surveillance recorder 300 is detached, but the DVD±R/RW/RAM drive and the new card media drive are attached instead, a function that the surveillance recorder 300 does not have is added.

In the surveillance recorder 300, as represented in FIG. 54, cooperation information of the hardware engines administrated by the surveillance recorder 300 itself is stored in a setting memory 322.

When the CD-R/RW drive is detached from the surveillance recorder 300, the surveillance recorder 300 detects it, and then, turns on a switch that starts a program for searching for hardware engines that the surveillance recorder 300 can control by itself (Step A, 330).

The program for searching for the hardware engines of the surveillance recorder 300 itself performs inquiry to each hardware engine about defining the kind of each hardware engine (multiple video I/O, encrypting_{—}1 engine, etc.), and gets information related to the kind of each hardware engine.

Based on the gotten information, the CPU 301 updates the cooperation setting stored in the memory 322 of the surveillance recorder 300 itself, and also updates controllable flags in the data list (Step B, 331).

Thereby, as represented in FIG. 54, before and after the CD-R/RW drive being detached, the controllable flag of administration No. r_4 changes from “flag exists (flag related to r_4 of cooperation setting 331a is “F”)” to “flag does not exist (flag related to r_4 of cooperation setting 331b does not exist)”.

Subsequently, when the ubiquitous image module 310 is attached to the empty slot for the CD-R/RW drive, the ubiquitous image module 310 detects that the module has been connected to the storage host I/F 308, and then, turns on the switch that starts a hardware-engine searching program in the ubiquitous image module 310 itself (Step C, 332).

Here, this switch may be configured using, for example, a hardware switch or a software switch that can supply electric power to the ubiquitous image module 310; thus, it may be configured in such a way that the above hardware-engine searching program starts with the electric power being supplied to at least the UM-CPU 311 by an operation of turning this switch on.

The hardware-engine searching program performs inquiry about defining the kind of each hardware engine (encrypting_{—}2 engine, media_{—}2 engine, etc.) with respect to each hardware engine of the ubiquitous module 310, and gets information related to the kind of each hardware engine; accordingly, controllable flags of cooperation setting 332a stored in a setting memory 325 of the ubiquitous image module 310 itself are updated (Step D, 333).

In the ubiquitous image module 310 in this case, because no status change occurs such as attaching or detaching of the included hardware engines, as represented in FIG. 55, before and after the DVD±R/RW/RAM drive being attached, controllable flag of each hardware engine does not change.

By the hardware-engine searching program, in the wake of cooperation setting 332b inside the setting memory 325 having been updated, the following program related to transmitting and receiving of signals starts.

The ubiquitous image module 310, in order to control the hardware engines administrated by the surveillance recorder 300, transmits to the storage host I/F 308 of the surveillance recorder 300 a request signal for getting the cooperation setting 331b administrated by the surveillance recorder 300 (Step E, 334).

The storage host I/F 308 having received this request signal transmits to the ubiquitous image module 310 the cooperation setting 331b stored in the setting memory 322 of the surveillance recorder 300 (Step F, 335).

Based on the received cooperation setting 331b of the surveillance recorder 300 and the cooperation setting 332b stored in the setting memory 325, the ubiquitous image module 310 creates a data list 333 related to the hardware engines, as schematically represented in FIG. 57, which the ubiquitous image module 310 can control.

Based on whether access flags exist in the data list 333 related to the hardware engines of the surveillance recorder 300 and the ubiquitous image module 310, the ubiquitous image module 310 accesses the surveillance recorder 300 (Step G, 336).

Here, in the example of the data list 333 represented in FIG. 57, hardware engines, among the hardware engines of the surveillance recorder 300 that the ubiquitous image module 310 needs to access become only the multiple video I/O 302 to which the access flag is given.

In the example represented in FIG. 57, only the multiple video I/O 302 to which the access flag is given is the hardware engine that needs to be accessed from the ubiquitous image module 310; however, it is not necessarily limited to this example.

That is, as a case in which the hardware engines on the side of the surveillance recorder 300 are more sophisticated than those included or not included in the ubiquitous image module 310, based on a state in which the access flags represented in the data list 333 are given, the necessity of access from the ubiquitous image module 310 to the surveillance recorder 300 changes.

When the ubiquitous image module 310 accesses the multiple video I/O 302, the UM-CPU 311 of the ubiquitous image module 310 outputs to the surveillance recorder 300 an access request signal for accessing the multiple video I/O 302 of the surveillance recorder 300 to which these access flags are given.

The CPU 301 of the surveillance recorder 300 that has received the access request accesses a hardware engine designated by the received access request signal (in the example represented in FIG. 57, only the multiple video I/O 302 needs to be accessed).

In the hardware engine accessed by the CPU 301, processing of the hardware engine is performed, and the processing result is transmitted to the CPU 301 of the surveillance recorder 300.

The CPU 301 of the surveillance recorder 300 transmits to the ubiquitous image module 310 the received processing result (Step H, 337).

By continuously processing from Step A to Step H as explained above, the UM-CPU 311 of the ubiquitous image module 310 can practically control the CPU 301 of the surveillance recorder 300.

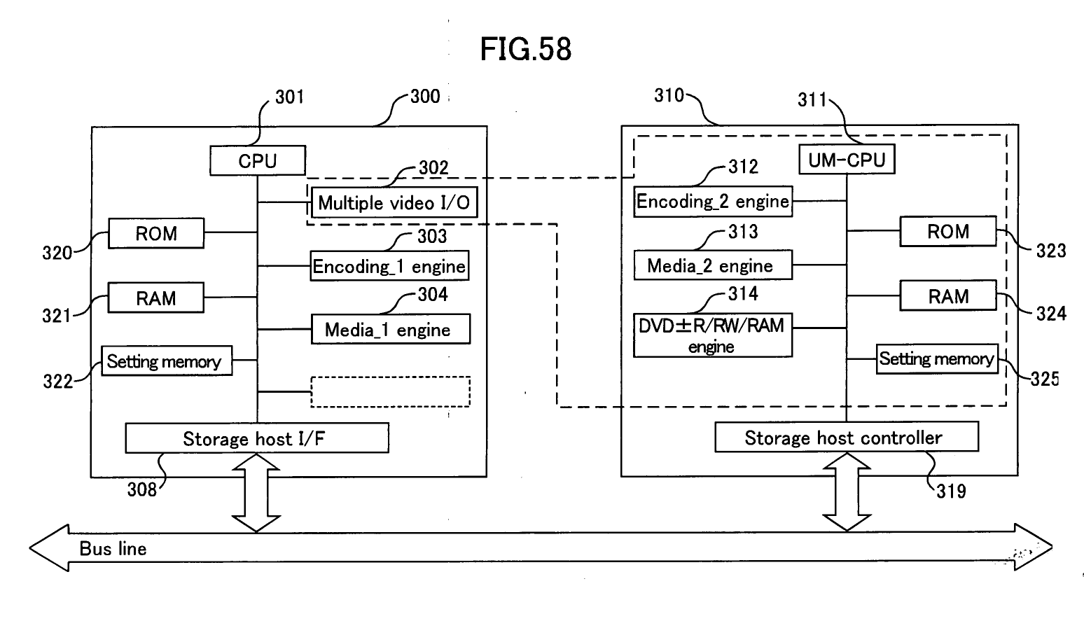

That is, as schematically illustrated, this is equivalent to that the UM-CPU 311 practically controls a portion surrounded by a broken line in FIG. 58. Therefore, by configuring as described above, regarding a function that the image information apparatus or the connected ubiquitous image module does not originally have, connecting the image information apparatus with the ubiquitous image module enables complementary relationships to be created; thus, using the above data list that represents the complementary relationships, accessibility can be improved.

Here, in Embodiment 6, those except for the above description are the same as those in Embodiment 1.

As described above, by adopting such a configuration as explained in the various embodiments, it is possible that a ubiquitous image module side, by operating a CPU of an image information apparatus side, configures a hardware engine on the image information apparatus side such as the surveillance recorder 200, to receive its output; thereby, when further functional upgrading is implemented into the image information apparatus, the function upgrading can be possible, without updating the CPU (system LSI) on the image information apparatus side, only by connecting the ubiquitous image module.

Moreover, by configuring a ubiquitous image module in such a way that access flag information, related to the hardware engines, usable by the ubiquitous image module is set among hardware engines included in an image information apparatus connected to the module, operational cooperation between the image information apparatus and the ubiquitous image module can be smoothly performed.

What is claimed is:

1. An image information apparatus comprising:
an image-information-apparatus main unit including
a first central processing unit, and
a connection interface for connecting with a module unit that has a second central processing unit for controlling the first central processing unit; wherein:
the first central processing unit and the second central processing unit each have a plurality of hierarchical control strata, and
the second central processing unit included in the module unit is configured to transmit, between each of the hierarchical control strata of the first central processing unit and respectively corresponding hierarchical control strata of the second central processing unit, control information related to each of respectively corresponding hierarchical control strata, so as to control the image-information-apparatus main unit.

2. An image information apparatus as recited in claim 1, wherein:
the image-information-apparatus main unit and the module unit are connected with each other through the connection interface; and
the apparatus is configured to store, into data storage provided outside the apparatus and connected to a network to which the module unit is connected, image data outputted from the image-information-apparatus main unit or the module unit.

3. An image information apparatus as recited in claim 2, wherein:
the plurality of hierarchical control strata of the image-information-apparatus main unit and the plurality of hierarchical control strata of the module unit are structured to include a software program for each respective hierarchical control stratum; and
data is transmitted and received between each software program that structures the plurality of hierarchical control strata of the image-information-apparatus main unit and each software program that structures the plurality of hierarchical control strata of the module unit.

4. An image information apparatus as recited in claim 3, wherein:
each software program included respectively in the image-information-apparatus main unit and in the module unit includes a respective operating system; and
data is transmitted and received between each of the respective operating systems.

5. An image information apparatus as recited in claim 3, wherein:
each software program included respectively in the image-information-apparatus main unit and in the module unit includes a respective middleware item; and
data is transmitted and received between each of the respective middleware items of the main and module units.

6. An image information apparatus as recited in claim 3, wherein:
each software program included respectively in the image-information-apparatus main unit and in the module unit includes a respective application; and
data is transmitted and received between each of the respective applications.

7. An image information apparatus as recited in claim 3, wherein:
each software program included respectively in the image-information-apparatus main unit and in the module unit includes a respective inter-process communications communicator; and
data is transmitted and received between each of the respective inter-process communications communicators.

8. An image information apparatus as recited in claim 2, wherein the module unit, in addition to having the second central processing unit, includes an operating system for controlling the second central processing unit, and a hardware engine running on the operating system.

9. An image information apparatus as recited in claim 2, wherein the image-information-apparatus main unit and the module unit store, in respective memories provided in the main unit and the module unit, administration information related to respective hardware or hardware engines that the main unit and the module unit each have.

10. An image information apparatus as recited in claim 9, wherein the module unit:
reads out, from the memory provided in the image information apparatus, first administration information related to the hardware or the hardware engine that the image information apparatus, connected to the module unit, has, and
structures third administration information based on the first administration information and on second administration information stored in the memory provided in the module unit and related to the hardware or the hardware engine that the module unit has.

11. An image information apparatus as recited in claim 10, wherein the first administration information includes a flag related to the hardware or the hardware engine that the image information apparatus has.

12. An image information apparatus as recited in claim 10, wherein the second administration information includes a flag related to the hardware or the hardware engine that the module unit, connected to the image information apparatus, has.

13. An image information apparatus as recited in claim 10, wherein the third administration information includes, in the hardware or the hardware engine that the image information apparatus has, a flag representing access needed from the module unit connected to the image information apparatus.

14. An image information apparatus as recited in claim 10, wherein when a connection state of the hardware or the hardware engine connected to the image-information-apparatus main unit has been changed, the first administration information that the image-information-apparatus main unit has is changed before the third administration information is structured.

15. An image information apparatus as recited in claim 10, wherein the module unit accesses the hardware or the hardware engine of the image information apparatus referring to a flag included in the third administration information, and receives processed output from the hardware or the hardware engine of the image information apparatus.

16. A module unit comprising:
a connecting portion connected to a connection interface of an image-information-apparatus main unit that includes a first central processing unit having a plurality of hierarchical control strata, and the connection interface; and
a second central processing unit having hierarchical control strata corresponding to the hierarchical control strata of the first central processing unit, and for transmitting, from the hierarchical control strata of the second central processing unit through the connecting portion, control information for controlling the hierarchical control strata of the first central processing unit, so as to control the first central processing unit; wherein by controlling the first central processing unit, processed information including image information is outputted from the image-information-apparatus main unit.

17. A module unit as recited in claim 16, further comprising:
an operating system for controlling the second central processing unit; and
a hardware engine running on the operating system.

18. A module unit as recited in claim 17, further comprising a memory, wherein administration information, related to the hardware engine that the module unit has, is stored in the memory.

19. A module unit as recited in claim 16, wherein:
first administration information, related to hardware or a hardware engine that the image information apparatus, connected to the module unit, has, is read out from a memory provided in the image information apparatus; and
third administration information is structured based on the first administration information read out, and second administration information, stored in a memory provided in the module unit, related to hardware or a hardware engine that the module unit has.

20. A module unit as recited in claim 19, wherein the first administration information includes a flag related to the hardware or the hardware engine that the image information apparatus connected to the module unit has.

21. A module unit as recited in claim 19, wherein the second administration information includes a flag related to the hardware or the hardware engine that the module unit has.

22. A module unit as recited in claim 19, wherein the third administration information includes, in the hardware or the hardware engine that the image information apparatus connected to the module unit has, a flag representing access needed from the module unit.

23. A module unit as recited in claim 19, wherein the module unit accesses the hardware or the hardware engine of the image information apparatus referring to a flag included in the third administration information, and receives processed output from the hardware or the hardware engine of the image information apparatus.
